(19) United States
(12) Patent Application Publication
(10) Pub. No.: US 2025/0023597 A1
(43) Pub. Date: Jan. 16, 2025

(54) COUPLING CANCELLATION PORTS

(71) Applicant: Space Exploration Technologies Corp., Hawthorne, CA (US)

(72) Inventors: Eric Pepin, Seattle, WA (US); Amir Agah, Kirkland, WA (US); Kim W. Schulze, Seattle, WA (US)

(21) Appl. No.: 18/771,928

(22) Filed: Jul. 12, 2024

Related U.S. Application Data
(60) Provisional application No. 63/526,873, filed on Jul. 14, 2023.

(51) Int. Cl. H04B 1/405; H01Q 3/34; H04B 1/00

(52) U.S. Cl. CPC H04B 1/405; H01Q 3/34; H04B 1/0078

(57) ABSTRACT

A phased array antenna system is provided. The phased array antenna system includes: a beamformer (BF) module comprising an antenna port coupled to an antenna element. The BF module includes first, second, and third radio frequency (RF) ports. The first and third RF ports are configured as a first differential signal pair and the second and third RF ports are configured as a second differential signal pair. The first RF port corresponds to a first RF signal and the second RF port corresponds to a second RF signal, different from the first RF signal.

### CROSS-REFERENCE TO RELATED APPLICATIONS

The present application claims the benefit of, and priority to, U.S. Provisional Patent Application No. 63/526,873 filed Jul. 14, 2023 entitled “COUPLING CANCELLATION PORTS”, the contents of which are hereby incorporated by reference in their entirety.

### TECHNICAL FIELD

The present disclosure generally relates to wireless communications and, more specifically, systems and techniques for signal coupling cancellation.

### BACKGROUND

Phased array antennas are used in a variety of wireless communication systems such as satellite and cellular communication systems. The phased array antennas can include a number of antenna elements arranged to behave as a larger directional antenna. Moreover, a phased array antenna can be used to increase an overall directivity and gain, steer the angle of array for greater gain and directivity, perform interference cancellation from one or more directions, determine the direction of arrival of received signals, and improve a signal to interference ratio, among other things. Advantageously, a phased array antenna can be configured to implement beamforming techniques to transmit and/or receive signals in a preferred direction without physically repositioning or reorientation.

It would be advantageous to configure phased array antennas to support an increased number of simultaneous data beams for transmitting and/or receiving signals. Likewise, it would be advantageous to configure phased array antennas and associated circuitry having reduced weight, reduced size, lower manufacturing cost, and/or lower power requirements. Accordingly, embodiments of the present disclosure are directed to these and other improvements in phase array antenna systems or portions thereof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a phased array antenna system is provided. The phased array antenna system includes: a beamformer (BF) module comprising an antenna port coupled to an antenna element. The BF module includes first, second, and third radio frequency (RF) ports. The first and third RF ports are configured as a first differential signal pair and the second and third RF ports are configured as a second differential signal pair. The first RF port corresponds to a first RF signal and the second RF port corresponds to a second RF signal, different from the first RF signal.

### BRIEF DESCRIPTION OF THE DRAWINGS

In order to describe the manner in which the various advantages and features of the disclosure can be obtained, a more particular description of the principles described above will be rendered by reference to specific embodiments thereof, which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a simplified diagram illustrating an example wireless communication system, in accordance with some examples of the present disclosure;

FIG. 1B is a simplified diagram illustrating an example of communication in a satellite communication system, in accordance with some examples of the present disclosure;

FIGS. 2A and 2B are isometric top and bottom views depicting an exemplary antenna apparatus, in accordance with some examples of the present disclosure;

FIG. 3A is an isometric exploded view depicting an exemplary antenna apparatus including the housing and the antenna stack assembly, in accordance with some examples of the present disclosure;

FIG. 3B is a cross-sectional view of an antenna stack assembly of an antenna apparatus, in accordance with some examples of the present disclosure;

FIG. 4A is a diagram illustrating an example illustration of a top view of an antenna lattice, in accordance with some examples of the present disclosure;

FIG. 4B is a diagram illustrating an example phased array antenna system, in accordance with some examples of the present disclosure;

FIG. 4C is a diagram illustrating example components of a beamformer chip and serially fed frontend (FE) networks that interface the beamformer chip with antenna elements, in accordance with some examples of the present disclosure;

FIG. 5A and FIG. 5B are diagrams illustrating additional example configurations for a phased array antenna, in accordance with some examples of the present disclosure;

FIG. 6 is a diagram illustrating a portion of a single data beam phased array antenna with front end modules (FEMs) connected by a distribution network from a centrally located beamformer (BF), in accordance with some examples of the present disclosure;

FIG. 7 is a block diagram illustrating a portion of a single data beam phased array antenna with serially fed FE networks connected to a BF positioned at an edge of the phased array antenna, in accordance with some examples of the present disclosure;

FIG. 8A is a diagram illustrating cross coupling, in accordance with some examples of the present disclosure;

FIG. 8B is a simplified block diagram illustrating cross coupling for an antenna configured in a transmitting (Tx) configuration, in accordance with some examples of the present disclosure;

FIG. 8C is a simplified block diagram illustrating cross coupling for an antenna configured in a receiving (Rx) configuration, in accordance with some examples of the present disclosure;

FIG. 8D is a diagram illustrating an example vector summation model defining a voltage magnitude and phase associated with a coupling victim and a coupling aggressor, in accordance with some examples of the present disclosure;

FIG. 8E is a simplified block diagram illustrating a closed loop feedback cross coupling model, in accordance with some examples of the present disclosure;

FIG. 8F is a diagram illustrating an example vector summation model defining a voltage magnitude of a coupling product associated with a coupling victim and two coupling aggressors, in accordance with some examples of the present disclosure;

FIG. 8G is a diagram illustrating an example vector summation model defining a voltage phase of a coupling product associated with a coupling victim and two coupling aggressors, in accordance with some examples of the present disclosure;

FIG. 8H through FIG. 8J are diagrams illustrating a differential signaling configuration for coupling cancellation, in accordance with some examples of the present disclosure;

FIG. 9A is a diagram illustrating a coupling cancellation configuration, in accordance with some examples of the present disclosure;

FIG. 9B is a diagram illustrating a coupling cancellation configuration for a transmitting (Tx) phased array antenna, in accordance with some examples of the present disclosure;

FIG. 9C is another diagram illustrating a coupling cancellation configuration, in accordance with some examples of the present disclosure;

FIG. 9D is a diagram illustrating is a diagram illustrating a coupling cancellation configuration for a receiving (Rx) phased array antenna, in accordance with some examples of the present disclosure, in accordance with some examples of the present disclosure;

FIG. 9E is a diagram illustrating a coupling cancellation configuration for a transmitting (Tx) phased array antenna, in accordance with some examples of the present disclosure;

FIG. 9F is a diagram illustrating an additional coupling cancellation configuration for a receiving (Rx) phased array antenna, in accordance with some examples of the present disclosure;

FIG. 10A is a diagram illustrating a coupling cancellation configuration for a transmitting (Tx) phased array antenna, in accordance with some examples of the present disclosure;

FIG. 10B is a diagram illustrating an additional coupling cancellation configuration for a receiving (Rx) phased array antenna, in accordance with some examples of the present disclosure;

FIG. 11 is a diagram illustrating an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Language such as “top”, “bottom”, “upper”, “lower”, “vertical”, “horizontal”, “lateral”, in the present disclosure is meant to provide orientation for the reader with reference to the drawings and is not intended to be the required orientation of the components or to impart orientation limitations into the claims.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

In some aspects, systems, apparatuses, processes (also referred to as methods), and computer-readable media (collectively referred to herein as “systems and techniques”) are described herein for beamforming in a phased array antenna.

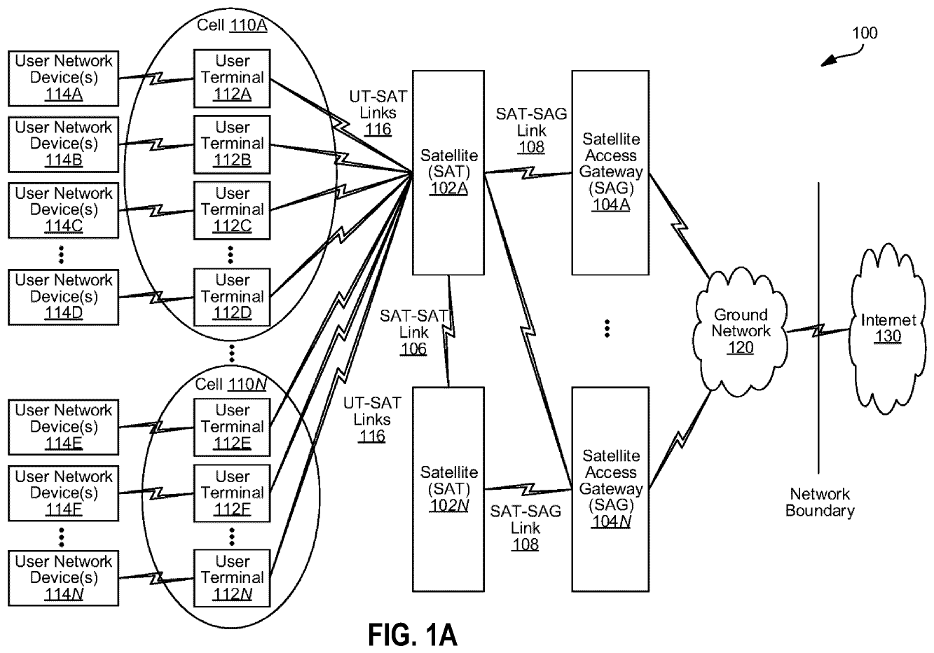

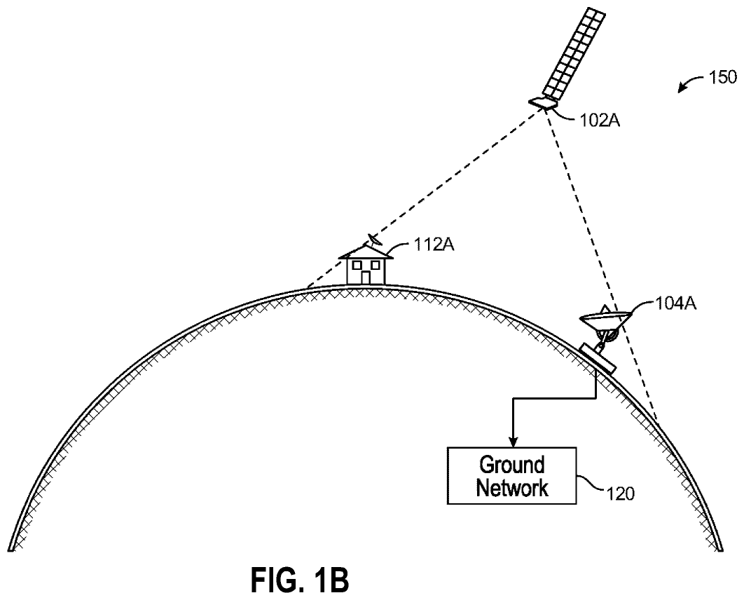

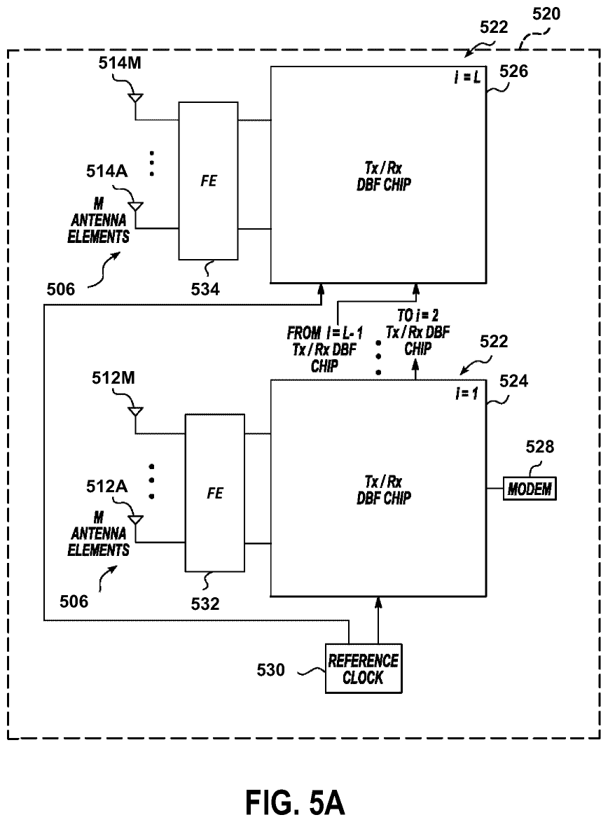

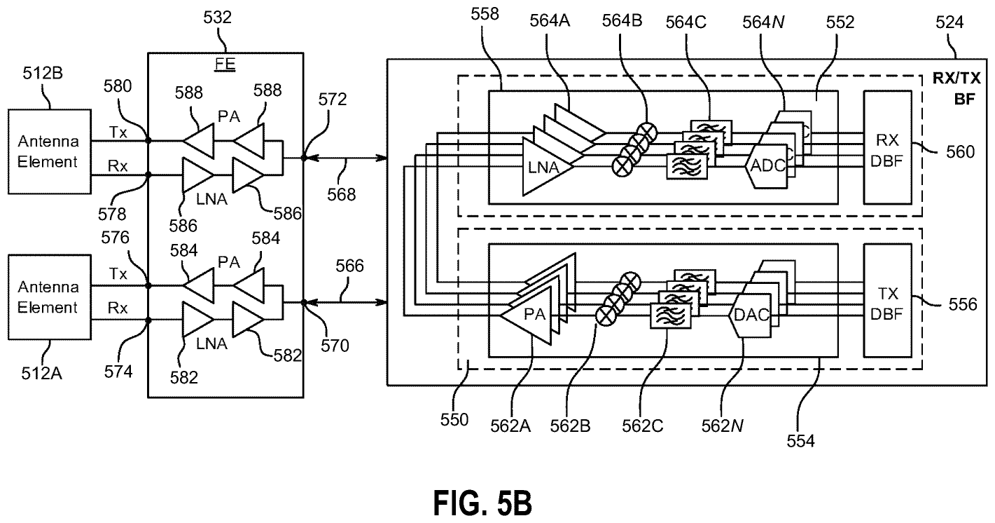

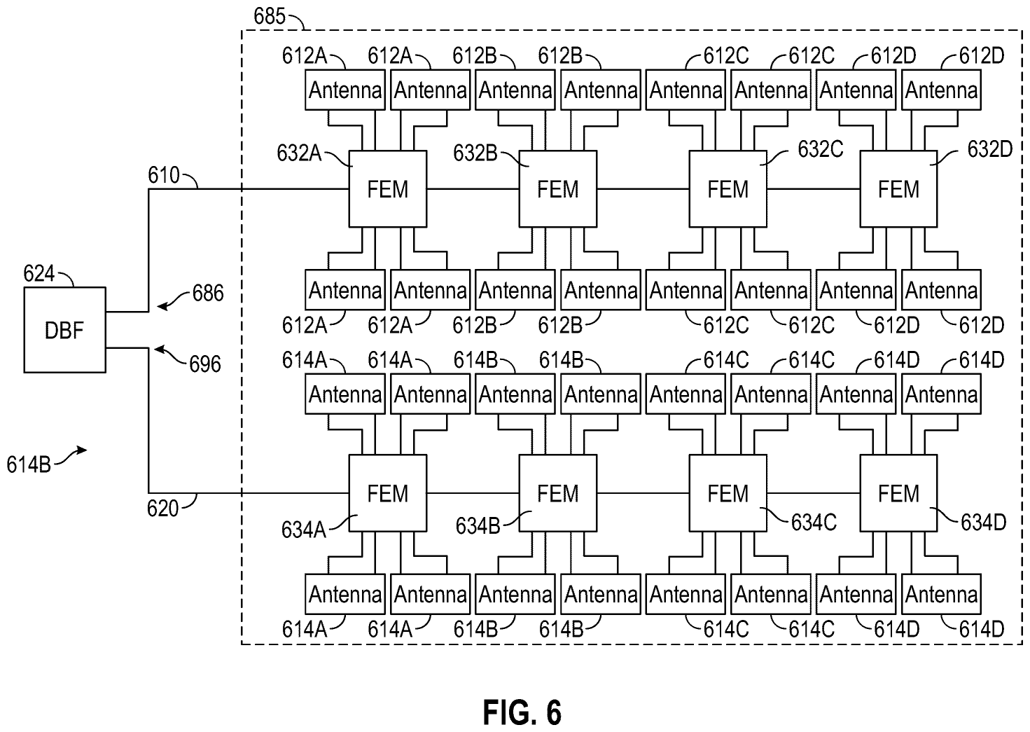

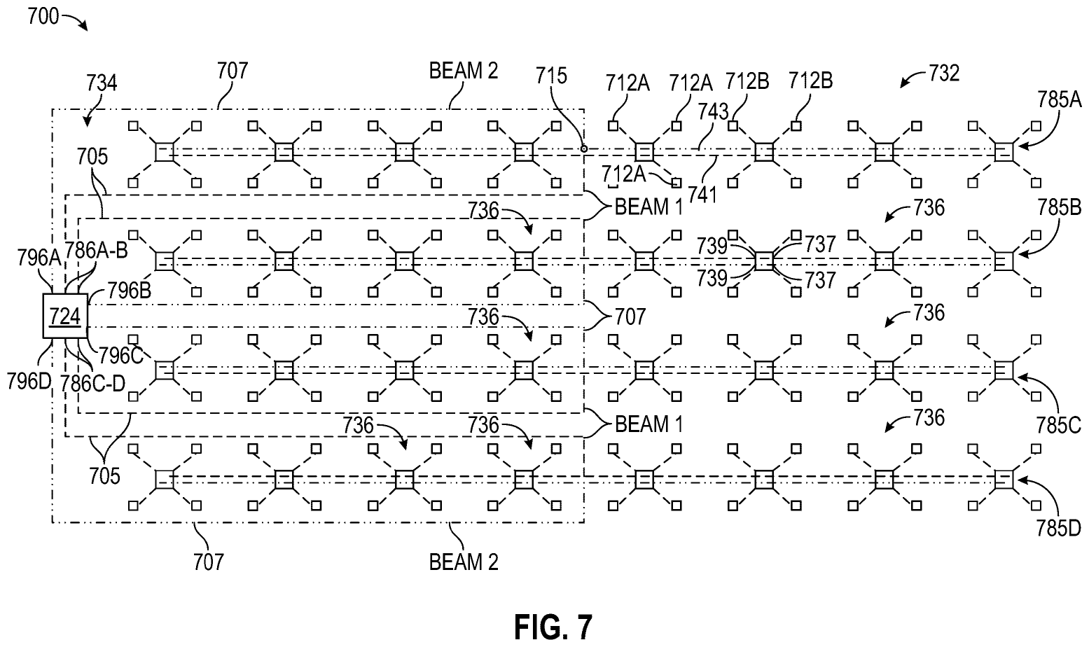

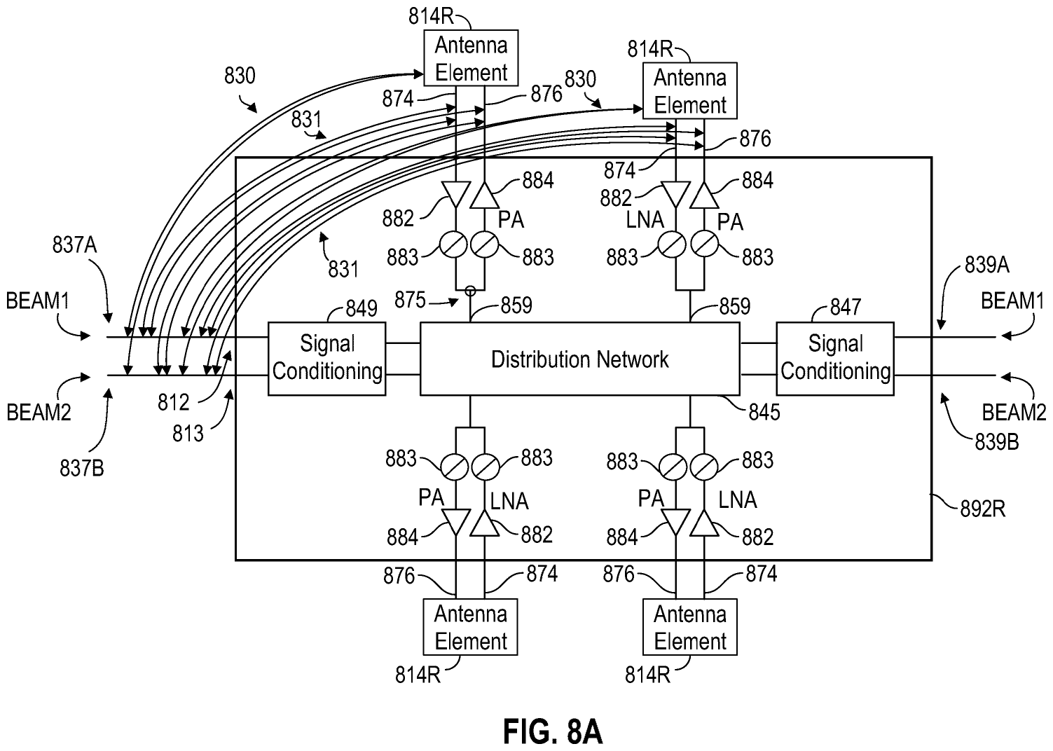

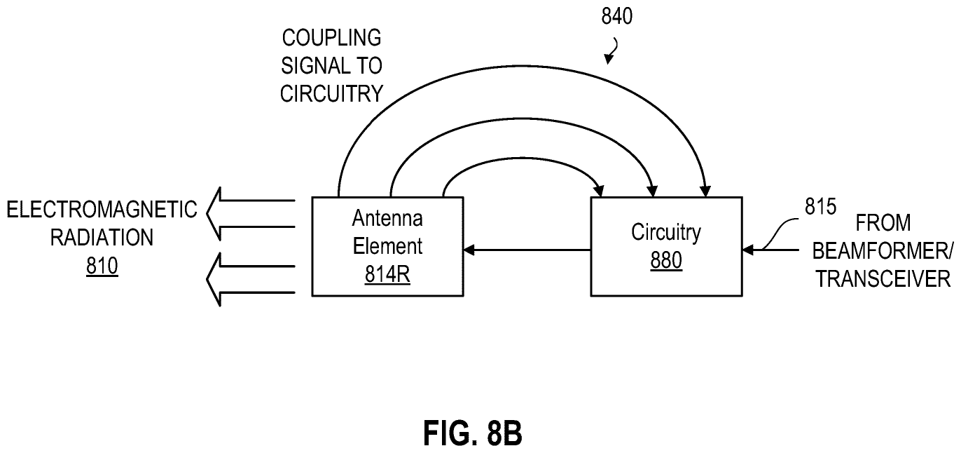

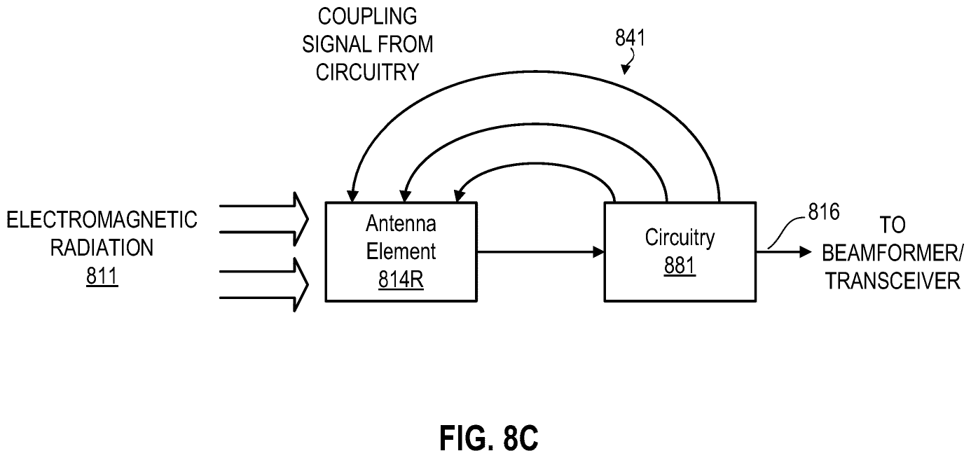

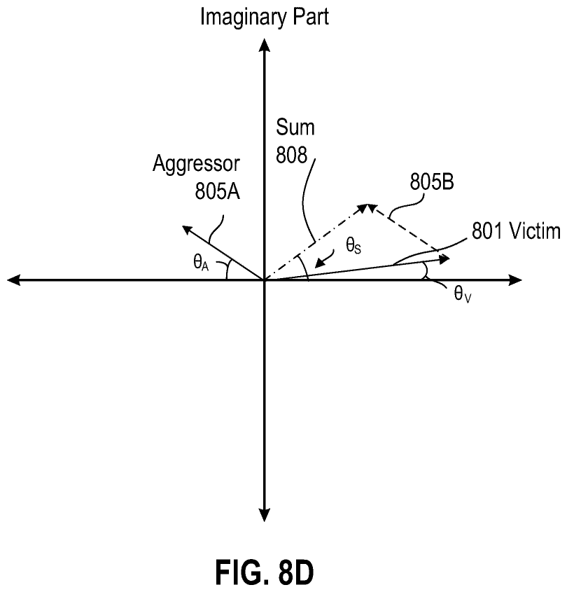

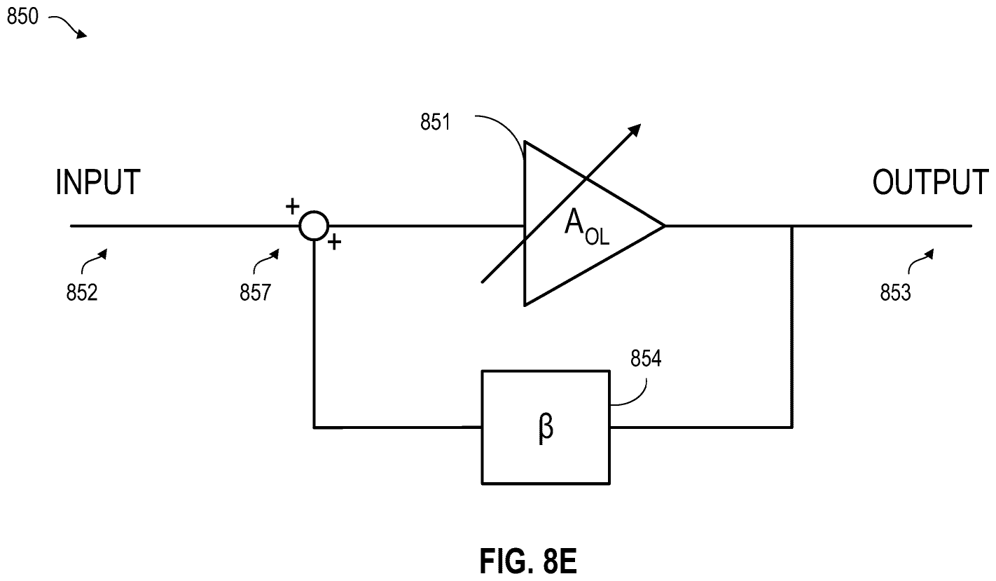

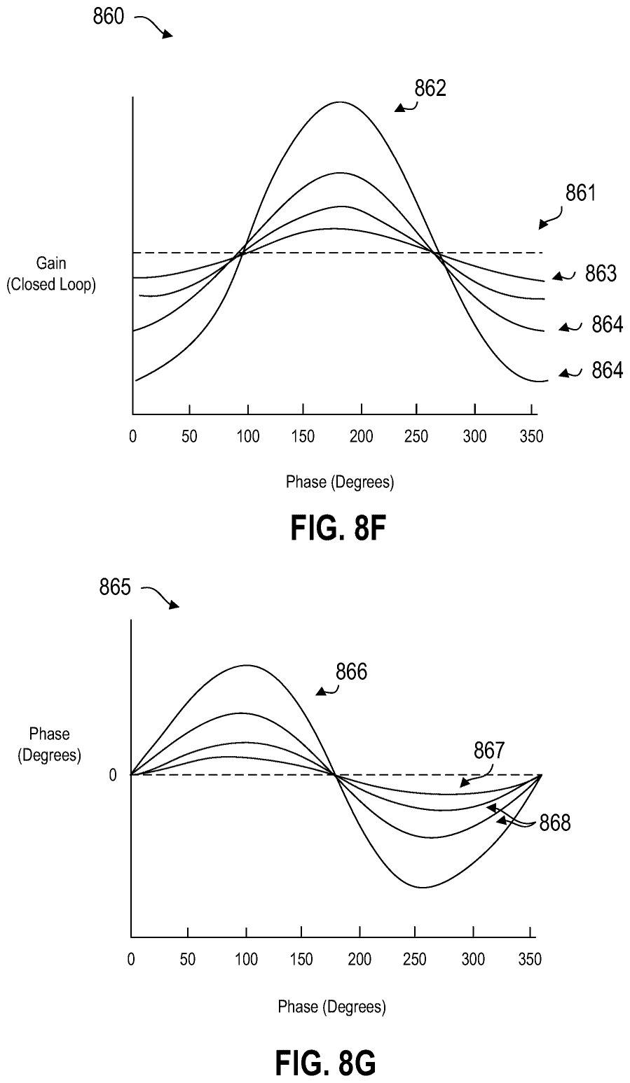

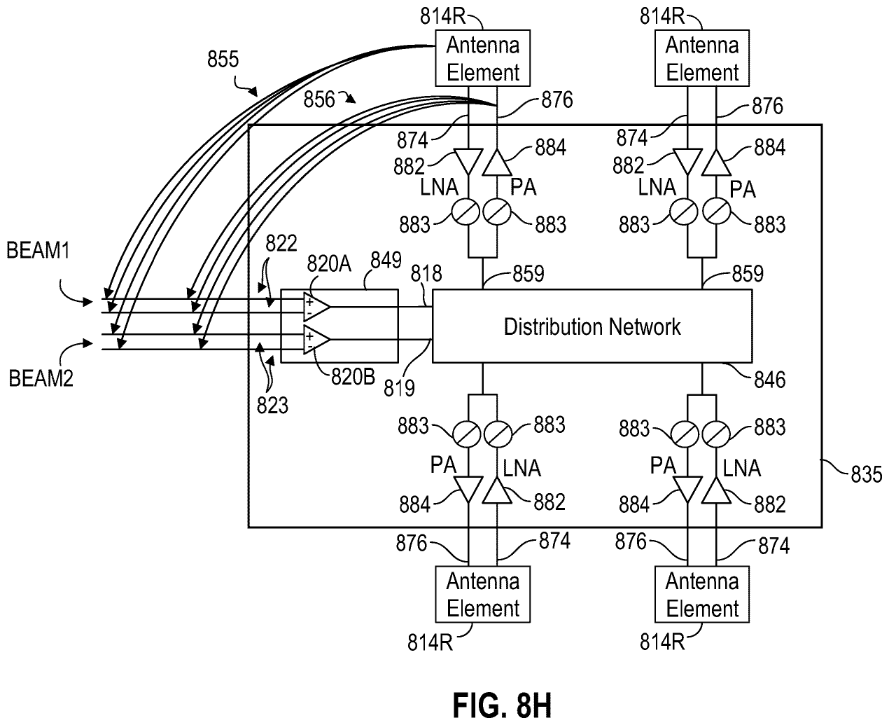

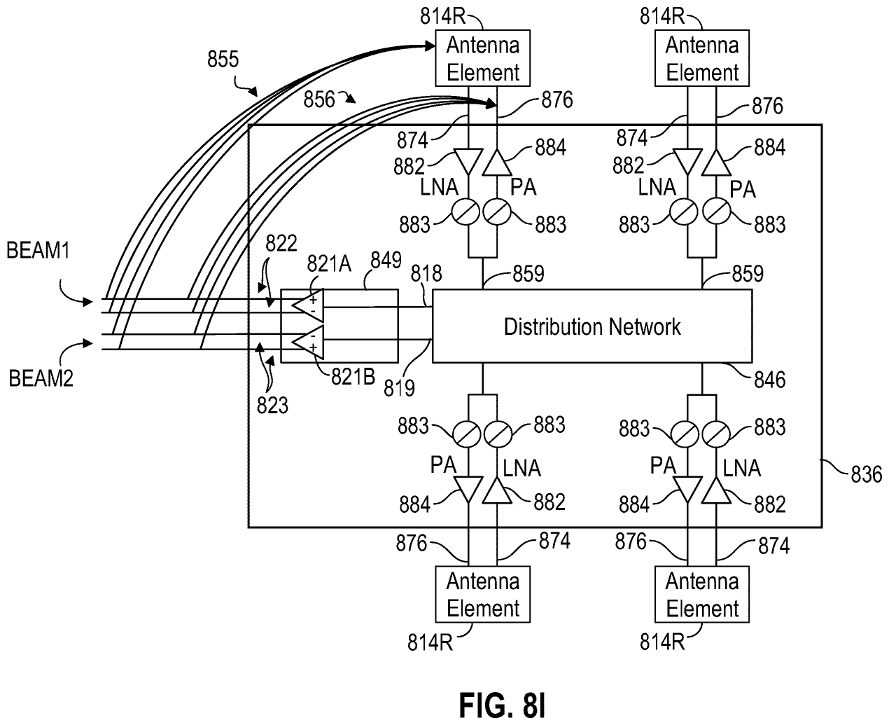

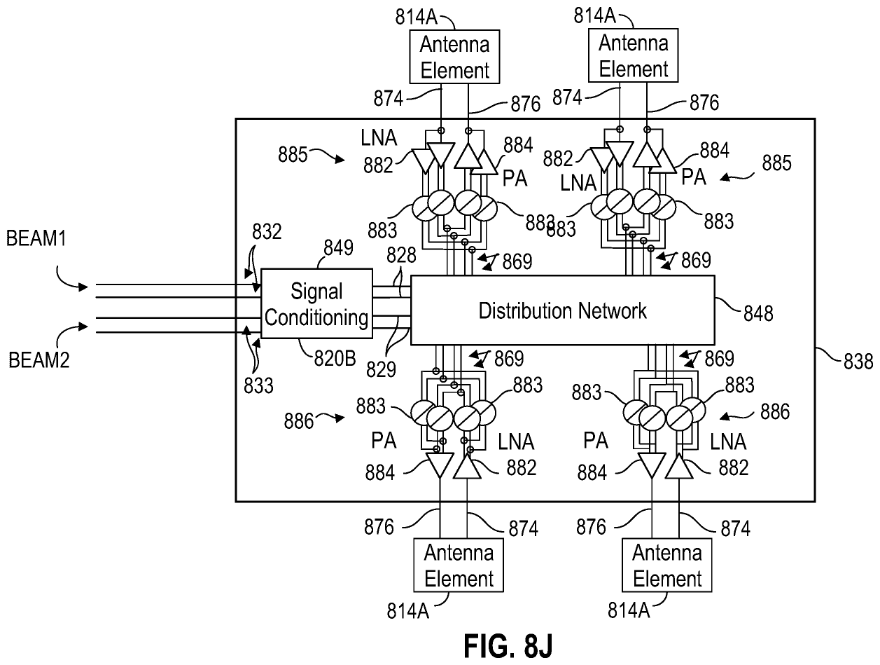

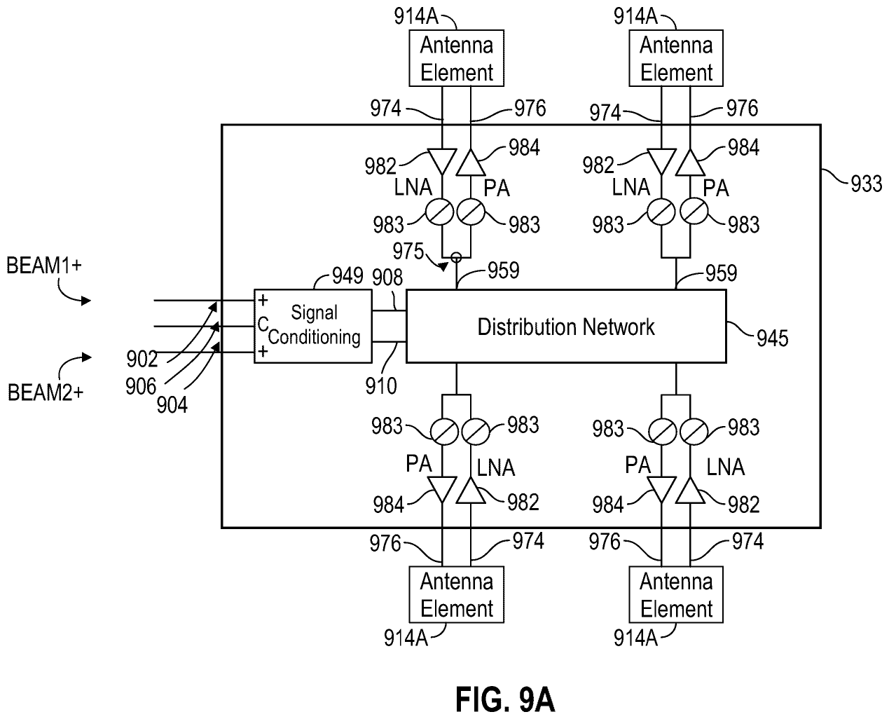

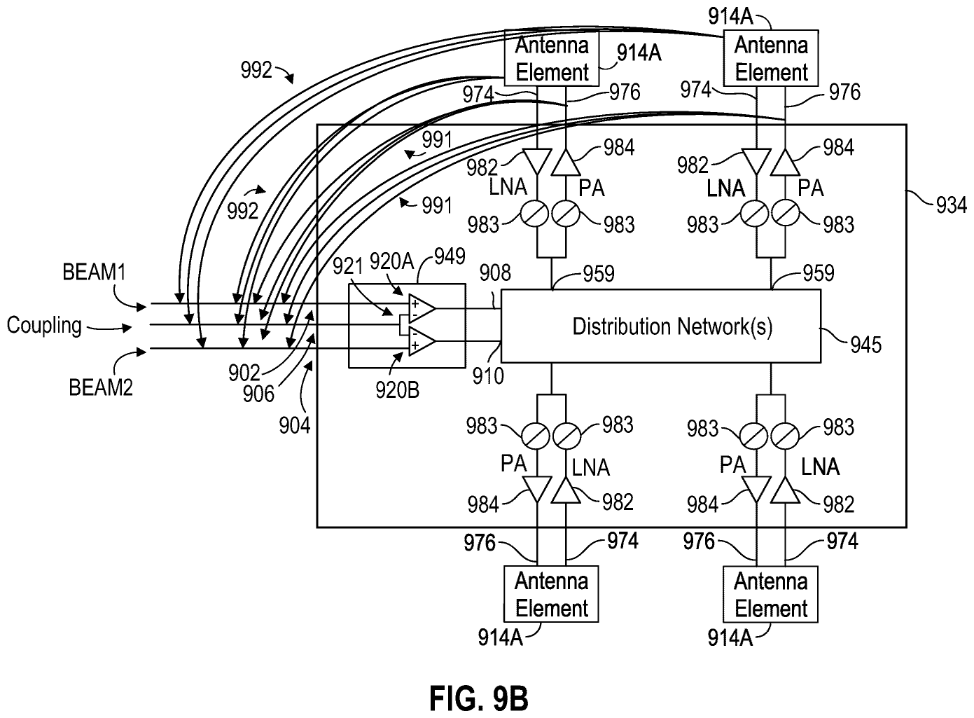

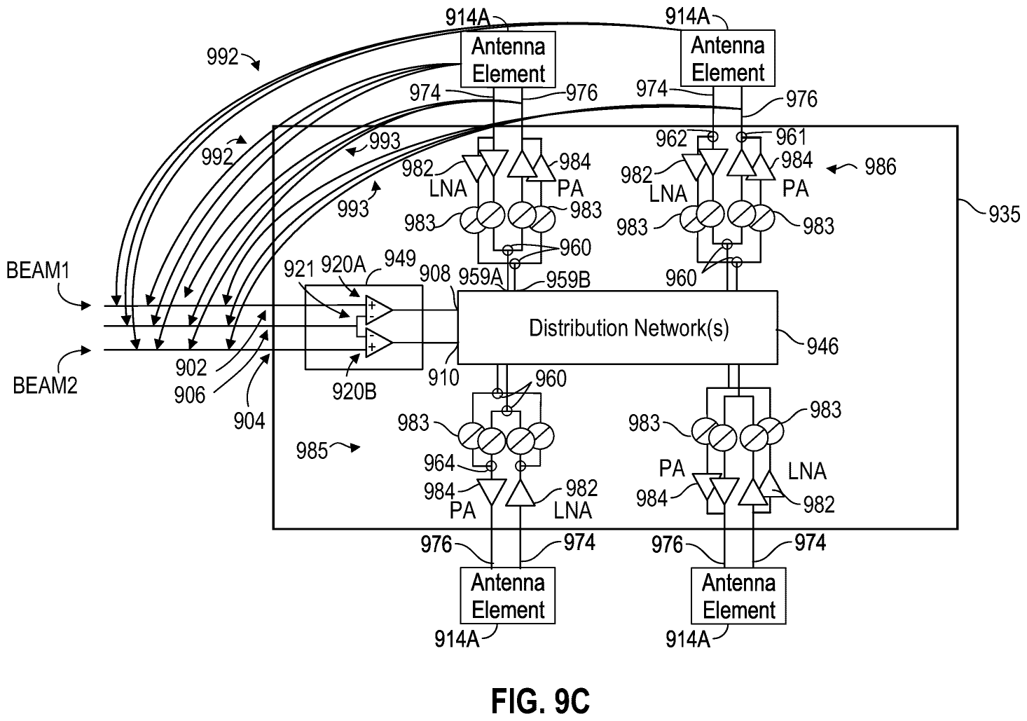

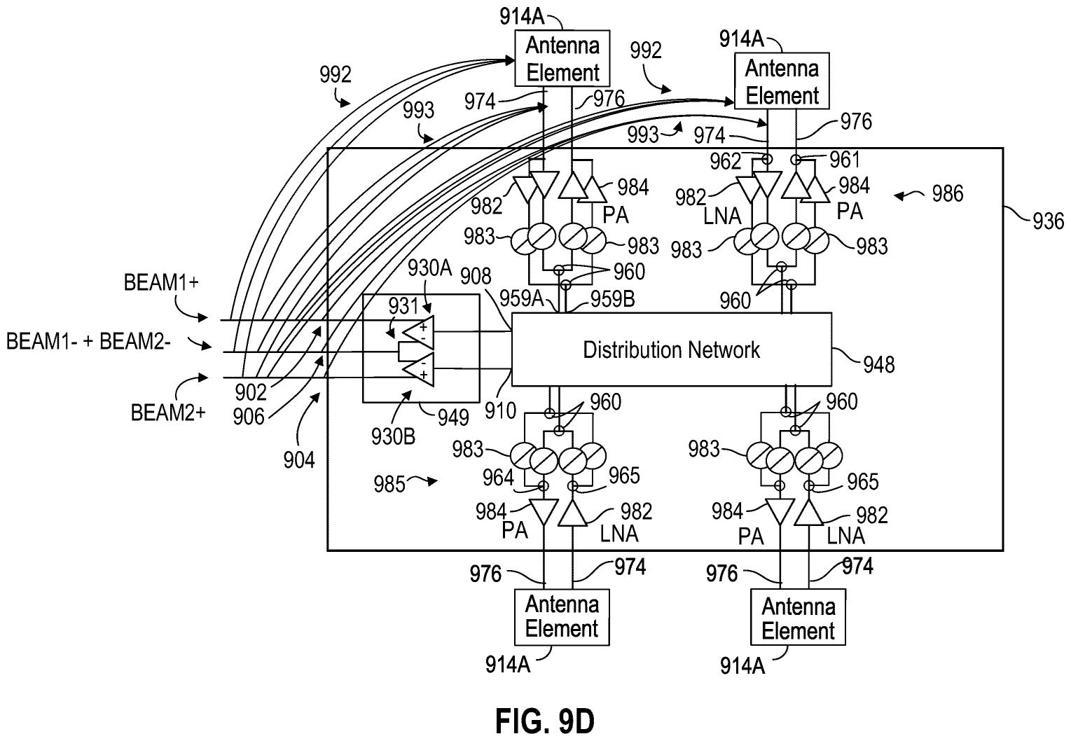

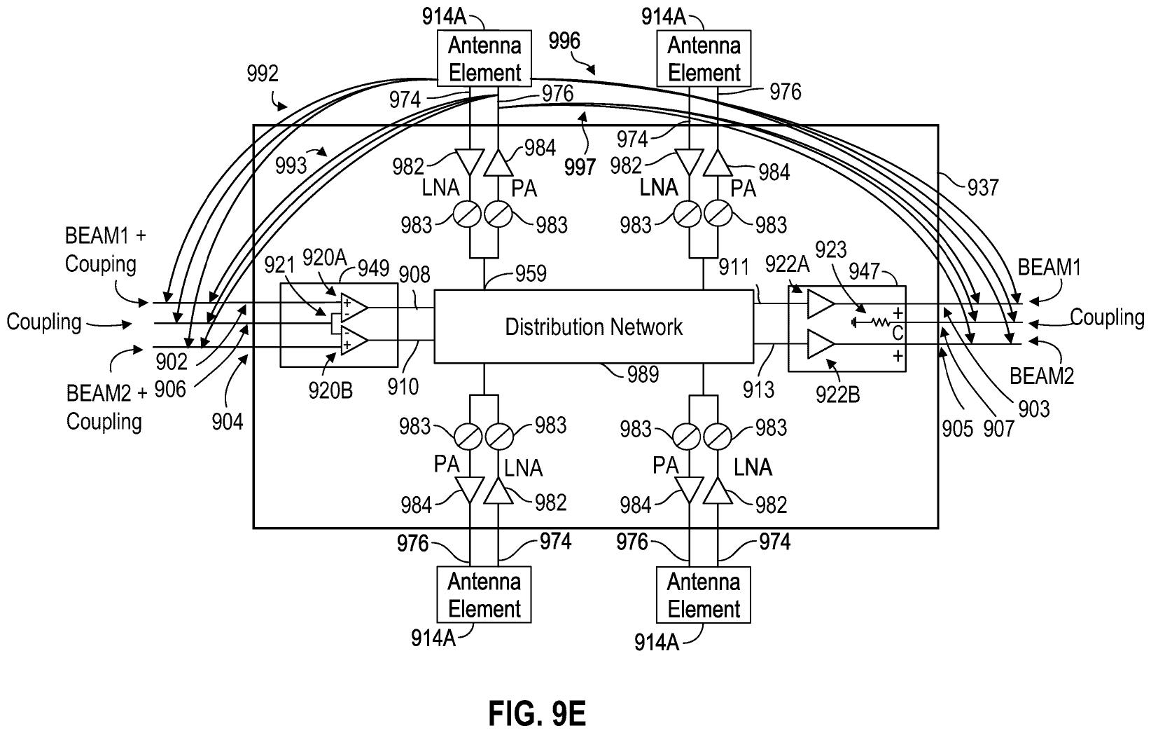

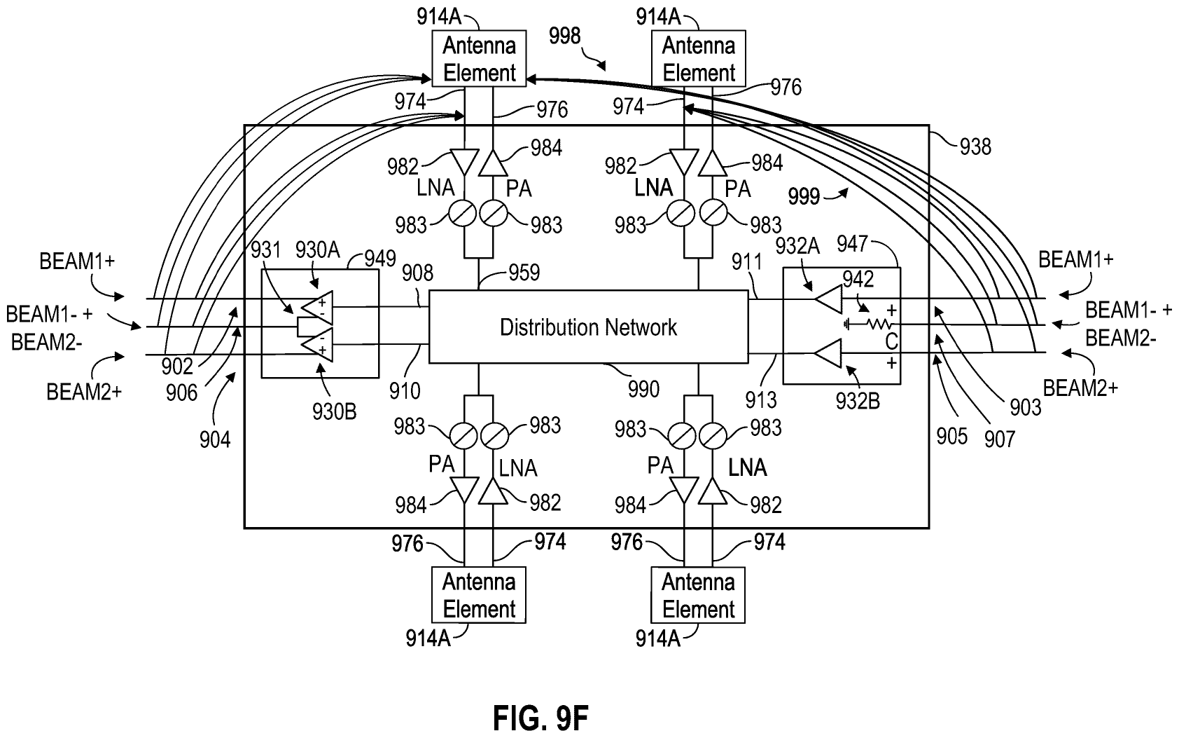

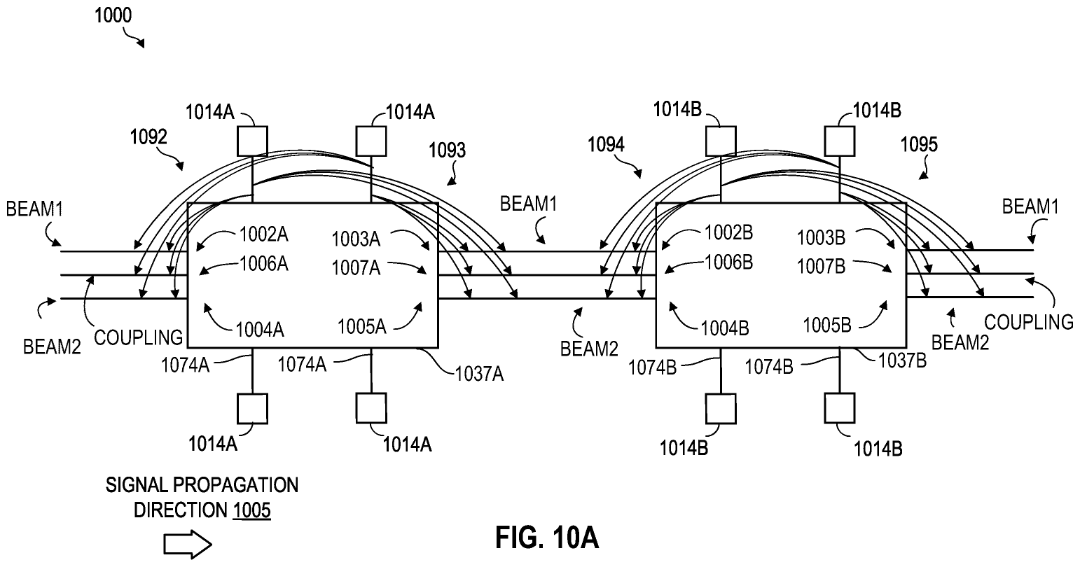

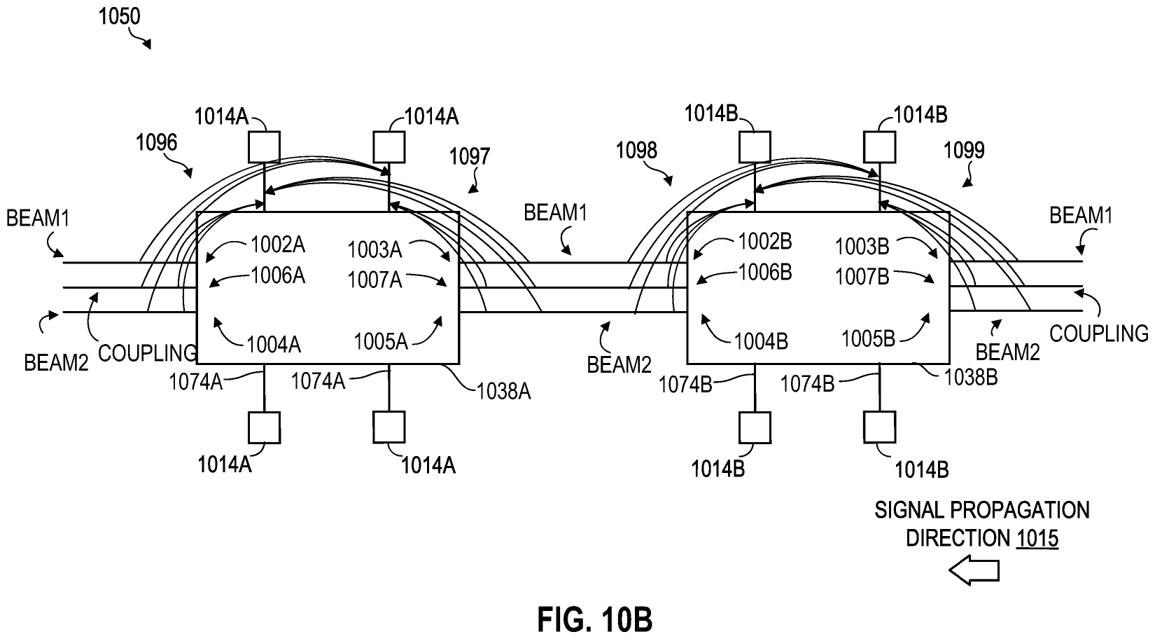

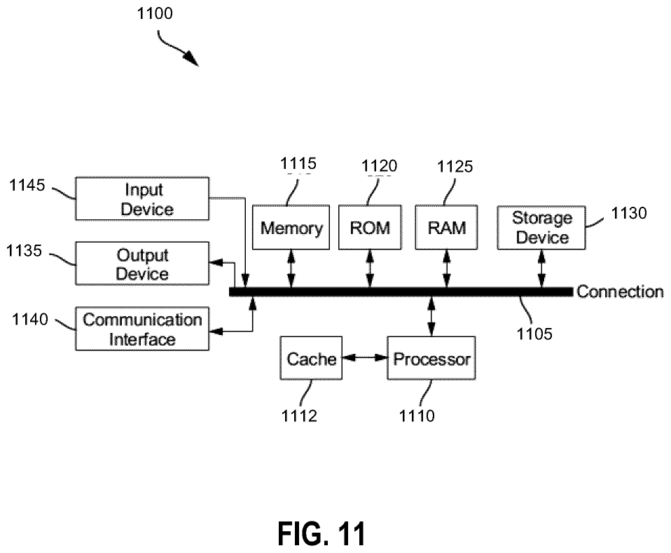

The disclosed systems and techniques will be described in the following disclosure as follows. The discussion begins with a description of example systems and technologies for wireless communications and example phased array antennas and circuits, as illustrated in FIGS. 1A through 4C. A description of an additional phased array antenna configuration, as illustrated in FIGS. 5A through 5B, will then follow. A description of routing between a BF and a serially fed FE network for a single beam phased array antenna, as illustrated in FIG. 6, will then follow. A description of routing between BFs and serially fed FE networks for a multiple beam phased array antenna, as illustrated in FIG. 7, will then follow. A description of example signal coupling models and coupling cancellation configurations, as illustrated in FIGS. 8A through 8J, will then follow. A description of various coupling cancelation configurations, as illustrated in FIGS. 9A through 9F, will then follow. A description of various coupling cancelation configurations, as illustrated in FIGS. 10A and 10B, will then follow. The discussion concludes with a description of an example computing and architecture including example hardware components that can be implemented with phased array antennas and other electronic systems, as illustrated in FIG. 11. The disclosure now turns to FIG. 1A.

FIG. 1A is a block diagram illustrating an example wireless communication system 100, in accordance with some examples of the present disclosure. In this example, the wireless communication system 100 is a satellite-based communication system and includes one or more satellites (SATs) 102A-102N (collectively “102”), one or more satellite access gateways (SAGs) 104A-104N (collectively “104”), user terminals (UTs) 112A-112N (collectively “112”), user network devices 114A-114N (collectively “114”), and a ground network 120 in communication with a network 130, such as the Internet.

The SATs 102 can include orbital communications satellites capable of communicating with other wireless devices or networks (e.g., 104, 112, 114, 120, 130) via radio telecommunications signals. The SATs 102 can provide communication channels, such as radio frequency (RF) links (e.g., 106, 108, 116), between the SATs 102 and other wireless devices located at different locations on Earth and/or in orbit. In some examples, the SATs 102 can establish communication channels for Internet, radio, television, telephone, radio, military, and/or other applications.

The user terminals 112 can include any electronic devices and/or physical equipment that support RF communications to and from the SATs 102. The SAGs 104 can include gateways or earth stations that support RF communications to and from the SATs 102. The user terminals 112 and the SAGs 104 can include antennas for wirelessly communicating with the SATs 102. The user terminals 112 and the SAGs 104 can also include satellite modems for modulating and demodulating radio waves used to communicate with the SATs 102. In some examples, the user terminals 112 and/or the SAGs 104 can include one or more server computers, routers, ground receivers, earth stations, user equipment, antenna systems, communication nodes, base stations, access points, and/or any other suitable device or equipment. In some cases, the user terminals 112 and/or the SAGs 104 can perform phased-array beamforming and digital processing to support highly directive, steered antenna beams that track the SATs 102. Moreover, the user terminals 112 and/or the SAGs 104 can use one or more frequency bands to communicate with the SATs 102, such as the Ku and/or Ka frequency bands.

The user terminals 112 can be used to connect the user network devices 114 to the SATs 102 and ultimately the Internet 130. The SAGs 104 can be used to connect the ground network 120 and the Internet 130 to the SATs 102. For example, the SAGs 104 can relay communications from the ground network 120 and/or the Internet 130 to the SATs 102, and communications from the SATs 102 (e.g., communications originating from the user network devices 114, the user terminals 112, or the SATs 102) to the ground network 120 and/or the Internet 130.

The user network devices 114 can include any electronic devices with networking capabilities and/or any combination of electronic devices such as a computer network. For example, the user network devices 114 can include routers, network modems, switches, access points, smart phones, laptop computers, servers, tablet computers, set-top boxes, Internet-of-Things (IoT) devices, smart wearable devices (e.g., head-mounted displays (HMDs), smart watches, etc.), gaming consoles, smart televisions, media streaming devices, autonomous vehicles or devices, user networks, etc. The ground network 120 can include one or more networks and/or data centers. For example, the ground network 120 can include a public cloud, a private cloud, a hybrid cloud, an enterprise network, a service provider network, an on-premises network, and/or any other network.

In some cases, the SATs 102 can establish communication links between the SATs 102 and the user terminals 112. For example, SAT 102A can establish communication links 116 between the SAT 102A and the user terminals 112A-112D and/or 112E-112N. The communication links 116 can provide communication channels between the SAT 102A and the user terminals 112A-112D and/or 112E-112N. In some examples, the user terminals 112 can be interconnected (e.g., via wired and/or wireless connections) with the user network devices 114. Thus, the communication links between the SATs 102 and the user terminals 112 can enable communications between the user network devices 114 and the SATs 102. In some examples, each of the SATs 102A-N can serve user terminals 112 distributed across and/or located within one or more cells 110A-110N (collectively “110”). The cells 110 can represent geographic areas served and/or covered by the SATs 102. For example, each cell can represent an area corresponding to the satellite footprint of radio beams propagated by a SAT. In some cases, a SAT can cover a single cell. In other cases, a SAT can cover multiple cells. In some examples, a plurality of SATs 102 can be in operation simultaneously at any point in time (also referred to as a satellite constellation). Moreover, different SATs can serve different cells and sets of user terminals.

The SATs 102 can also establish communication links 106 with each other to support inter-satellite communications. Moreover, the SATs 102 can establish communication links 108 with the SAGs 104. In some cases, the communication links between the SATs 102 and the user terminals 112 and the communication links between the SATs 102 and the SAGs 104 can allow the SAGs 104 and the user terminals 112 to establish a communication channel between the user network devices 114, the ground network 120 and ultimately the Internet 130. For example, the user terminals 112A-D and/or 112E-N can connect the user network devices 114A-114D and/or 114E-114N to the SAT 102A through the communication links 116 between the SAT 102A and the user terminals 112A-D and/or 112E-N. The SAG 104A can connect the SAT 102A to the ground network 120, which can connect the SAGs 104A-N to the Internet 130. Thus, the communication links 108 and 116, the SAT 102A, the SAG 104A, the user terminals 112A-D and/or 112E-N and the ground network 120 can allow the user network devices 114A-114D and/or 114E-114N to connect to the Internet 130.

In some examples, a user can initiate an Internet connection and/or communication through a user network device from the user network devices 114. The user network device can have a network connection to a user terminal from the user terminals 112, which it can use to establish an uplink (UL) pathway to the Internet 130. The user terminal can wirelessly communicate with a particular SAT from the SATs 102, and the particular SAT can wirelessly communicate with a particular SAG from the SAGs 104. The particular SAG can be in communication (e.g., wired and/or wireless) with the ground network 120 and, by extension, the Internet 130. Thus, the particular SAG can enable the Internet connection and/or communication from the user network device to the ground network 120 and, by extension, the Internet 130.

In some cases, the particular SAT and SAG can be selected based on signal strength, line-of-sight, and the like. If a SAG is not immediately available to receive communications from the particular SAT, the particular SAG can be configured to communicate with another SAT. The second SAT can in turn continue the communication pathway to a particular SAG. Once data from the Internet 130 is obtained for the user network device, the communication pathway can be reversed using the same or different SAT and/or SAG as used in the UL pathway.

In some examples, the communication links (e.g., 106, 108, and 116) in the wireless communication system 100 can operate using orthogonal frequency division multiple access (OFDMA) via time domain and frequency domain multiplexing. OFDMA, also known as multicarrier modulation, transmits data over a bank of orthogonal subcarriers harmonically related by the fundamental carrier frequency. Moreover, in some cases, for computational efficiency, fast Fourier transforms (FFT) and inverse FFT can be used for modulation and demodulation.

While the wireless communication system 100 is shown to include certain elements and components, one of ordinary skill will appreciate that the wireless communication system 100 can include more or fewer elements and components than those shown in FIG. 1A. For example, the wireless communication system 100 can include, in some instances, networks, cellular towers, communication hops or pathways, network equipment, and/or other electronic devices that are not shown in FIG. 1A.

FIG. 1B is a diagram illustrating an example of an antenna and satellite communication system 100 in accordance with some examples of the present disclosure. As shown in FIG. 1B, an Earth-based UT 112A is installed at a location directly or indirectly on the Earth's surface such as a house, building, tower, vehicle, or another location where it is desired to obtain communication access via a network of satellites.

A communication path may be established between the UT 112A and SAT 102A. In the illustrated example, the SAT 102A, in turn, establishes a communication path with a SAG 104A. In another example, the SAT 102A may establish a communication path with another satellite prior to communication with SAG 104A. The SAG 104A may be physically connected via fiber optic, Ethernet, or another physical connection to a ground network 120. The ground network 120 may be any type of network, including the Internet. While one satellite is illustrated, communication may be with and between a constellation of satellites.

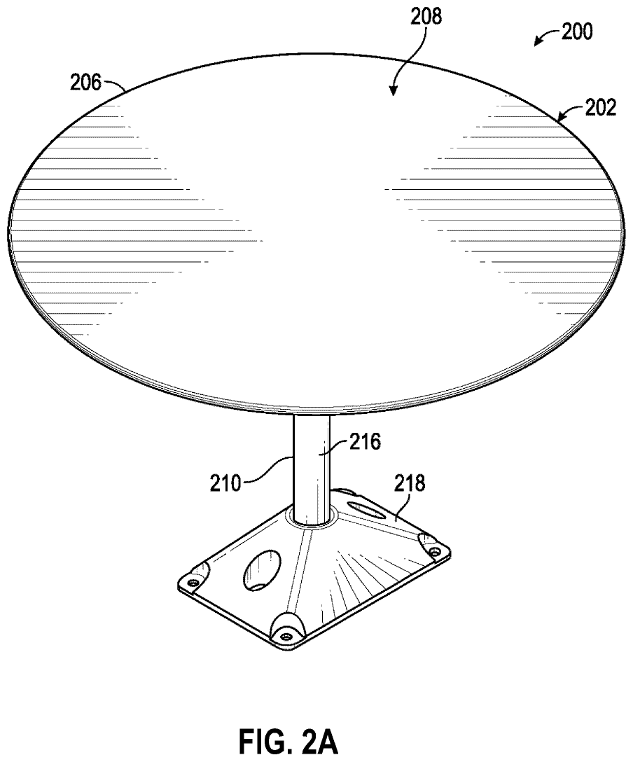

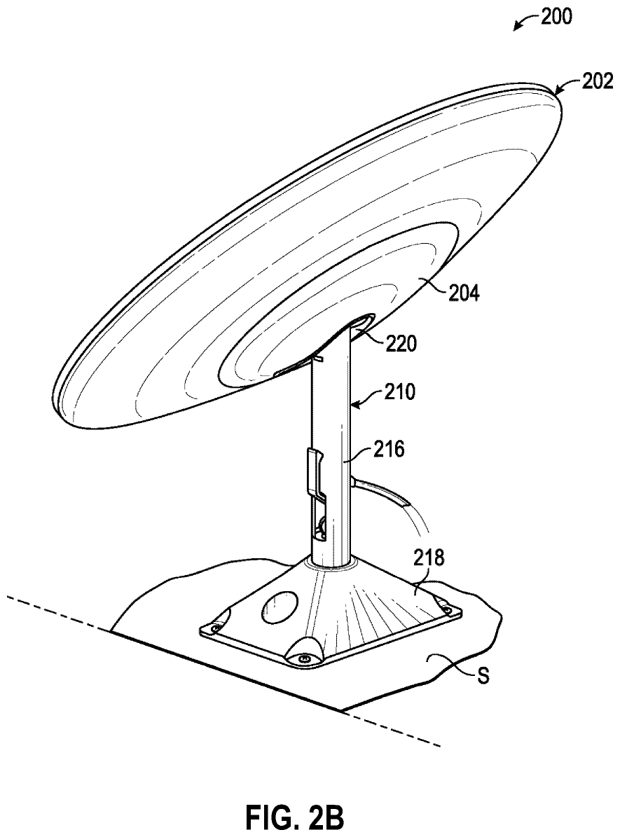

In some examples, the UT 112A may include an antenna system disposed in an antenna apparatus 200, for example, as illustrated in FIGS. 2A and 2B, designed for sending and/or receiving radio frequency signals to and/or from a satellite or a constellation of satellites. FIG. 2A illustrates an example top view of the antenna apparatus 200. The antenna apparatus 200 may include an antenna aperture 207 defining an area for transmitting and receiving signals, such as a phased array antenna system or another antenna system. The antenna apparatus 200 may include a top enclosure 208 that couples to a radome portion 206 to define a housing 202. The antenna apparatus 200 can also include a mounting system 210 having a leg 216 and a base 218.

FIG. 2B illustrates a perspective view of an underside of the antenna apparatus 200. As shown, the antenna apparatus 200 may include a lower enclosure 204 that couples to the radome portion 206 to define the housing 202. In the illustrated example, the mounting system 210 includes a leg 216 and a base 218. The base 218 may be securable to a surface S and configured to receive a bottom portion of the leg 216. A tilting mechanism 220 (details not shown) disposed within the lower enclosure 204 permits a degree of tilting to point the face of the radome portion 206 at a variety of angles for optimized communication and for rain and snow run-off.

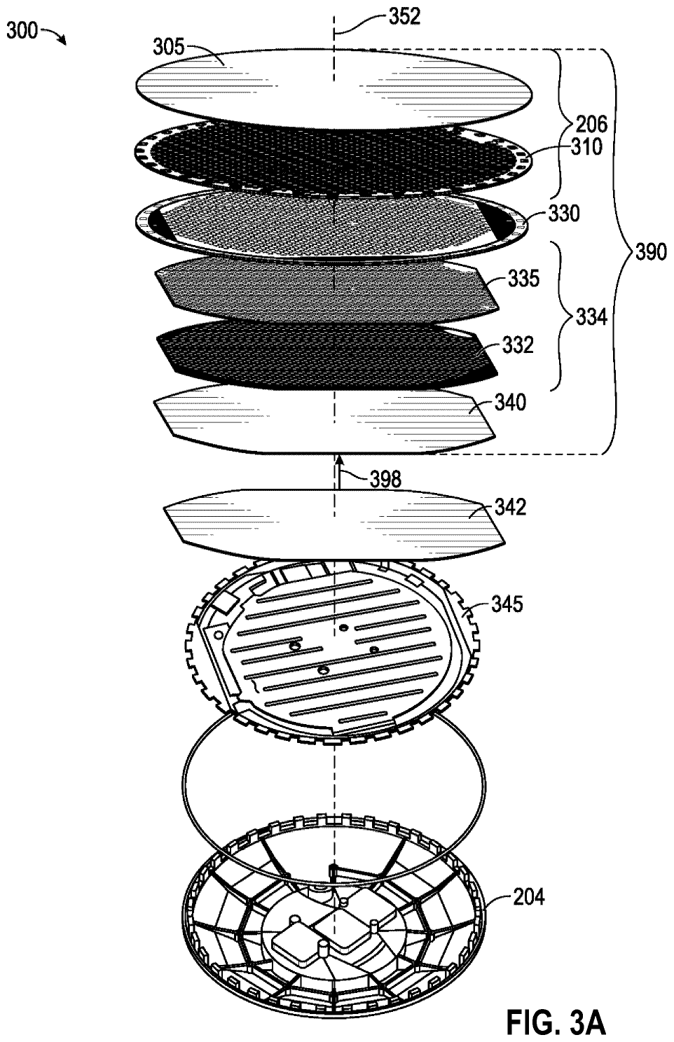

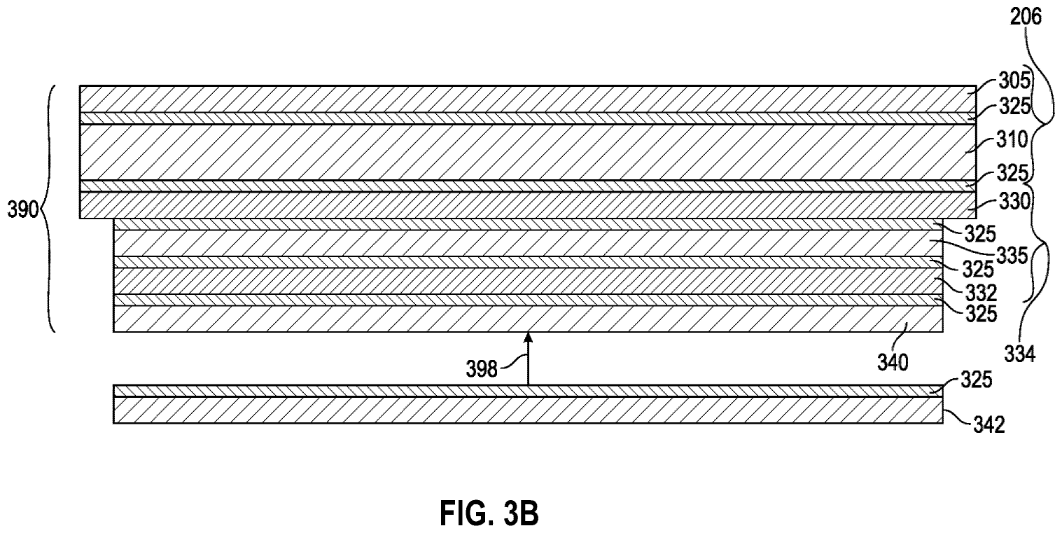

Referring to FIG. 3A, an antenna stack assembly 300 can include a plurality of antenna components, which can include a printed circuit board (PCB) assembly 342 configured to couple to other electrical components disposed within the housing assembly 202 (including lower enclosure 204 and radome assembly 206). In the illustrated example, the antenna stack assembly 300 includes a phased array antenna assembly including a plurality of individual antenna elements configured in an array. The components of the phased array antenna assembly 334 may be mechanically and electrically supported by the PCB assembly 342.

In the illustrated example of FIGS. 3A and 3B, the layers in the antenna stack assembly 300 layup include a radome assembly 206 (including radome 305 and radome spacer 310), a phased array patch antenna assembly 334 (including upper patch layer 330, lower patch layer 332, and antenna spacer 335 in between), a dielectric layer 340, and PCB assembly 342, as will be described in greater detail below. As seen in FIG. 3B, the layers may include adhesive coupling 325 between adjacent layers.

Phased Array Antenna with Serially Fed Frontend Networks

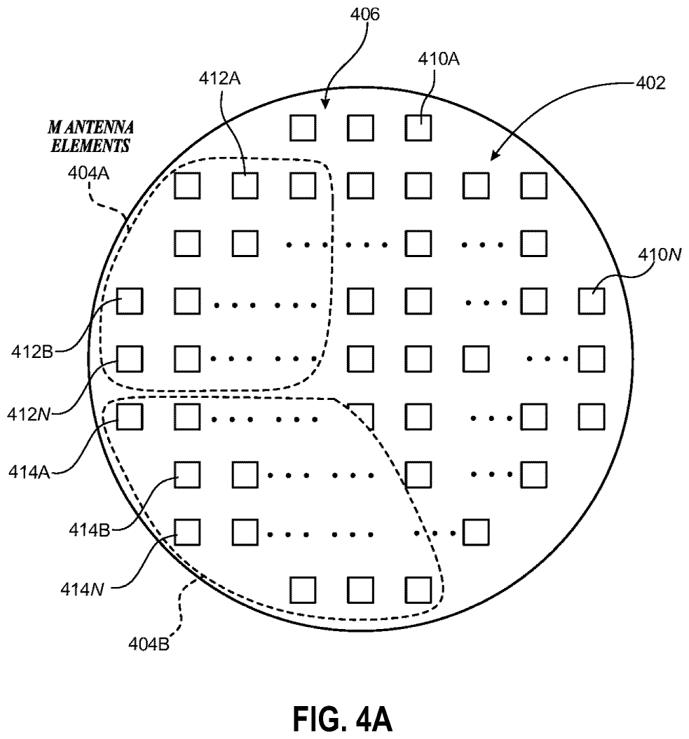

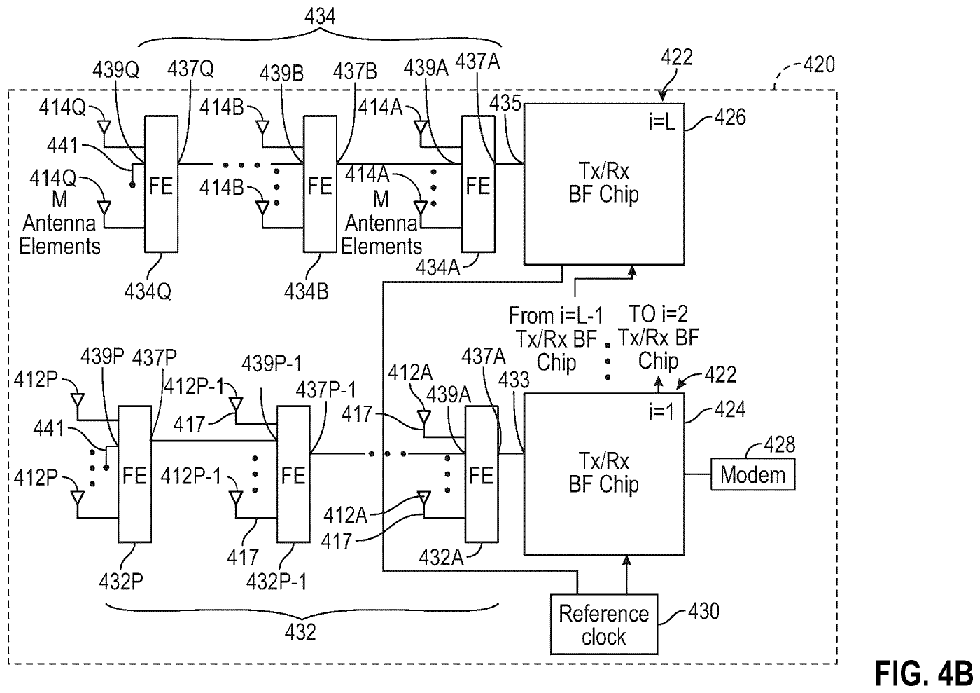

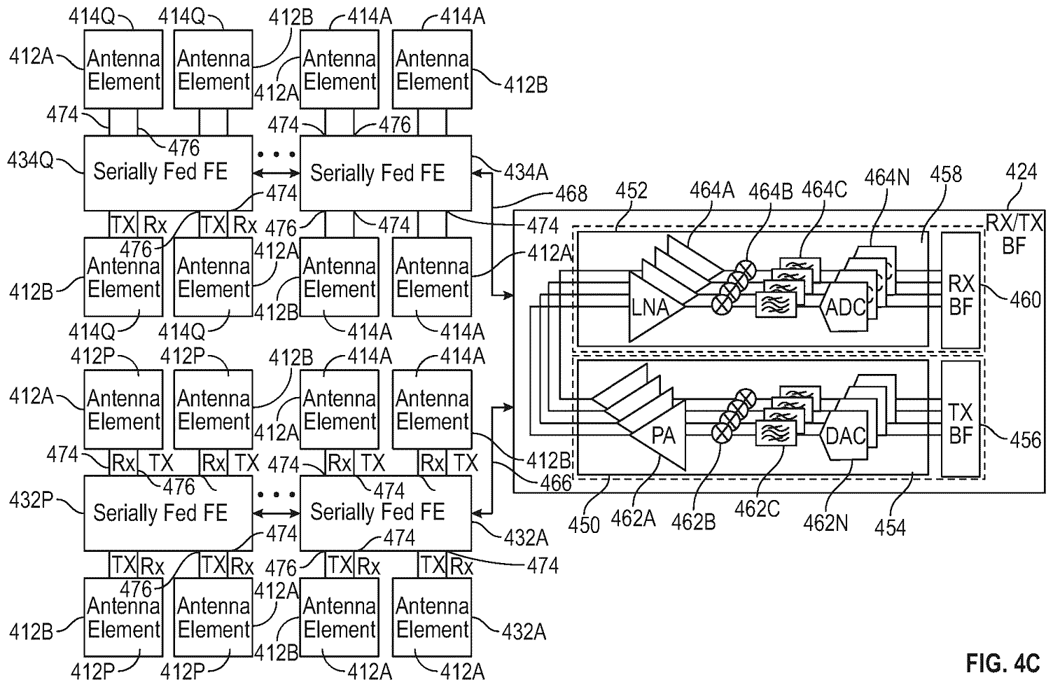

FIG. 4A is a diagram illustrating an example top view of an antenna lattice 406, in accordance with some examples of the present disclosure. The antenna lattice 406 can be part of a phased array antenna system, as further described below with respect to FIGS. 4B and 4C. The antenna lattice 406 can include antenna elements 410A-410N (collectively “410”), 412 A-412N (collectively “412”), 414A-414N (collectively “414”) configured to transmit and/or send radio frequency signals. In some examples, the antenna elements 410, 412, 414 can be coupled to (directly or indirectly) corresponding amplifiers, as further described below with respect to FIGS. 4B and 4C. The amplifiers can include, for example, low noise amplifiers (LNAs) in the receiving (Rx) direction or power amplifiers (PAs) in the transmitting (Tx) direction.

An antenna aperture 402 of the antenna lattice 406 can be an area through which power is radiated or received. A phased array antenna can synthesize a specified electric field (phase and amplitude) across the antenna aperture 402. The antenna lattice 406 can define the antenna aperture 402 and can include the antenna elements 410, 412, 414 arranged in a particular configuration that is supported physically and/or electronically by a PCB.

In some cases, the antenna aperture 402 can be grouped into subsets of antenna elements 404A and 404B. Each subset of antenna elements 404A, 404B of antenna elements can include N number of antenna elements 412, 414, which can be associated with specific beamformer (BF) chips as shown in FIGS. 4B and 4C. The remaining antenna elements 410 in the antenna aperture 402 can be similarly associated with other BF chips (not shown).

FIG. 4B is a diagram illustrating an example phased array antenna system 420, in accordance with some examples. The phased array antenna system 420 can include an antenna lattice 406 including antenna elements 412, 414, and a BF lattice 422, which in this example includes BF chips 424, 426, for receiving signals from a modem 428 in the transmit (Tx) direction and sending signals to the modem 428 in the receive (Rx) direction. The antenna lattice 406 can be configured to transmit and/or receive a beam of radio frequency signals having a radiation pattern from or to the antenna aperture 402.

The BF chips 424, 426 in the BF lattice 422 can include an L number of BF chips. For example, BF chip 424 can include a first BF chip i (i=1, where i=1 to L), and so forth, and BF chip 426 can include the Lₜₕ BF chip (i=L) of the BF chips in the BF lattice 422. Each BF chip 424, 426 of the BF lattice 422 electrically couples with one or more serially fed signal distribution networks. For the purposes of illustration, the examples of FIG. 4B through 4C illustrate serially fed FE networks 432, 434. For example, although the examples of FIG. 4B through 4C illustrate amplification by PAs/LNAs and phase shifting by phase shifters included within individual FEs of a serially fed FE network, other example serially fed signal distribution networks may exclude LNAs, PAs, and/or phase shifters without departing from the scope of the present disclosure.

For example, a BF radio frequency input/output (RFIO) 433 of BF chip 424 is electrically coupled to serially fed FE network 432. Similarly, BF RFIO 435 of BF chip 426 is electrically coupled to serially fed FE network 434. Although one BF RFIO 433, 435 is shown for each BF chip 424, 426, each BF can include multiple BF RFIOs which can each couple to one or more serially fed FE networks as described in more detail below with respect to FIGS. 4C, 6, and 7 below. Although FIG. 4B illustrates a phased array antenna system including multiple BF chips 426, in some cases, a phased array antenna system including a single BF chip 426 (e.g., L=1) can be used with serial fed FE networks (e.g., 432, 434) without departing from the scope of the present disclosure.

The phased array antenna system 420 can include serially fed FE networks 432, 434. Each serially fed FE network 432, 434 can include multiple individual FEs, with serial signal distribution between individual FEs of the serially fed FE networks 432, 434. For example, as illustrated in FIG. 4B, serially fed FE network 432 can include P individual FEs and serially fed FE network 434 can include Q individual FEs. In some embodiments, the number of individual FEs in each serially fed FE network 432, 434 of a phased array antenna system 420 can be equal (e.g., P=Q). However, there is no requirement for each of the serially fed FE networks 432, 434 in a phased array antenna system to include equal numbers of individual FEs.

In some cases, additional digital signals can be communicated between one or more BFs of the BF lattice and individual FEs of the serially fed FE networks. For example, digital signals (e.g., one or more clocks, control signals, or the like) can be provided to the serially fed FE networks 434 by the BF chips 424, 426 of the BF lattice 422. In some cases, the digital signals can be provided to each individual FE of the phased array antenna in parallel. In some cases, the digital signals can be provided to initial FEs (e.g., 432A, 434A) of the serially fed FE networks and serially distributed to the remaining individual FEs of the serially fed FE networks.

Referring to FIG. 4B, each of the individual FEs, 432A-432P of the serially fed FE network 432 can include an RF serial input 437A through 437P and RF serial output 439A through 439P. Similarly, each of the induvial FEs 434A-434Q of the serially fed FE network 434 can include an RF serial input 437A through 437Q and an RF serial output 439A through 439Q. Each individual FE 432A-432P, 434A-434Q of the serially fed FE networks 432, 434 can interface with M antenna elements through coupling antenna traces 417. The value for M can be any positive integer. As used herein, the RF serial inputs 437A through 437P of serially fed FE network 432 and RF serial inputs 437A through 437Q of serially fed FE network 434 are collectively referred to as RF serial inputs 437. As used herein, the RF serial outputs 439A through 439P of serially fed FE network 432 and RF serial outputs 439A through 439Q of serially fed FE network 434 are collectively referred to as RF serial outputs 439. The terms “input” and “output” used to describe RF serial inputs 437 and RF serial outputs 439 are consistent with the phased array antenna system 420 operating in a transmit (Tx) configuration. However, for the purposes of consistently identifying the RF serial input 437 and RF serial output 439 of each individual FE, the descriptors “input” for RF serial input 437 and “output” RF serial output 439 are used whether the phased array antenna system 420 (or a subset of antenna elements of the phased array antenna system 420, such as antenna elements 404A, 404B of FIG. 4A) is operating in a transmit (Tx) configuration or a receive (Rx) configuration. In some cases, such as when the serially fed FE networks are used for both receiving and transmitting configurations, the RF serial inputs 437 and RF serial outputs 439 can also be referred to as RF serial input/outputs (IOs) herein.

As illustrated in FIG. 4B, M antenna elements 412A are coupled to individual FE 432A, M antenna elements 412P-1 are coupled to individual FE 432P-1, and so on with M antenna elements 412P coupled to individual FE 432P at the end of the serially fed FE network 432. Similarly, M antenna elements 414A are coupled to individual FE 434A, M antenna elements 414B are coupled to individual FE 434B, and so on with M antenna elements 412Q coupled to individual FE 432Q at the end of the serially fed FE network 434. In some implementations, the individual FEs of the serially fed FE networks 432, 434 can include circuitry for performing analog processing of RF signals received from and/or transmitted to the antenna elements 412, 414. In some implementations, the BF chips 424, 426 in combination with the serially fed FE networks 432, 434 can collectively form a hybrid beamforming network (e.g., including both analog and digital beamforming components). A hybrid beamforming network may also be referred to as a hybrid beamformer, HBF, or hybrid analog/digital beamformer herein. In some cases, the BFs and FEs can form an analog beamforming network without departing from the scope of the present disclosure. In some implementations, the BF chips illustrated in FIG. 4B can be replaced with any RF transceiver. For example, in the case of a phased array antenna system including a single serially fed FE network (e.g., one of serially fed FE networks 432, 434), a single transceiver can be used in place of a BF chip and beamforming functionality can be performed by the individual FEs of the serially fed FE network. Although multiple BF chips 424, 426 are illustrated in FIG. 4B, a phased array antenna system including a single BF chip can be used with a serially fed FE network without departing from the scope of the present disclosure.

Each serially fed FE network 432, 434 can include an initial FE 432A, 434A, that interfaces with the BF chips 424, 426 and a first set of M antenna elements 412A, 414A. As used herein, references to an initial FE 432A, 434A means that the RF serial input 437A of the initial FE 432A, 434A is communicatively coupled to a BF IO and/or a distribution/combination network coupled to a corresponding BF IO. For example, an RF serial input 437A of initial FE 432A can communicatively couple with BF RFIO 433 of BF chip 424 and RF serial input 437A of the initial FE 434A can communicatively couple with BF RFIO 435 of BF chip 426. As illustrated, the RF serial output 439A of initial FE 432A of the serially fed FE network 432 can subsequently be coupled to the RF serial input 437B of FE 432B, and so on for each subsequent individual FE 432C through 432P to form serially fed FE network 432. Similarly, the RF serial output 439A of initial FE 434A of the serially fed FE network 434 can subsequently be coupled to the RF serial input 437B of FE 434B, and so on for each subsequent individual FE 434C through 434Q to form serially fed FE network 434.

The serially fed FE networks (e.g., serially fed FE networks 432, 434) can be configured to provide the same gain between a BF RFIO (e.g., BF RFIO 433 of BF chip 424, BF RFIO 435 of BF chip 426) and each of the antenna elements (e.g., antenna elements 412, 414) coupled to the BF RFIO through the serially fed FE network. For example, a gain between the BF RFIO 433 and each antenna element 412A coupled to individual FE 432A and a gain between BF RFIO 433 and each antenna element 412P-1 coupled to individual FE 432P-1 can be equal to a common gain. In addition, a gain between the BF RFIO 433 and each antenna element 412P coupled to individual FE 432P can also be equal the common gain. In some cases, the gain between the BF RFIO 433 and different antenna elements of the antenna elements 412 coupled to the individual FEs of serially fed FE network 432 can be different. For example, gains between the BF RFIO 433 and antenna elements 412 can be configured to provide a desired excitation taper (e.g., an amplitude taper)

For the last individual FE 432P in the serially fed FE network 432 and last individual FE 434Q in serially fed FE network 434 there is no individual FE to couple to the RF serial output 439. As illustrated, the RF output of each last individual FE 432P, 434Q can be terminated with a matched termination 441. In some embodiments, the RF output of each last individual FE 432P, 434Q, and/or any associated signal conditioning components (see FIG. 8A) can be disabled. In some cases, disabling the RF output of a last individual FE 432P, 434Q can alleviate a requirement to terminate the RF output with an output termination.

In some implementations, each individual FE module 432A-432P, 434A-434Q of the serially fed FE networks 432, 434 can include RF or millimeter wave (mmWave) frontend integrated circuits, modules, devices, and/or any other type of frontend package and/or component(s). In some cases, the individual FEs 432A-432P, 434A-434Q of the serially fed FE networks 432, 434 can include multiple-input, multiple-output FEs interfacing with multiple antenna elements and one or more BF chips.

Each BF chip of the BF lattice 422 can include an integrated circuit (IC) chip or an IC chip package including a plurality of pins. In some cases, a first subset of the plurality of pins can be configured to communicate signals with a respective, electrically coupled BF chip(s) (e.g., if the BF chips are digital beamformers (DBFs)) in a daisy chain configuration), and/or modem 428 in the case of BF chip 424. A second subset of the plurality of pins can be configured to transmit/receive signals with M antenna elements, and a third subset of the plurality of pins can be configured to receive a signal from a reference clock 430. The BF chips in the BF lattice 422 may also be referred to as transmit/receive (Tx/Rx) BF chips, Tx/Rx chips, transceivers, BF transceivers, and/or the like. As described above, the BF chips may be configured for Rx communication, Tx communication, or both. Although the illustrated example of FIG. 4B shows components such as an ADC normally associated with DBFs, the BF chips 424 can be analog beamformers, DBFs, and in some cases simple transceivers without departing from the scope of the present disclosure.

In some cases, the BF chips 424, 426 in the BF lattice 422 can include amplifiers, phase shifters, mixers, filters, up samplers, down samplers, variable gain amplifiers (VGAs), and/or other electrical components. In the receiving direction (Rx), a beamformer function can include delaying signals arriving from each antenna element so the signals arrive to a combining network at the same time. In the transmitting direction (Tx), the beamformer function can include delaying the signal sent to each antenna element such that the signals arrive at the target location at the same time (or substantially the same time). This delay can be accomplished by using “true time delay” or a phase shift at a specific frequency. In some examples, each of the BF chips 424, 426 can be configured to operate in half duplex mode, where the BF chips 424, 426 switch between receive and transmit modes as opposed to full duplex mode where RF signals/waveforms can be received and transmitted simultaneously. In other examples, each of the BF chips 424, 426 can be configured to operate in full duplex mode, where RF signals/waveforms can be received and transmitted simultaneously.

Each individual FE within the serially fed FE networks 432, 434 electrically couples to a group of respective M number of antenna elements. In turn, the individual FEs 432A-432P, 434A-434Q of the serially fed FE networks 432, 434 collectively couple a BF RFIO 433, 435 from each BF chip to a respective M number of elements multiplied by the number of FEs in the corresponding serially fed FE network 432, 434. For example, BF RFIO 433 of BF chip 424 can electrically couple to M*P antenna elements 412 through serially fed FE network 432. Similarly, BF RFIO 435 of BF chip 426 can electrically couple to M*Q number of antenna elements 414 through serially fed FE network 434.

The serially fed FE networks 432, 434 can include various components, such as RF ports, phase shifters, amplifiers (e.g., PAs, LNAs, VGAs, etc.), signal conditioning components, and the like. In some examples, in Rx mode, the serially fed FE networks 432, 434 can provide a gain to RF contents of each Rx input (e.g., input from antenna traces 417, such as antenna Rx ports 474 of FIG. 4C and/or Rx inputs received at RF serial outputs 439 in Rx mode), and low noise power to suppress the signal-to-noise ratio impacts of noise contributors downstream in the Rx chain/path. In some cases, the serially fed FE networks 432, 434 can be configured to provide an equal gain between each individual antenna element of the antenna elements 412, 414 and a corresponding BF RFIO 433, 435. For example, a signal received at antenna element 414Q and a signal received at antenna element 414A can have equal gain along the path to BF RFIO 435.

Moreover, in Tx mode, the serially fed FE networks 432, 434 can provide gain to each Tx path (e.g., output to traces 417, antenna Tx ports 476 of FIG. 4C and/or Tx outputs transmitted from RF serial outputs 439 in Tx mode) and drive RF power into a corresponding antenna element 412, 414. In some cases, the serially fed FE networks 432, 434 can be configured to provide an equal gain between each BF RFIO 466, 468 and each corresponding individual antenna element of the antenna elements 412, 414. For example, a signal transmitted from BF RFIO 433 can have an equal gain at antenna element 412A and antenna element 412P-1. In some cases, the serially fed FE networks 432, 434 can be configured to provide gains between the BF RFIOs 433, 435 and different individual antenna elements of the antenna elements 412, 414. For example, the gain to different individual antenna elements can be set to provide an excitation taper (e.g., an amplitude taper) to the antenna elements 412, 414.

In the illustrated example of FIG. 4B, the BF chips in the BF lattice 422 are electrically coupled to each other in a daisy chain arrangement. In some cases, such as where the BF chips are analog BF chips, digital communication between BFs by a daisy chain arrangement can be excluded. The BF chips are also coupled to serially fed FE networks 432, 434 that include analog beamforming functionality in a hybrid beamforming network. The serially fed FE networks 432, 434 can be used in many different configurations without departing from the scope of the present disclosure. For example, the serially fed FE networks 432 can be used with analog BFs, digital BFs, transceivers, receivers, and/or transmitters. As another example, in some cases, aspects of the disclosure can be implemented using BFs and/or FEs having different arrangement(s) and/or electrical coupling structure(s).

FIG. 4C is a diagram illustrating example components of BF chip 424 communicatively coupling with two serially fed FE networks 432, 434 that each interface with the BF chip 424 through separate BF RFIOs 466, 468, respectively. In the illustrated configuration, BF RFIO 466 of the BF chip 424 is communicatively coupled to serially fed FE network 432 and each individual FE 432A-432P of the serially fed FE network 432 is communicatively coupled to M antenna elements 412A through 412P, respectively. As a result, the BF RFIO 466 can be communicatively coupled to M*P antenna elements 412A through 412P while being connected directly to the initial FE 432A of serially fed FE network 432. As a result, the BF RFIO 466 can be communicatively coupled to M*P antenna elements 412A through 412P while being directly connected to the initial FE 432A of serially fed FE network 432. As illustrated in FIG. 4C, BF RFIO 468 of the BF chip 424 is communicatively coupled to serially fed FE network 434 and each individual FE 434A-434Q of the serially fed FE network 434 is communicatively coupled to M antenna elements 414A through 414Q, respectively. As a result, the BF RFIO 468 can be communicatively coupled to M*P antenna elements 412A through 412P while only being directly connected to the initial FE 434A of serially fed FE network 434. Each BF in the BF lattice 422 can similarly include multiple BF RFIOs each communicatively coupled to one or more serially fed FE networks, thereby allowing the number of antenna elements 412, 414 in the phased array antenna system 420 to be scaled. In some embodiments, one or more BF RFIOs 466, 468 can also be distributed (e.g., through a distribution network, distributor/combiners, or the like) to multiple serially fed FE networks as a means of scaling the phased array antenna system 420.

In the illustrated example of FIG. 4C, the BF chip 424 can include a transmit section 450 and a receive section 452, and the serially fed FE networks 432, 434 can each include an RF serial input 437 and an RF serial output 439. Although described as “input” and “output” ports, in the illustrated embodiment the RF serial input 437 and RF serial output 439 can each be used for bidirectional communication with the BF chip 424 and/or the antenna elements 412. As illustrated, each individual FE 432A through 432P includes M antenna Rx ports 474 and M antenna Tx ports 476, with an antenna Rx port 474 and an antenna Tx port 476 provided for each of the M connected antenna elements 412. Similarly, each individual FE 434A through 434Q also includes M antenna Rx ports 474 and antenna Tx ports 476, with an antenna Tx port 476 and an antenna Rx port 474 provided for each of the M connected antenna elements 414. In the illustrated example, each individual FE 432A through 432P, 434A through 434Q is coupled to four antenna elements 412, 414 (e.g., M=4). Different values for M can be chosen (e.g., M=2, M=3, M=8, or any other value) without departing from the scope of the present disclosure.

The transmit section 450 of BF chip 424 can include a transmit beamformer (Tx BF) 456 and one or more Tx RF sections 454. The Tx BF 456 can include a number of components (e.g., digital and/or analog) such as, for example and without limitation, a VGA, a time delay filter, a filter, a gain control, one or more phase shifters, one or more up samplers, one or more IQ gain and phase compensators, and the like. Each Tx RF section 454 can also include a number of components (e.g., digital and/or analog). In this example, each Tx RF section 454 includes a power amplifier (PA) 462A, a mixer 462B, a filter 462C such as a low pass filter, and a digital-to-analog converter (DAC) 464N. The one or more Tx RF sections 454 can be configured to ready the time delay and phase encoded digital signals for transmission. In some examples, the one or more Tx RF sections 454 can include a Tx RF section for each BF RFIO 466, 468 to each serially fed FE network 432, 434. Although the Tx RF section 454 is illustrated in a DBF configuration (e.g., including DACs 462N), an analog BF can be used without departing from the scope of the present disclosure.

The receive section 452 can include a receive beamformer (Rx BF) 460 and one or more Rx RF sections 458. The Rx BF 460 can include a number of components such as, for example and without limitation, a VGA, a time delay filter, a filter, an adder, one or more phase shifters, one or more down samplers, one or more filters, one or more IQ compensators, one or more direct current offset compensators (DCOCs), and the like. Each Rx RF section 458 can also include a number of components. In the example of FIG. 4C, each Rx RF section 458 includes a low noise amplifier (LNA) 464A, a mixer 464B, a filter 464C such as a low pass filter, and an analog-to-digital converter (ADC) 464N. In some examples, the one or more Rx RF sections 458 can include an Rx RF section for each BF RFIO 466, 468 to each serially fed FE network 432, 434, respectively. Although the receive section 452 is illustrated as BF ADCs 464N, an analog RX BF can be used without departing from the scope of the present disclosure.

The serially fed FE networks 432, 434 can include one or more Rx components (see LNAs 882, phase shifters 883 of FIG. 8A) for processing Rx signals from the antenna elements 412, 414 and one or more Tx components (see phase shifters 883, PAs 884 of FIG. 8A) for processing Tx signals for each of the antenna elements 412, 414. As an illustrative and non-limiting example, one or more Rx components for processing Rx signals can include LNAs to amplify respective signals from the antenna elements 412, 414 without significantly degrading the signal-to-noise ratio of the signals, and one or more Tx components for processing Tx signals can include PAs to amplify signals from the transmit section 450 to the antenna elements 412, 414. The phase shifters 483 (e.g., for Rx and/or Tx) can apply a phase shift, a time delay, or the link to Tx and/or Rx signals to provide beamforming and beam steering for a phased array antenna. In some examples, the serially fed FE networks 432, 434 can include other components such as, for example, VGAs. In some cases, VGAs, LNAs 482, PAs 484 and/or phase shifters 483 can be included in separate FE components (not shown) coupled to the serially fed FE networks 432, 434. Individual FEs of the serially fed FE networks 432, 434 can also include one or more ports (not shown) for coupling to power and/or digital control signals.

In some cases, the serially fed FE networks 432, 434, can be communicatively coupled to one or more 90-degree hybrid couplers (not shown), which can be communicatively coupled to the antenna elements 412, 414. In some examples, a 90-degree hybrid coupler can be used for power splitting in the Rx direction and power combining in the Tx direction and/or to interface the serially fed FE networks 432, 434 with a circularly polarized antenna element. For example, an antenna Rx port 474 and an antenna Tx port 476 associated with each antenna element 412, 414 can be coupled to first and second isolated ports of a 90-degree hybrid coupler and third and fourth isolated ports of the 90-degree hybrid coupler can be coupled to first and second ports of a corresponding antenna elements 412, 414. While a 90-degree hybrid coupler is provided as an illustrative example, other directional coupler mechanisms are within the scope of the present disclosure.

The BF chip 424 and serially fed FE networks 432, 434 can process data signals, streams, or beams for transmission by the antenna elements 412, 414, and receive data signals, streams, or beams from antenna elements 412, 414. The BF chip 424 can also recover/reconstitute the original data signal in a signal received from antenna elements 412, 414 and serially fed FE networks 432, 434. For example, for a received (Rx) signal, the BF chip 424 can coherently combine a beamformed signal from each connected serially fed FE network 432, 434. Moreover, the BF chip 424 can strengthen signals in desired directions and suppress signals and noise in undesired directions.

For example, in transmit mode (e.g., the transmit direction), the one or more Tx RF sections 454 of the transmit section 450 can process signals from the Tx BF 456 and output corresponding signals amplified by the PA 462A. For example, signals to the antenna elements 412 can be routed from BF RFIO 466 to RF serial input 437A of the initial FE 432A, and signals to the antenna elements 414 can be routed from BF RFIO 468 to RF serial input 437A of the initial FE 434A. The initial FE 432A of serially fed FE network 432 can receive the amplified RF signal at RF serial input 437 and distribute the RF signal to antenna elements 412A. For example, the amplified RF signal can be split equally among each of the antenna elements (e.g., from the distribution/combination ports 459) and the RF serial output 439A of the initial FE 434A. In some cases, phase shifters (e.g., phase shifters 883 of FIG. 8A) can apply a phase shift to the corresponding split signals to generate a coherently combining transmitted signal in a desired direction (e.g., the beam direction). In turn antenna elements 412A can radiate the amplified and phase adjusted RF signal.

In some embodiments, each individual FE of the serially fed FE networks 432, 434 can include signal conditioning components (see signal conditioning components 847, 849 of FIG. 8A) for amplitude and/or phase adjusting the RF signal in the transmit direction before outputting the RF signal to the next individual FE of the serially fed FE network 432, 434.

In the illustrated embodiment, initial FE 432A of serially fed FE network 432 distributes the RF signal from RF serial output 439A to the RF serial input 437B of the next individual FE 432B. In turn, the individual FE 432B can distribute the RF signal received from initial FE 432A to antenna elements 412B and the RF output 439B of individual FE 432B. The RF signal can be serially passed to each successive individual FE 432C through 432P and corresponding antenna elements 412C through 412P in a similar fashion. Similarly, the initial FE 434A of the serially fed FE network 434 can process an RF signal received from BF RFIO 468 and distribute the RF signal to antenna elements 414A.

In some cases, the signal conditioning components (e.g., signal conditioning components 847, 849 of FIG. 8A) and/or PAs (e.g., PAs 884 of FIG. 8A) can be configured to provide a common gain between a BF RFIO (e.g., BF RFIO 466, 468 of FIG. 4C) and each of the antenna elements 414R. In some implementations, the signal conditioning components and/or the PAs can be configured to provide a common gain between a BF RFIO 466, 468 and each of the RF serial inputs 437 (see FIG. 4B) of the individual FEs. For example, the signal conditioning components of the initial FE 432A can be configured to make a first gain between a BF RFIO 466, 468 and RF serial input 437A and a second gain between the BF RFIO 433 and the RF serial input 437B equal to the common gain. In some cases, each individual FE can be configured such that the RF serial inputs 437 of each individual FE of the serially fed FE network 432 receives a signal with a matched gain relative to the BF RFIO. In one illustrative example, a gain of one (e.g., unity gain) can be set between each RF serial input 437A through 437P-1 and each subsequent corresponding RF serial input 437B through 437P. In some cases, providing a unity gain can result in each individual FE of the serially fed FE networks 432 receiving a signal having the same amplitude at each RF input 437A-437P of the individual FEs 432A-432P.

In some examples, the signal conditioning components 447, 449, and/or the PAs 484 of individual FEs included in a phased array antenna can be configured to provide different gains to different antenna elements 414R. In one illustrative example, the gain of different PAs 484 in different individual FEs 492R can be varied to provide an excitation taper (e.g., and amplitude taper) to signals transmitted from the antenna elements 414R of the phased array antenna.

In receive mode (e.g., the receive direction), serially fed FE networks 432, 434 can receive RF signals from antenna elements 412, 414 and process the RF signals. For example, the initial FE 432A of the serially fed FE network 432 can receive RF signals from antenna elements 412A via respective antenna Rx ports 474. The one or more RX components (see components 882, 883 of FIG. 8A) of the last individual FE 432P of the serially fed FE network 432 can, for example, amplify respective RF signals received from the antenna elements 412P without significantly degrading the signal-to-noise ratio of the RF signals (e.g., with one or more LNAs). The one or more Rx components (see components 882, 883 of FIG. 8A) of the last individual FE 432P can also combine the signals from each of the antenna elements 412P. In one illustrative and non-limiting example, a distribution/combination network can combine the signals from each of the antenna elements 412P The last individual FE 432P can output the received RF signal (e.g., the combined signal from antenna elements 412P) to RF serial input 437P of the individual FE 432P, which can serve as an RF output port in the receive mode as mentioned above.

The one or more Rx components (see components 882, 883 of FIG. 8A) of the next to last individual FE 432P-1 can, for example, amplify respective RF signals from the antenna elements 412P-1 without significantly degrading the signal-to-noise ratio of the RF signals. The RF serial output 439P-1 (which can act as an RF input port in the receive mode) of next to last individual FE 432P-1 can also receive the RF signal output (e.g., the combined signal from antenna elements 412P) from RF serial input 437P of last individual FE 432P. The one or more Rx components (see components 882, 883 of FIG. 8A) of individual FE 432P-1 can also combine the RF signals from each of the antenna elements 412P-1 with the RF signal received from last individual FE 432P. The RF signals received from each of the antenna elements 412P-1 can be phased shifted (e.g., by phase shifters 483) so that the received signals originating from a desired direction (e.g., a beam direction) can be combined coherently. In some embodiments, each individual FE of the serially fed FE network can include signal conditioning components for amplitude adjusting (e.g., an amplifier) and/or phase adjusting (e.g., phase shifters 483) the RF signal in the receive direction before outputting the RF signal to the next individual FE of the serially fed FE networks 432.

The next to last individual FE 432P-1 can output the combined RF signal to RF input port 437P-1, which can then be input by the RF output port 439P-2 of the next individual FE 432P-2 of the serially fed FE network 432 and combined with RF signals received from the antenna elements 412P-2 coupled to the next individual FE 432P-2 and so on until a combined RF signal that includes the RF signals received from each of the antenna elements 412A through 412P is output from the RF serial input 437A of the initial FE 432A. The combined RF signal can be routed from the RF serial input 437A of the initial FE 432A through the BF RFIO 466 to the receive section 452 of the BF chip 424. Similarly, the serially fed FE network 434 can output a combined RF signal from RF serial input 437A of the initial FE 434A that includes the RF signals received from each of the antenna elements 414A through 414Q to the BF RFIO 468 which can be connected to the receive section 452 of the BF chip 424.

In some cases, the signal conditioning components (e.g., signal conditioning components 847, 849 of FIG. 8A) and/or the LNAs (e.g., LNAs 882 of FIG. 8A) can be configured to provide an equal gain between each of the antenna elements 414R and a BF RFIO (e.g., BF RFIO 466, 468 of FIG. 4C). In some implementations, the signal conditioning components (e.g., signal conditioning components 847, 849 of FIG. 8A) and/or the LNAs (e.g., 882 of FIG. 8A) can be configured to provide a common gain between each of the RF serial output 439R of the individual FEs and a BF RFIO 466, 468. For example, the signal conditioning components (e.g., signal conditioning components 847, 849 of FIG. 8A) and/or the LNAs (e.g., LNAs 882 of FIG. 8A) of the initial FE 492A can be configured to make a first gain between RF serial output 439A and a BF RFIO 466, 468 and a second gain between the RF serial out 439B and the BF RFIO 466, 468 equal to the common gain. In some cases, each individual can be configured such that the RF serial outputs 439 of each individual FE of the serially fed FE network 432 receives a signal with a matched gain relative to the BF RFIO 466, 468. For example, the gain between RF serial output 439A and RF serial out B can be made equal to one (1). In some embodiments, a gain of one (e.g., unity gain) can be set between each RF serial output 439P-439B and each adjacent corresponding RF serial output 439P-1-439A.

The one or more Rx RF sections 458 of the receive section 452 of the BF chip 424 can process the received RF signals and output the processed signal to the Rx BF 460. In some examples, the processed signal can include a signal amplified by an LNA 464A of Rx RF section 458. The Rx BF 460 can receive the signal and output a beamformed signal to a modem (e.g., modem 428 of FIG. 4B).

In some examples, the transmit section 450 and the receive section 452 can support a same number and/or set of antenna elements and/or serially fed FE networks. In other examples, the transmit section 450 and the receive section 452 can support different numbers and/or sets of antenna elements and/or serially fed FE networks. Moreover, while FIG. 4C illustrates two serially fed FE networks 432, 434 interfacing with two separate BF RFIOs 466, 468 of the BF chip 424, it should be noted that a BF chip can interface with a single serially fed FE network or more than two serially fed FE networks. The configuration of each BF RFIO 466, 468 of the BF chip interfacing with a single serially fed FE network in FIG. 4C is merely an illustrative example provided for explanation purposes. For example, a combiner/distributer (or a network of combiner/distributors) can allow a single BF RFIO 466, 468 of the BF chip 424 to interface with multiple serially fed FE networks. Also, while the serially fed FE networks 432, 434 are shown in FIG. 4C with one RF serial input, one RF serial output, four antenna Rx ports 474 and four antenna Tx ports 476 supporting four (e.g., M=4) antenna elements, it should be noted that, in other examples, the serially fed FE networks 432 can include more or fewer RF inputs/outputs and can support more or fewer antenna elements than shown in FIG. 4C. For example, in some cases, the serially fed FE networks 432, 434 can include two RF inputs and two RF outputs (e.g., for two separate data beams as shown in FIG. 7). In some cases, the serially fed FE networks 432, 434 can support two, three, five, or more antenna elements with an antenna Rx port 474 and an antenna Tx port 476 provided for each supported antenna element.

In the illustrative example of FIG. 4C, a TX/RX BF chip 424 is shown and the serially fed FE networks 432, 434 are also illustrated as bidirectional serially fed FE networks. In some implementations, serially fed FE networks can be configured for transmit (Tx) only operation or receive (Rx) only operation. In some implementations, serially fed FE networks configured for Tx only operation can be used with Tx BFs in a transmitting (Tx) phased array antenna. In some implementations serially fed FE networks configured for Rx only operation can be used with Rx only BFs in a receiving (Rx) phased array antenna. In some implementations, TX only BFs, RX only BFs, and/or TX/RX BFs (e.g., TX/RX BF chip 424) can be used with TX only serially fed FE networks, Rx only serially fed FE networks, Tx/Rx serially fed FE networks, and/or any combination thereof without departing from the scope of the present disclosure.

Referring to FIG. 4C, while the BF chip 424 is shown to include certain elements and components, one of ordinary skill will appreciate that the BF chip 424 can include more or fewer elements and components than those shown in FIG. 4C. Similarly, while the serially fed FE networks 432, 434 are shown to include certain elements and components, the serially fed FE networks 432, 434 shown in FIG. 4C and the example individual FE 892R shown in FIG. 8A can include more or fewer elements and components than those shown in FIG. 4C. For example, in some cases, the BF chip 424 and/or serially fed FE networks 432, 434 can be coupled to, reside on, and/or implemented by, a printed circuit board (PCB) of the phased array antenna system and/or any number of discrete parts on a PCB. The elements and components of the BF chip 424 and serially fed FE networks 432, 434 shown in FIG. 4C are merely illustrative examples provided for explanation purposes. Moreover, the example phased array antenna system 420 in FIG. 4B is merely an example implementation provided for explanation purposes. One of skill in the art will recognize that, in other implementations, the phased array antenna system 420 can include more or less of the same and/or different components than those shown in FIG. 4B. For example, in other implementations, the phased array antenna system 420 can implement other beamformers (e.g., analog, digital, hybrid), a different number and/or arrangement of beamformers and/or FEs, and/or any other type and/or configuration of beamformers and/or FEs.

Phased Array Antenna with Individual Beamformer Chips

FIG. 5A is a diagram illustrating an example phased array antenna system 520, in accordance with some examples. The phased array antenna system 520 can include an antenna lattice 506 including antenna elements 512, 514, and a beamformer lattice 522, which in this example includes beamformer (BF) chips 524, 526, for receiving signals from a modem 528 in the transmit (Tx) direction and sending signals to the modem 528 in the receive (Rx) direction. The antenna lattice 506 can be configured to transmit or receive a beam of radio frequency signals having a radiation pattern from or to the antenna aperture 502.

The BF chips 524, 526 in the beamformer lattice 522 can include an L number of BF chips. For example, BF chip 524 can include a BF chip i (i=1, where i=1 to L), and so forth, and BF chip 526 can include the Lth BF chip (i=L) of the BF chips in the beamformer lattice 522. Each BF chip of the beamformer lattice 522 electrically couples with a group of respective M number of antenna elements. In the illustrated example, BF chip 524 electrically couples with M antenna elements 512 (e.g., antenna elements 512A through 512M) and BF chip 526 electrically couples with M antenna elements 514 (e.g., antenna elements 514A through 514M). In the illustrated example, the BF chips in the beamformer lattice 522 are electrically coupled to each other in a daisy chain arrangement. However, other types of beamformers (e.g., analog, hybrid, etc.), beamforming techniques, configurations, coupling arrangements, etc., are within the scope of the present disclosure. For example, in other implementations, aspects of the disclosure can be implemented using analog beamforming or hybrid beamforming (e.g., implementing combined aspects of analog and digital beamforming). As another example, in other implementations, aspects of the disclosure can be implemented using beamformers having a different arrangement(s) and/or electrical coupling structure(s) such as, for example and without limitation, a multiplex feed network or a hierarchical network or H-network.

Each BF chip of the beamformer lattice 522 can include an integrated circuit (IC) chip or an IC chip package including a plurality of pins. In some cases, a first subset of the plurality of pins can be configured to communicate signals with a respective, electrically coupled BF chip(s) (e.g., if the BF chips are DBFs in a daisy chain configuration), and/or modem 528 in the case of BF chip 524. Moreover, a second subset of the plurality of pins can be configured to transmit/receive signals with M antenna elements, and a third subset of the plurality of pins can be configured to receive a signal from a reference clock 530. The BF chips in the beamformer lattice 522 may also be referred to as transmit/receive (Tx/Rx) BF chips, Tx/Rx chips, transceivers, BF transceivers, and/or the like. As described above, the BF chips may be configured for Rx communication, Tx communication, or both. Although the illustrated example of FIG. 5B shows components such as an ADC normally associated with DBFs, the BF chips 524 can be analog beamformers, DBFs, and in some cases simple transceivers without departing from the scope of the present disclosure.

In some cases, the BF chips 524, 426 in the beamformer lattice 522 can include amplifiers, phase shifters, mixers, filters, up samplers, down samplers, and/or other electrical components. In the receiving direction (Rx), a beamformer function can include delaying signals arriving from each antenna element so the signals arrive to a combining network at the same time. In the transmitting direction (Tx), the beamformer function can include delaying the signal sent to each antenna element such that the signals arrive at the target location at the same time (or substantially the same time). This delay can be accomplished by using “true time delay” or a phase shift at a specific frequency. In some examples, each of the BF chips 524, 426 can be configured to operate in half duplex mode, where the BF chips 524, 426 switch between receive and transmit modes as opposed to full duplex mode where RF signals/waveforms can be received and transmitted simultaneously.

The phased array antenna system 520 can also include frontends (FEs) 532, 534 that interface with the BF chips 524, 526 and the antenna elements 512, 514. For example, the FE 532 can communicatively couple the BF chip 524 with M antenna elements 512, and the FE 534 can communicatively couple the BF chip 526 with M antenna elements 514. The FEs 532, 534 can include RF or millimeter wave (mmWave) frontend integrated circuits, modules, devices, and/or any other type of frontend package and/or component(s). In some cases, the FEs 532, 534 can include multiple-input, multiple-output FEs interfacing with multiple antenna elements and one or more BF chips.

Moreover, the FEs 532, 534 can include various components, such as RF ports, BF ports, amplifiers (e.g., PAs, LNAs, etc.), and the like. In some examples, in Rx mode, the FEs 532, 534 can provide a gain to RF contents of each Rx input, and low noise power to suppress the signal-to-noise ratio impacts of noise contributors downstream in the Rx chain/path. Moreover, in Tx mode, the FEs 532, 534 can provide gain to each Tx path and drive RF power into a corresponding antenna element.

FIG. 5B is a diagram illustrating example components of a BF chip 524 and a FE 532 that interfaces the BF chip 524 with antenna elements 512A, 512B. In this example, the BF chip 524 can include a transmit section 550 and a receive section 552, and the FE 532 can include RF ports 570, 572 for RF inputs/outputs to and from the BF chip 524, Rx and Tx ports 574, 576 for transmit and receive signals to and from antenna element 512A, and Rx and Tx ports 578, 580 for transmit and receive signals to and from antenna element 512B.

The transmit section 550 can include a transmit digital beamformer (Tx BF) 556 and one or more RF sections 554. The Tx BF 556 can include a number of components (e.g., digital and/or analog) such as, for example and without limitation, a time delay filter, a filter, a gain control, one or more phase shifters, one or more up samplers, one or more IQ gain and phase compensators, and the like. Each RF section 554 can also include a number of components (e.g., digital and/or analog). In this example, each RF section 554 includes a power amplifier (PA) 562A, a mixer 562B, a filter 562C such as a low pass filter, and a digital-to-analog converter (DAC) 562N. The one or more RF sections 554 can be configured to ready the time delay and phase encoded digital signals for transmission. In some examples, the one or more RF sections 554 can include an RF section 554 for each RF path 566, 568 to each antenna element 512A, 512B.

The receive section 552 can include a receive digital beamformer (Rx BF) 560 and one or more RF sections 558. The Rx BF 560 can include a number of components such as, for example and without limitation, a time delay filter, a filter, an adder, one or more phase shifters, one or more down samplers, one or more filters, one or more IQ compensators, one or more direct current offset compensators (DCOCs), and the like. Each RF section 558 can also include a number of components. In this example, each RF section 558 includes a low noise amplifier (LNA) 564A, a mixer 564B, a filter 564C such as a low pass filter, and an analog-to-digital converter (ADC) 564N. In some examples, the one or more RF sections 558 can include an RF section 558 for each RF path 566, 568 to each antenna element 512A, 512B.

The FE 532 can include one or more components 582 for processing Rx signals from the antenna element 512A and one or more components 584 for processing Tx signals to the antenna element 512A. The FE 532 can also include one or more components 586 for processing Rx signals from the antenna element 512B and one or more components 588 for processing Tx signals to the antenna element 512B. In FIG. 4C, the components 582 and 586 include LNAs to amplify respective signals from the antenna elements 512A, 512B without significantly degrading the signal-to-noise ratio of the signals, and the components 584 and 588 include PAs to amplify signals from the transmit section 550 to the antenna elements 512A, 512B. In some examples, the FE 532 can include other components such as, for example, phase shifters (e.g., for Rx and/or Tx).

In some cases, the FE 532 can be communicatively coupled to one or more 90-degree hybrid couplers (not shown), which can be communicatively coupled to the antenna elements 512A, 512B. In some examples, a 90-degree hybrid coupler can be used for power splitting in the Rx direction and power combining in the Tx direction and/or to interface the FE 532 with a circularly polarized antenna element. However, other directional coupler mechanisms are within the scope of the present disclosure.

The BF chip 524 and FE 532 can process data signals, streams, or beams for transmission by the antenna elements 512A, 512B, and receive data signals, streams, or beams from antenna elements 512A, 512B. The BF chip 524 can also recover/reconstitute the original data signal in a signal received from antenna elements 512A, 512B and FE 532. Moreover, the BF chip 524 can strengthen signals in desired directions and suppress signals and noise in undesired directions.

For example, in transmit mode (e.g., the transmit direction), the one or more RF sections 554 of the transmit section 550 can process signals from the Tx BF 556 and output corresponding signals amplified by the PA 562A. Signals to the antenna element 512A can be routed through signal path 566 to RF port 570 of the FE 532, and signals to the antenna element 512B can be routed through signal path 568 to RF port 572 of the FE 532. The FE 532 can process an RF signal received from signal path 566 and output an amplified RF signal through Tx port 576. Antenna element 512A can receive the amplified RF signal and radiate the amplified RF signal. Similarly, the FE 532 can process an RF signal received from signal path 568 and output an amplified RF signal through Tx port 580. Antenna element 512B can receive the amplified RF signal and radiate the amplified RF signal.

In receive mode (e.g., the receive direction), FE 532 can receive RF signals from antenna elements 512A, 512B and process the RF signals using components 582 and 586. The FE 532 can receive RF signals from antenna element 512A via RF port 574, and RF signals from antenna element 512B through RF port 578. The components 582 and 586 can amplify respective RF signals from the antenna elements 512A, 512B without significantly degrading the signal-to-noise ratio of the RF signals. The components 582 can output RF signals from the antenna element 512A, which can be routed from RF port 570 of the FE 532 through the signal path 566 to the receive section 552 of the BF chip 524. Similarly, the components 586 can output RF signals from the antenna element 512B, which can be routed from RF port 572 of the FE 532 through the signal path 568 to the receive section 552 of the BF chip 524.

The one or more RF sections 558 of the receive section 552 of the BF chip 524 can process the received RF signals and output the processed signal to the Rx BF 560. In some example, the processed signal can include a signal amplified by an LNA 564A of RF section 558. The Rx BF 560 can receive the signal and output a beamformed signal to a modem (e.g., modem 528).

In some examples, the transmit section 550 and the receive section 552 can support a same number and/or set of antenna elements. In other examples, the transmit section 550 and the receive section 552 can support different numbers and/or sets of antenna elements. Moreover, while FIG. 5B illustrates a single FE interfacing with the BF chip 524, it should be noted that a BF chip can interface with multiple FEs. The configuration of a single FE interfacing with a BF chip in FIG. 5B is merely an illustrative example provided for explanation purposes. Also, while the FE 532 is shown in FIG. 5B with 2 RF inputs (e.g., RF ports 574 and 578) and 2 RF outputs (e.g., RF ports 576 and 580) supporting 2 antenna elements (e.g., antenna elements 512A and 512B), it should be noted that, in other examples, the FE 532 can include more or less RF inputs/outputs and can support more or less antenna elements than shown in FIG. 5B. For example, in some cases, the FE 532 can include 4 RF inputs and 4 RF outputs and can support more than 2 antenna elements.

While the BF chip 524 and the FE 532 are shown to include certain elements and components, one of ordinary skill will appreciate that the BF chip 524 and the FE 532 can include more or fewer elements and components than those shown in FIG. 5B. For example, in some cases, the BF chip 524 and/or the FE 532 can be coupled to, reside on, and/or implemented by, a printed circuit board (PCB) of the phased array antenna system and/or any number of discrete parts on a PCB. The elements and components of the BF chip 524 and the FE 532 shown in FIG. 5B are merely illustrative examples provided for explanation purposes. Moreover, the example phased array antenna system 520 in FIG. 5A is merely an example implementation provided for explanation purposes. One of skill in the art will recognize that, in other implementations, the phased array antenna system 520 can include more or less of the same and/or different components than those shown in FIG. 5A. For example, in other implementations, the phased array antenna system 520 can implement analog beamformers, hybrid beamformers, a different number and/or arrangement of beamformers and/or FEs, and/or any other type and/or configuration of beamformers and/or FEs.

In some cases, a crowded electromagnetic environment in a MIMO system (and/or other components associated with the MIMO system such as a PCB, among others) can cause unwanted cross-coupling within the MIMO system (and/or other components associated with the MIMO). For example, a crowded electromagnetic environment in the FE 532 can cause unwanted cross-coupling between the signal paths to and from the antenna elements 512A, 512B. The cross-coupling can negatively impact the performance of the phased array antenna system, distort radiation patterns, change and/or distort the properties of the signals to and from the antenna elements in undesired ways, and/or produce other undesired effects. For example, the electromagnetic interactions from cross-coupling can cause signal interference, phase shifts, harmonic distortion, integrity losses, grating lobes that dominate the peak sidelobe profile, among others.

### Single Beam Serially Fed Phased Array Antenna Configuration

FIG. 6 illustrates a schematic representation of a phased array antenna system including serially fed FE networks is shown. For the purposes of providing a simplified illustration, only two BF RFIOs 686, 696 and corresponding serially fed FE networks 632, 634 coupled to each respective BF RFIO 686, 696 are illustrated. It should be understood that more BF RFIOs and/or more serially fed FE networks can be used without departing from the scope of the present disclosure. As shown in FIG. 6, each BF RFIO 686, 696 can couple to an initial FE 632A, 634A of the serially fed FE networks 632, 634 by a corresponding routing trace 610, 620. Individual FEs 632A through 632D of the serially fed FE network 632 can couple to antenna elements 612A through 612D as illustrated in FIG. 6. Similarly, individual FEs 634A through 634D of the serially fed FE network 634 can couple to antenna elements 614A through 614D as illustrated in FIG. 6.

As shown in FIG. 6, two serially fed FE networks 632, 634 are coupled to BF 624 by separate BF RFIOs 686, 696. In some cases, multiple serially fed FE networks can be coupled to a single BF RFIO of the BF 624 (e.g., by a distribution/combination network). FIG. 6 illustrates a serially fed FE network block 685 including two serially fed FE networks 632, 634. In the example of FIG. 6, the serially fed FE network block 685 includes two serially fed FE networks. In some cases, a serially fed FE network block can include more or fewer serially fed FE networks that are similar to and perform similar functions to the serially fed FE networks 632, 634 of FIG. 6. Additionally or alternatively, in some embodiments, the serially fed FE network block 685 can include more or fewer components than shown in serially fed FE network block 685 of FIG. 6 without departing from the scope of the present disclosure. For example, individual FEs within a serially fed FE network 632, 634 may include additional ports for power and/or digital signals.

### Multiple Beam Serially Fed Phased Array Antenna Configuration

FIG. 7 illustrates a block diagram for a signal distribution configuration 700 for a multiple beam phased array antenna system. In the illustrated example, the BF 724 can simultaneously receive and/or transmit RF signals corresponding to two separate data beams BEAM1, BEAM2 of a phased array antenna.

In the signal distribution configuration 700 of FIG. 7, BF RFIOs 786, 796 are coupled to initial FEs (e.g., initial FEs 432A, 434A of FIGS. 4B and 4C) of serially fed FE networks 732, 734, 736. In the illustrated example, the serially fed FE networks 732, 734, 736 can be similar to and perform similar functions to the serially fed FE networks 432, 434 of FIGS. 4B, 4C. In the illustrated example, of FIG. 7, the serially fed FE networks 732, 734, 736 are arranged in pairs in FE network blocks 785A-785D (collectively referred to herein as FE network blocks 785). In the illustrated example of FIG. 7, antenna elements 712A and antenna elements 712B are coupled to two different individual FEs of the serially fed FE network 732, while antenna elements coupled to other individual FEs of the serially fed FE networks 734, 736 are not labeled. The labeled antenna elements 712A, 712B and unlabeled antenna elements coupled to individual FEs of the serially fed FE networks 732, 734, 736 are collectively referred to herein as antenna elements 712.

In the illustrated example of FIG. 7, each of the BF RFIOs 786A-786D (collectively referred to herein as BF RFIOs 786) and BF RFIOs 796A-796D (collectively referred to herein as BF RFIOs 796) of the BF 724 can electrically couple to the initial FEs of two different serially fed FE networks 732, 734, 736. For example, in the illustrated example of FIG. 7, each of the individual FEs of the serially fed FE networks 732, 734, 736 can include two RF serial inputs 737 and two RF serial outputs 739. Each individual RF serial input 737 can correspond to an RF serial input 437 of FIG. 4B for a respective data BEAM1, BEAM2. In some embodiments, the individual FEs (e.g., individual FE 892R of FIG. 8A) can include additional components, including but not limited to additional receive (Rx) components and/or additional transmit (Tx) components to process the two data beams BEAM1, BEAM2 to/from the antenna elements 712.

In the example of FIG. 7, each of the distribution/combination networks 705, 707 includes a routing structure similar to the routing connections between BF RFIO 786 and serially fed FE networks 432, 434 of FIG. 4C. In the illustrated example, each of the distribution/combination networks 705, 707 is from a corresponding BF RFIO 786, 796 to a midpoint between two serially fed FE networks of each of the serially fed FE network blocks 785A through 785D (collectively referred to herein as serially fed FE network blocks 785). As illustrated, each distribution/combination network 705, 707 includes a branching junction that connects the corresponding distribution/combination network 705, 707 to the initial FEs of two serially fed FE networks of each serially fed FE network block 785. As illustrated the distribution/combination networks 705, 707 can include combiner/dividers 715. In the illustrated example of FIG. 7, the distribution/combination networks 705, 707 are also routed from the BF RFIOs 786, 796 in routing channels that can run between the rows formed by the FE network blocks 785. It should be noted that the routing illustrated in FIG. 7 provides only an example and routing configurations on different numbers of layers and/or over different routing paths can be used without departing from the scope of the present disclosure. In some cases, the signals from BF RFIOs 786, 796 received at RF serial inputs 737 of the serially fed FE networks 732, 734, 736 can be routed to additional individual FEs of the serially fed FE networks by through paths 741, 743 for BEAM1 and BEAM2, respectively. The RF through paths 741, 743 can provide serial connections between individual FEs of the serially fed FE networks 732, 734, 736 as illustrated in FIG. 7. Accordingly, each BF RFIO 786, 796 can be communicatively coupled with thirty-two (32) antenna elements in the configuration shown in FIG. 7.

In one illustrative example, the distribution/combination networks 705, 707 can couple to initial FEs of the serially fed FE networks 732, 734, 736, and routing to the other individual FEs can occur through RF through paths 741 and RF through paths 743. In some cases, a BF RFIO associated with BEAM2 (e.g., BF RFIO 796A) can be electrically coupled to the RF through path 743 of a serially fed FE network. For example, as illustrated, BF RFIO 796A associated with BEAM2 is electrically coupled to the paths 743 (e.g., the upper paths) of the serially fed FE networks 732, 734. In contrast, BEAM2 is coupled to the paths 741 (e.g., the lower paths) of the serially fed FE networks 736 in the second block 785B. In some implementations, each of the RF through paths 741, 743 can be configured to selectively operate on any of two or more beams (e.g., BEAM1, BEAM2) to facilitate a non-overlapping layout. For example, the individual FEs of the serially fed FE networks 732, 734, 736 can be programmable to provide signal distribution and/or beamforming for either BEAM1 or BEAM2. As illustrated in FIG. 7, using the serially fed FE networks 732, 734, 736 in the signal distribution configuration 700, the distribution/combination networks 705, 707 do not cross. Because of the lack of crossing between the conductive traces of the distribution/combination networks 705, 707, in some cases, all of the routing between BF 724 and the serially fed FE networks 732, 734, 736 can be included in a single layer of a PCB.

The example of FIG. 7 illustrates only one example configuration for distribution of signals from a single BF RFIO (e.g., BF RFIO 796A to multiple serially fed FE networks (e.g., serially fed FE networks 732, 734). For example, although the serially fed FE network block 785A is shown with two serially fed FE networks 732, 734 arranged in a same “row” (e.g., along a straight line in the x-axis direction), other configurations can be used without departing from the scope of the present disclosure. For example, a serially fed FE network block can include serially fed FE networks in different “rows” of the phased array antenna. For example, a serially fed FE network block can include the serially fed FE network 734 and an adjacent serially fed FE network 736. In some examples, more than two (e.g., three or more) serially fed FE networks can share a single BF RFIO by including an additional combiner/divider layer to couple the BF RFIO to any number of serially fed FE networks. In one illustrative example, the serially fed FE networks included in serially fed FE network blocks 785A, 785B can be combined into a serially fed FE network block (not shown) including four serially fed FE networks. In such a configuration, a single BF RFIO (e.g., BF RFIO 796A) can be mapped to sixty-four (64) antenna elements for either BEAM1 or BEAM2.

In addition, although each of the serially fed FE networks 732, 734, 736 of FIG. 7 are shown including an equal number of individual FEs (e.g., four), serially fed FE networks of a phased array antenna can include a different number of individual FEs (e.g., two or more). In some cases, serially fed FE network blocks can include serially fed FE networks with differing numbers of individual FEs. For example, in an alternative configuration, serially fed FE network 732 can include four individual FEs and serially fed FE network 734 can include three (or two, five, or more) individual FEs instead of the four individual FEs shown in FIG. 7.

In some embodiments, the BF 724 and/or other components (e.g., portions of distribution/combination networks 705, 707) can be included in an auxiliary component (e.g., on a separate PCB from the antenna elements).

### Signal Coupling and Coupling Cancellation

FIG. 8A illustrates an example individual FE 892R, which can be included in a serially fed FE network 892 (not shown). For the purposes of the illustration of FIG. 8A, the value R can correspond to an index of the individual FE 892R within a serially fed FE network 892 (not shown). For example, an initial FE 892A of the serially fed FE network 892 has an index of R=A. The serially fed FE network 892 (not shown) that includes individual FE 892R can correspond to serially fed FE networks 432, 434 shown in FIGS. 4B and 4C and the individual FE 892R can correspond to any of the individual FEs included in serially fed FE networks 432, 434. As shown in FIG. 8A, individual FE 892R can include RF serial ports 837A, 837B, an RF serial ports 839A, 839B, four antenna Rx ports 874 and four antenna Tx ports 876. As illustrated, four two-port antenna elements 814R can be communicatively coupled to a respective antenna Rx port 874 and respective antenna Tx port 876.

The individual FE 892R can include a distribution/combination network 845. The distribution/combination network 845 can combine signals in a receive (Rx) mode and distribute signals in a transmit (Tx) mode. In a transmit (Tx) mode, the distribution/combination network 845 can distribute a signal received at RF serial port 837A of individual FE 892R and conditioned by the signal conditioning components 849 to distribution/combination ports 859 and the RF serial port 839A of individual FE 892R. Similarly, the distribution/combination network 845 can distribute a signal received at RF serial port 837B of individual FE 892R and conditioned by the signal conditioning components 849 to distribution/combination ports 859 and the RF serial port 839B of individual FE 892R. The distributed signals can be amplified by PAs 884 and/or phase shifted by phase shifters 883 prior to being received by the antenna elements 814R.

In a receive (Rx) mode, the distribution/combination network 845 can combine a signal received at the RF serial port 839A and conditioned by the signal conditioning components 847 with signals from each antenna element 814R received at distribution/combination ports 859. Similarly, the distribution/combination network 845 can combine a signal received at the RF serial port 839B and conditioned by the signal conditioning components 847 with signals from each antenna element 814R received at distribution/combination ports 859. The signal from each antenna element 814R can be amplified by LNAs 882 and/or phase shifted by phase shifters 883. In the illustrated example of FIG. 8A, the Tx and Rx signal paths share a common distribution/combination port 859 and the paths are joined at a junction 875. In the example of FIG. 8A with four antenna elements 814R coupled to the individual FE 892R (e.g., M=4), the distribution/combination network 845 can act as a 5-way distributor/combiner. In some cases, for any value of M, the distribution/combination network 845 can include an M+1-way distributor/combiner. In one illustrative example, the distribution/combination network 845 can include an M+1-way Wilkinson distributor/combiner.

In some embodiments, the individual FE 892R can include one or more components 882, 883 for processing Rx signals from the antenna elements 814R and one or more components 883, 884 for processing Tx signals to the antenna elements 814R. In FIG. 8A, the components 882 include LNAs to amplify respective signals from the antenna elements 814R without significantly degrading the signal-to-noise ratio of the signals.

Although a single LNA 882 and phase shifter 883 is shown coupled to each antenna element, 814R, in some cases, a separate phase shifter 883 and/or LNA 882 can be coupled to each individual antenna element 814R for each data beam. For example, in the case of two beam (e.g., BEAM1, BEAM2) FE 892R of FIG. 8A, each antenna element 814R can be phase shifted by a separate phase shifter 883 (e.g., phase shifters 983 of FIG. 9C). In some cases, a single LNA 882 can be shared by two or more phase shifters 883 (see e.g., configuration 985 of FIG. 9C). In some cases, a separate LNA 882 (see e.g., configuration 986 of FIG. 9C) can be provided for each phase shifter 883.

Similarly, although a single phase shifter 883 and PA 884 is shown coupled to each antenna element 814R in FIG. 8A, in some cases, a separate phase shifter 883 and/or PA 884 can be coupled to each individual antenna element 814R for each data beam. For example, in the case of two beam (e.g., BEAM1, BEAM2) FE 892R of FIG. 8A, each antenna element 814R can be phase shifted by a separate phase shifter 883 (e.g., phase shifters 983 of FIG. 9C). In some cases, a single PA 884 (see e.g., configuration 985 of FIG. 9C) can be shared by two or more phase shifters 883. In some cases, a separate PAs 884 (see e.g., configuration 986 of FIG. 9C) can be provided for each phase shifter 883.

The individual FE 892R can include signal conditioning components 849 communicatively coupled to the RF serial ports 837A, 837B and the distribution/combination network 845. The individual FE 892R can also include signal conditioning components 847 communicatively coupled to the RF serial ports 839A, 839B and the distribution/combination network 845. In some examples, the one or more of the signal conditioning components 847, 849 can include components such as, for example, LNAs, PAs, VGAs, transformers, and/or phase shifters (e.g., for Rx and/or Tx).

As described above with respect to FIGS. 4B and 4C, in a receive (Rx) mode, the individual FEs 892R of the serially fed FE network 892 can be configured to provide an equal gain between each of the antenna elements 814R and a corresponding BF RFIO (e.g., BF RFIO 466, 468 of FIG. 4C). In some implementations, signal conditioning components 847, 849 can be configured to provide a common gain between RF serial ports 839A, 839B of each individual FE 892R and a corresponding BF RFIO (e.g., BF RFIO 466, 468 of FIG. 4C). In one illustrative example, the signal conditioning components 847, 849 of the individual FE 892A can be configured to make a first gain between RF serial port 839A of individual FE 892A and a first BF RFIO (e.g., BF RFIO 466, 468 of FIG. 4C) and the signal conditioning components 847, 849 of FE 892B can be configured to make a second gain between RF serial port 839A of individual FE 892B and the first BF RFIO (e.g., BF RFIO 466, 468 of FIG. 4C) equal to the common gain. In another illustrative example, the signal conditioning components 847, 849 of the individual FE 892A can be configured to make a third gain between RF serial port 839B of individual FE 892A and a second BF RFIO (e.g., BF RFIO 466, 468 of FIG. 4C) equal to a common gain and the signal conditioning components 847,849 of FE 892B can be configured to make a fourth gain between RF serial port 839B of individual FE 892B and the second BF RFIO (e.g., BF RFIO 466, 468 of FIG. 4C) equal to the common gain. In some implementations, the signal conditioning components 847, 849 can be configured to provide a unity gain between successive RF serial ports 839A, 839B of each individual FE 892R in the serially fed FE network 892. In some cases, providing a unity gain in the receive mode can result in each individual FE 892R of the serially fed FE network 892 receiving a signal having the same gain at each RF serial port 839A, 839B of the individual FEs 892R.

Moreover, in transmit (Tx) mode, each individual FE 892R of the serially fed FE network 892 can be configured to provide an equal gain between each of the BF RFIOs (e.g., BF RFIO 466, 468 of FIG. 4C) and each of the antenna elements 814R. In some implementations, signal conditioning components 847, 849 can be configured to provide a common gain between each BF RFIO (e.g., BF RFIO 466, 468 of FIG. 4C) and a corresponding RF serial port 837A. In one illustrative example, the signal conditioning components 847, 849 of the individual FE 892A and/or the individual FE 892B can be configured to make a first gain between a first BF RFIO (e.g., BF RFIO 466, 468 of FIG. 4C) and the RF port 812 of a first individual FE 892A and a second gain between the BF RFIO (e.g., BF RFIO 466, 468 of FIG. 4C) and the RF port 813 of individual FE 892B equal to the common gain. In some cases, applying a unity gain in the Tx mode can result in each individual FE 892R of the serially fed FE network 892 receiving a signal having the same gain at each RF serial port 837A of the individual FEs 892R for a first data beam. In some examples, applying a unity gain in the Tx mode can result in each individual FE 892R of the serially fed FE network 892 receiving a signal having the same gain at each RF serial port 837B of the individual FEs 892R for a second data beam

In some cases, the individual FE 892R can be an initial FE 892A (e.g., R=A) of the serially fed FE network 892 (not shown). The initial FE 892A can correspond to initial FE 432A, 434A of FIGS. 4B, 4C. As described above with respect to FIGS. 4B and 4C, the RF serial port 837A of an initial FE 892A can be coupled to a BF RFIO (e.g., BF RFIOs 433, 435 of FIGS. 4B, 4C) of a BF (e.g., BF chips 424, 426 shown in FIGS. 4B, 4C). The RF serial port 839A of an initial FE 892A can be coupled to an RF port 812 of an individual FE 892B that is serially connected to the initial FE 892A. Similarly, the RF serial port 839B of an initial FE 892A can be coupled to the RF port 813 of an individual FE 892B.

In some cases, the individual FE 892R can be a last individual FE 892P (e.g., last individual FEs 432P, 434Q of FIGS. 4B and 4C, R=P). In some embodiments, the RF serial ports 839A, 839B of the last individual FE 892P can each be coupled to a matched termination. In some embodiments, the RF serial ports 839A, 839B of the last individual FE 892P can be disabled (e.g., by disabling one or more of the signal conditioning components 847).

FIG. 8A illustrates example cross-coupling signals for an individual FE 892R. As illustrated, the RF port 812 can correspond to a first data beam BEAM1 and the RF port 813 can correspond to a second data beam BEAM2. For example, in a receiving (Rx) configuration, signals received at the antenna elements 814R can be amplified by LNAs 882, phase shifted by phase shifters 883, and routed to the RF ports 812, 813 by the distribution/combination network 845. In some cases, a portion of the RF signals output from the RF ports 812, 813 can radiate (e.g., leak) and couple to the antenna elements 814R (as indicated by coupling signals 830) and/or to the antenna Rx ports 874 (as indicated by coupling signals 831). Although not illustrated, similar coupling can occur between the four antenna Rx ports 874 and the RF serial ports 839A, 839B and/or between the antenna elements 814R and the RF serial ports 839A, 839B.

In transmit (Tx) mode, signals received at the RF ports 812, 813 can be routed by the the distribution/combination network 845 phase shifted by phase shifters 883, and amplified by the PAs 884. In some cases, the amplified signals output to the four antenna Tx ports 876 can couple (as indicated by coupling signals 831) to the RF ports 812, 813. In some cases, the antenna elements 814R can be stimulated to transmit an RF signal over the air, which can couple (as indicated by coupling signals 830) to the RF ports 812, 813. Although not illustrated, similar coupling can occur between the four antenna Tx ports 876 and the RF serial ports 839A, 839B and/or between the antenna element 814R and the RF serial ports 839A, 839B.

FIG. 8B is a simplified block diagram illustrating an example of coupling between an antenna element 814R and circuitry 880 for a phased array antenna operating in a transmitting (Tx) configuration. As illustrated, an RF signal 815 may be provided to circuitry 880 from a BF, transmitter, transceiver, or the like. The circuitry 880 can include, without limitation, one or more amplifiers (e.g., PAs 884 of FIG. 8A, variable gain amplifiers), phase shifters (e.g., phase shifters 883 of FIG. 8A), filters, conductive traces, solder balls, bond pads, or the like. In some cases, an amplifier included in the circuitry 880 can provide gain to the RF signal 815, which can output a signal that stimulates the antenna element 814R to radiate a beamformed (e.g., amplified and/or phase shifted) RF signal as electromagnetic radiation 810. In some examples, the RF signal can radiate from conductive traces, solder balls, bond pads, or the like in the transmit signal path as electromagnetic radiation 810. In some cases, a portion of the electromagnetic radiation from the antenna element 814R and/or any other source of electromagnetic radiation 810 can couple to the circuitry 880 with a phase shift relative to the RF signal 815. In some cases, the coupling signals 840 (e.g., coupling signals 830, 831 of FIG. 8A) can be amplified by circuitry 880 and stimulate the antenna element 814R with a coupling signal that can interfere with the RF signal 815.

FIG. 8C is a simplified block diagram illustrating an example of coupling between an antenna element 814R and circuitry 881 for a phased array antenna operating in a receiving (Rx) mode. In the Rx mode, the antenna element 814R can receive incident electromagnetic radiation 811 (e.g., an incoming signal from SATs 102, SAGs 104, and/or UTs 112 of FIG. 1A) to generate a received RF signal. The circuitry 881 can include, without limitation, one or more amplifiers (e.g., LNAs 882 of FIG. 8A, variable gain amplifiers), phase shifters (e.g., phase shifters 883 of FIG. 8A), filters, conductive traces, solder balls, bond pads, or the like. In some cases, an amplifier included in the circuitry 881 can provide gain to the received RF signal, which can in turn radiate and feed back to the antenna element 814R, conductive traces, solder balls, bond pads, or the like. As a result, the coupling signals 841 (e.g., coupling signals 830, 831 of FIG. 8A) can interfere with the incident electromagnetic radiation 811, which can in turn affect the RF signal 816 output by the circuitry 881.

FIG. 8D is a diagram illustrating an example vector summation model defining a voltage magnitude and phase of a coupling product for a coupling victim 801 and aggressor 805A. Referring to FIG. 8B, the coupling victim 801 can correspond to the RF signal 815 and the aggressor 805A can correspond to the coupling signals 840. As illustrated in FIG. 8B, the coupling signals 840 can be signals that are phase shifted and/or amplified by the circuitry 880. Referring to FIG. 8C, the coupling victim 801 can correspond to incident electromagnetic radiation 811 and the aggressor 805A can correspond to coupling signals 841. As illustrated in FIG. 8C, the coupling signals 841 can be phase shifted and/or amplified by the circuitry 881. In the example of FIG. 8D, the coupling victim 801 and aggressor 805A are modeled as vectors with linear voltage magnitudes and phases. Victim phase Ov represents the phase of the vector of the coupling victim 801 and aggressor phase OA represents the phase of the aggressor 805A. In some cases, as a result of interference between the aggressor 805A, the radiation pattern from the antenna element can have a phase and magnitude represented by the sum vector 808. The vector summation is illustrated graphically by a shifted aggressor vector 805B having a tail originating at the tip of the victim 801. Sum phase θ_{S} represents the phase of the sum vector 808. In some implementations, the aggressor 805A can include a signal that represents a combination of multiple data beams that can be simultaneously transmitted and/or received by the antenna element 814R.

In some implementations, phase and/or magnitude adjustments can be applied to compensate for the effects of the aggressor 805A and produce a signal at or near the desired magnitude and phase. However, in some cases where circuitry 880/881 includes a gain, the effect of phase and/or magnitude adjustments can be based on closed loop transfer function. For example, in a receiving (Rx) mode, gain (e.g., gain of LNAs 882 of FIG. 8A) and/or phase shift (e.g., phase shift applied by phase shifters 883 of FIG. 8A) compensation for coupling signals 841 of FIG. 8C can be based on a closed loop transfer function as described with respect to FIG. 8E through FIG. 8G. In another example, in a transmitting (Tx) mode, gain (e.g., gain of PAs 884 of FIG. 8A), and/or phase shift (e.g., phase shift applied by phase shifters 883 of FIG. 8A) compensation for coupling signals 840 of FIG. 8B can be based on a closed loop transfer function as described with respect to FIG. 8E through FIG. 8G.

FIG. 8E is a diagram illustrating a model of a coupling signal feedback loop 850. As illustrated, the model includes an amplifier 851 that can provide an open loop complex gain AOL between input 852 and output 853. Coupling between the output 853 and input 852 (e.g., coupling signals 840 of FIG. 8B, coupling signals 841 of FIG. 8C) is represented by the feedback block 854. The coupling can have a complex coupling factor β that can represent phase shift and atennuation of the signal that is fed back to the input 852 from the output 853. Summing junction 857 combines an input signal received at the input 852 with the feedback signal from the feedback block 854 which is in turn amplified by the amplifier 851. An example closed loop transfer function H of the coupling signal feedback loop 850 is shown in Equation (1) below:

$$H = \frac{{A}_{OL}}{1 - β * {A}_{O L}} \qquad ( 1 )$$

FIG. 8F and FIG. 8G are diagrams illustrating relationships between the closed loop transfer function H of the coupling signal feedback loop 850 of FIG. 8E and open loop phase delay. In some cases, the open loop phase delay can correspond to beamforming weights applied to the input signal of the amplifier. Accordingly, as the beam pointing direction for a data beam changes, the open loop phase delay may also change. In the examples of FIG. 8F and FIG. 8G, the magnitude of the open loop complex gain A_{OL} is held constant while the phase of the open loop complex gain A_{OL} is swept over a 360 degree range as illustrated by the x-axis values of plot 860 of FIG. 8F and plot 865 of FIG. 8G. In the illustrated examples of FIG. 8F and FIG. 8G, four curves are plotted for different simulated reverse isolation values (e.g., different values of complex coupling factor B). As the reverse isolation value is increased, the feedback signal becomes attenuated and can have a reduced impact on the closed loop transfer function. As illustrated in the plots 860 and 865, the y-axis values of the plots do not represent specific numerical values of gain or phase error and instead illustrate relative changes in closed loop gain relative to open loop phase (e.g., in plot 860) or closed loop phase error relative to open loop phase (e.g., in plot 865). Similarly, the reverse isolation values for each of the curves 862, 863, 864 of FIG. 8F and each of the curves 866, 867, 868 of FIG. 8G do not represent specific reverse isolation values and are provided to illustrated relative effects of varying reverse isolation on the behavior of the closed loop transfer function H.

As illustrated in plot 860 of FIG. 8F, the closed loop gain (e.g., y-axis value) varies about a nominal closed loop gain 861, which can correspond to the desired magnitude of the beamformed signal at the output of the amplifier 851 of FIG. 8E. Curve 862 is a plot of the lowest simulated reverse isolation value and exhibits the greatest peak to peak swing in closed loop gain. Curve 863 is a plot of the highest simulated reverse isolation value, and the remaining two curves 864 represent simulated reverse isolation values between the lowest and highest values. In one illustrative example, the peak to peak gain of the curve 862 can be approximately equal to 4 dB and the peak to peak gain of the curve 863 can be approximately equal to 1 dB. In one illustrative example, curve 862 corresponds to a reverse isolation of 30 dB and the curve 863 corresponds to a reverse isolation of 50 dB.

As illustrated in plot 865 of FIG. 8G, the closed loop phase error (e.g., y-axis value) varies about zero, which can correspond to the actual phase of the beamformed signal at the output of the amplifier 851 of FIG. 8D being identical to the desired phase provided at the input of the amplifier 851. Curve 866 represents the lowest simulated reverse isolation value, curve 867 represents the highest simulated reverse isolation value, and the two curves 868 represent simulated reverse isolation values between the lowest and highest values. In one illustrative example, the peak to peak phase error of the curve 866 can be approximately 30 degrees and the peak to peak phase error of the curve 867 can be 10 degrees. In one illustrative example, curve 866 corresponds to a reverse isolation of 30 dB and the curve 867 corresponds to a reverse isolation of 50 dB.

As illustrated by FIG. 8F and FIG. 8G, increasing the reverse isolation in the coupling signal feedback loop 850 of FIG. 8E can reduce the impact of feedback coupling on the closed loop transfer function H. In some cases, differential signaling configurations can be used to increase reverse isolation for coupling signals. In some cases, a combination of compensation and reverse isolation can be used to achieve desired system performance.

In some cases, compensating for coupling in a phased array antenna system can be computationally intensive, can consume more power, can cause additional latency, can degrade signal quality, and/or can result in other degradations of antenna system performance.

FIG. 8H is a diagram illustrating a differential signaling configuration for providing coupling cancellation. A BF module 835 can be similar to and perform similar functions to the individual FE 892R of FIG. 8A. In the example of FIG. 8H, the single ended RF ports shown in FIG. 8A for each data beam are replaced with differential RF ports 822, 823. In the example of FIG. 8H, the differential signaling configuration can be utilized to cancel the effects of aggressor signals caused by coupling signals. For example, the coupling signals can include coupling signals between the antenna element 814R and the differential RF ports 822, 823 (as indicated by coupling signals 855). In some cases, the coupling signals can include coupling between the antenna Tx ports 876 and the differential RF ports 822, 823 (as indicated by coupling signals 856). The data beams BEAM1 and BEAM2 can be coupled to differential RFIOs of a BF (e.g., BFs of FIG. 4C). In some cases, each data beam can include a positive component and a negative component. For example, BEAM1 can include a positive component

$$\frac{B 1 +}{2}$$

and a negative component

$$\frac{B 1 -}{2} .$$

Similarly, BEAM2 can include a positive component

$$\frac{B 2 +}{2}$$

and a negative component

$$\frac{B 2 -}{2} .$$

The positive and negative components of the beams, BEAM1, and BEAM2 can represent differential current signals or a differential voltage signals. In the illustrated example of FIG. 8A, the signal conditioning components 849 can include one or more electrical components for converting between the differential signals and single ended signals within the BF module 835.

In the example of FIG. 8H, an example differential transmitting (Tx) configuration is illustrated. In some cases, a differential amplifier (e.g., differential amplifiers 820A, 820B) can convert signals between a differential signaling configuration and a single ended configuration. For example, amplifiers 820A, 820B each include a non-inverting (+) input and an inverting (−) input. In one illustrative example, amplifier 820A can receive a first differential input signal with an amplitude S/2 at the non-inverting input and a second differential input signal −S/2 at the inverting input. In one illustrative example, the first and second differential input signals can be provided by an RFIO of a BF (e.g., BF chip 424, BF chip 426 of FIG. 4B, or the like). In the example of FIG. 8H, the amplifier 820A can have a gain α. The resulting output signal from the amplifier 820A can have amplitude A_{S} as shown in Equation (2):

$${A}_{S} = α * ( \frac{s}{2} * {ω}_{1} - ( - \frac{s}{2} * {ω}_{2} ) ) = α * \frac{s}{2} ( {ω}_{1} + {ω}_{2} ) \qquad ( 2 )$$

Where ω₁, ω₂ are weighting coefficients. In some cases, the weighting coefficients can be used to adjust the relative contribution (e.g., gain and/or phase) of the two differential input signals to the output signal of the amplifier 820A. In some cases, one or more coupling signals (e.g., coupling signal 855, coupling signal 856) can be coupled to the non-inverting and inverting amplifier inputs of the amplifiers 820A, 820B by coupling to circuitry (e.g., circuitry 880 of FIG. 8B). For the common mode signal, the output signal can depend on the common mode gain (or common mode rejection ratio) of the amplifier, as well as relative phase and amplitude between the coupling signals coupled to each of the non-inverting (+) input and the inverting (−) input. For example, the spacing between the ports of the BF module 835 corresponding to the amplifier inputs can affect the relative phase and amplitude of the signals coupling to each of the ports. Other factors that can affect the relative phase and/or amplitude of the signals, the size, shape, and/or length of conductors (e.g., solder balls, bond pads, routing traces between the BF RFIOs and each of the amplifier inputs. In one illustrative example, the weighting coefficients ω₁, ω₂ can both be equal to 1, such that the output A_{S}=α*S.

In the example of FIG. 8H, the single ended outputs of the differential amplifiers 820A, 820B can couple to distribution network ports 818, 819 and can be distributed by the distribution/combination network 846, which can correspond to distribution/combination network 845 of FIG. 8A. In some cases, the differential signals can remain differential through the transmit (Tx) and/or receive (Rx) signal paths. For example, the distribution/combination network 846, LNAs 882, phase shifters 883, PAs 884, and antenna element 814R can be fully differential. In some implementations (not shown), differential to single-ended conversion and/or single-ended to differential conversion can occur at a different location within the transmit (Tx) and/or receive (Rx) signal paths without departing from the scope of the present disclosure.

Compared to the initial FE 892A of FIG. 8A, the BF module 835 of FIG. 8H includes two additional external connections. For example, the differential RF port 822 of FIG. 8H requires two external connections while the RF port 812 of FIG. 8A requires one external connection. Similarly, the differential RF port 823 of FIG. 8H requires two external connections while the RF port 813 of FIG. 8A requires one external connection. In one illustrative example, the BF module 835 can be included in an IC chip. In some cases, a larger IC chip package and/or increased silicon area may be required to accommodate the addition of two external connections to allow for fully differential RF IO ports in the BF module 835. In some cases, each additional external connection added to a BF module (e.g., BF module 835) can increase the area, cost, and/or weight of the BF module.

FIG. 8I illustrates a differential receiving (Rx) configuration. In the illustrated example of FIG. 8I, the BF module 836 can be similar to and perform similar functions to the individual FE 892R of FIG. 8A. In some cases, a single-ended to differential amplifier (e.g., single-ended to differential amplifiers 821A, 821B) can convert signals between a single ended signaling configuration and a differential configuration. For example, amplifiers 821A, 821B each include a non-inverting (+) output and an inverting (−) output. In some cases, weighting coefficients ω₃,ω₄ can be used to adjust a gain and/or phase applied to the single-ended input signal to generate the differential output signals of the amplifiers 821A, 821B. In one illustrative example, amplifier 820A can output a first differential signal with an amplitude S*ω₃ at the non-inverting output and a second differential output signal with an amplitude −S*ω₄ at the inverting output. In one illustrative example, the differential output signals of each amplifier 921A, 921B can be provided to a differential RFIO of a BF (e.g., BF chip 424, BF chip 426 of FIG. 4B, or the like).

In the example of FIG. 8I, the single ended input of the single-ended to differential amplifiers 821A, 821B can couple to distribution network ports 818, 819 and can receive a combined signal from the antenna elements 814R that can be combined by the distribution/combination network 846, which can correspond to distribution/combination network 845 of FIG. 8A. In some cases, the input signals to the single-ended to differential amplifiers 821A, 821B can remain differential through the transmit (Tx) and/or receive (Rx) signal paths. For example, the distribution/combination network 846, LNAs 882, phase shifters 883, PAs 884, and/or antenna element 814R can be fully differential. In some implementations (not shown), differential to single-ended conversion and/or single-ended to differential conversion can occur at a different location within the transmit (Tx) and/or receive (Rx) signal paths without departing from the scope of the present disclosure.

FIG. 8J illustrates example configurations for a BF module 838 that illustrate different configurations for transmit (Tx) signal paths and/or receive (Rx) signal paths. For example, FIG. 8J illustrates different configurations for phase shifters 883 and PAs 884 in transmit (Tx) signal paths. Similarly, FIG. 8J illustrates different configurations for phase shifters 883 and LNAs 882 in receive (Rx) signal paths. In some cases, differential signals for BEAM1 and BEAM2 can be coupled to the BF module 838. In the example of FIG. 8J, differential signals for BEAM1 can be coupled to differential port 832 of signal conditioning components 849. Similarly, differential signals for BEAM2 can be coupled to differential port 833 of signal conditioning components 849. As illustrated, the differential distribution/combination ports 828, 829 of the distribution/combination network 848 are coupled to differential ports of the signal conditioning components 849. In some cases, the signal conditioning components 849 of FIG. 8J can include fully differential amplifiers (not shown) for transmitting and/or receiving signal paths of the BF module 838. As illustrated, differential distribution/combination ports 869 can be provided for transmit and/or receive signal paths for each antenna element 814R.

As illustrated, a differential distribution/combination port 869 can be provided for each data beam (e.g., BEAM1, BEAM2). In a first example configuration 885, the data beams BEAM1, BEAM2 are combined between the antenna elements 814R and LNAs 882 in the receive (Rx) signal path of each antenna element 814R. Similarly, in the first example configuration 885, the data beams BEAM1, BEAM2 are combined between antenna elements 814R and PAs 884 in the transmit (Tx) signal path of each antenna element 814R. In a second example configuration 886, the data beams BEAM1, BEAM2 are combined between the LNAs 882 and phase shifters 883 in the receive (Rx) signal path of each antenna element 814R. Similarly, in the second example configuration 886, the data beams BEAM1, BEAM2 are combined between the PAs 884 and phase shifters 883 in the transmit (Tx) signal path of each antenna elements 814R.

FIG. 9A illustrates an example coupling cancellation configuration incorporating a coupling port 906. The BF module 933 can be coupled to a signal source such as BF RFIOs of the BF chip 524 of FIG. 5B, a transducer, and/or any other signal source. For example, the BF module 933 can correspond to FE 532 of FIG. 5B. As illustrated, the BF module 933 can include three RF ports 902, 904, and 906. As used herein, the third RF port 906 is also referred to as coupling port 906. As illustrated, the first RF port 902 can correspond to a positive signal component B1+ for a first data beam BEAM1. Similarly, the second RF port 904 can correspond to a positive signal component B2+ for BEAM2. As illustrated, the coupling port 906 can be used as a coupling cancellation port for both BEAM1 and BEAM2. The coupling port 906 can be configured as a shared differential port for both BEAM1 and BEAM2. For example, the coupling port 906 can be configured to simultaneously provide coupling cancellation for both the first data beam BEAM1 and the second data beam BEAM2 while only adding a single external connection relative to a single ended configuration (e.g., individual FE 892R of FIG. 8A). As discussed in more detail below, the coupling port 906 can be used for a BF module operating in a receiving (Rx) mode and/or a transmitting (Tx) mode.

The BF module 933 can include signal conditioning components 949 communicatively coupled to the RF ports 902, 904, 906 and the distribution/combination network 945. The BF module 933 can also include signal conditioning components 949 communicatively coupled to the RF ports 902, 904, coupling port 906, and distribution/combination network 945. As illustrated, the distribution/combination network 945 can include a first distribution/combination network port 908 corresponding to BEAM1, a second distribution/combination network port 910 corresponding to BEAM2. The distribution/combination network 945 can also include distribution/combination network ports 959 corresponding to each antenna element 914A. A combiner/divider 975 can be coupled to a transmitting (Tx) signal path (e.g., including a PA 984 and a phase shifter 983) and a receiving (Rx) signal path (e.g., including LNA 982 and phase shifter 983). Although a single distribution/combination network 945 is shown, it should be understood that separate distribution networks (not shown) can be provided for each data beam. In addition, separate signal paths corresponding with each antenna element can be provided for each data beam (see, e.g., FIG. 9C). In the illustrated example of FIG. 9A, the antenna elements 914A are shown as dual port antenna elements. The BF module 933 can include dual antenna ports 974, 976 corresponding to the dual antenna ports of the antenna elements 914A. In some cases, a phased array antenna system utilizing antenna elements with fewer or more antenna ports can be used without departing from the scope of the present disclosure.

FIG. 9B illustrates an example coupling cancellation configuration for a BF module operating in a transmitting (Tx) mode incorporating a coupling cancellation port. The BF module 934 of FIG. 9B can correspond to the BF module 933 of FIG. 9A. As illustrated, the signal conditioning components 949 include a pair of differential amplifiers 920A, 920B. In some cases, the RF ports 902, 904, and 906 can receive one or more coupling signals (e.g., coupling signals 840 of FIG. 8B). In some cases, the one or more coupling signals can include coupling signals 992 transmitted by the antenna elements 914A and can couple to the RF ports 902, 904, 906 (as indicated by coupling signals 992). In some cases, the one or more coupling signals can include signals transmitted by the Tx antenna ports 976 (as indicated by coupling signals 991). In some examples, the coupling signals 992 and/or coupling signals 991 can contain beam data from BEAM1 and BEAM2.

In the illustrated example, the non-inverting input of the differential amplifier 920A is electrically coupled to the first RF port 902 of the BF module 934 corresponding to BEAM1. The non-inverting input of differential amplifier 920B is electrically coupled to the second RF port 904 of the BF module 934 corresponding to BEAM2. As shown, the inverting inputs of both differential amplifiers 920A, 920B are coupled to the coupling port 906 of the BF module 934. In the illustrated example of FIG. 9B, a splitter 921 is provided to distribute the coupling signal received at the coupling port 906 (e.g., coupling signals 991, 992) between the inverting inputs of the differential amplifiers 920A, 920B. In one illustrative example, the splitter 921 can be implemented as a 2:1 Wilkinson divider. As illustrated, the differential inputs to differential amplifier 920A can be converted to a single ended signal and coupled to a distribution/combination network port 908 of the distribution/combination network 945 and distributed by the distribution/combination network 945 to distribution/combination network ports 959 and in turn to phase shifters 983, PAs 984, and antenna elements 914A of the BF module 934. Similarly, the differential inputs to differential amplifier 920B can be converted to a single ended signal and coupled to a distribution/combination network port 910 of the distribution/combination network 945 and distributed by the distribution/combination network 945 to distribution/combination network ports 959 and in turn to phase shifters 983, PAs 984, and antenna elements 914A of the BF module 934. For simplicity, the distribution/combination network 945 of FIG. 9B includes only a single distribution/combination network port 959 for each of the antenna elements 914A. Similarly, a single PA and phase shifter 983 are shown connected to each distribution/combination network port 959. However, it should be understood that each data beam can be provided with separate phase shifters 983 per antenna element to allow for separately steering the transmitting direction for two data beams BEAM1 and BEAM2.

Referring to FIG. 9C, an example cross coupling cancellation configuration for a phased array antenna with two data beams in a transmitting (Tx) configuration is shown. The BF module 935 of FIG. 9C includes additional transmitting components (e.g., PAs 984, phase shifters 983) and receiving components (e.g., LNAs 982, phase shifters 983) that can be used to separately amplify and/or phase shift transmitted and/or received signals. In the illustrated example, the distribution/combination network 946 includes two distribution/combination network ports 959A, 959B for each antenna element 914A. For example, the distribution/combination network port 959A can be coupled to distribution/combination network port 908 and the distribution/combination network port 959B can be coupled to distribution/combination network port 910. Each distribution/combination network port 959A, 959B can be coupled to a separate phase shifter 983 along the transmitting (Tx) path. In one example configuration 986, PA 984 outputs can be combined at a combiner 961 before being output to the antenna element 914A. In another example configuration 985, the phase shifter 983 outputs corresponding to separate transmit (Tx) signal paths can be combined at a combiner 964 and amplified by a shared PA 984 before being output to the antenna element 914A. In some implementations, divider/combiners 960 can be coupled to a transmitting (Tx) signal path (e.g., including a PA 984 and a phase shifter 983) and a receiving (Rx) signal path (e.g., including LNA 982 and phase shifter 983). The illustration of FIG. 9C provides some example configurations of components that can be included in a coupling cancellation configuration. In some cases, more, fewer, and/or different components can be used without departing from the scope of the present disclosure.

Returning to FIG. 9B, in one illustrative example, the RF signal for BEAM1 input to the first RF port 902 of BF module 934 can have an amplitude B1 and the RF signal for BEAM2 input to the second RF port 904 can have an amplitude B2. In some examples, the coupling port 906 can be terminated. For example, the coupling port 906 can be terminated with a resistor outside of the BF module 934. In some cases, the coupling port 906 can be terminated at a signal source (e.g., a BF RFIO). In the illustrated example, the coupling signal 991 transmitted by the antenna elements 914A and/or the coupling signal 992 transmitted by the Tx antenna ports 976 can couple to the first RF port 902, second RF port 904, and coupling port 906. In some cases, the coupling signal 991 can include a first coupling component C_{B1} corresponding to BEAM1 and a second coupling component C_{B2} corresponding to BEAM2. In some cases, the spacing between conductors (e.g., routing traces, solder balls, bond pads, or the like) for the RF ports 902, 904, 906 may be configured with similar dimensions and have small spacing such that a coupling signal (e.g., coupling signals 991 and/or coupling signals 992) coupled to each of the RF ports 902, 904, 906 can have a same amplitude, phase shift, and/or time delay. Accordingly, the combination of BEAM1 and the first and second coupling components at RF port 902 can be B1+C_{B1}+C_{B2}. Similarly, the combination of BEAM2 and the first and second coupling components at RF port 904 can be B2+C_{B1}+C_{B2}. The coupling port 906 can include the first and second coupling components C_{B1}+C_{B2}. The coupling signal can be divided by the splitter 921 and provided to the non-inverting ports of each of the differential amplifiers 920A, 920B. In some cases, the splitter 921 can evenly split the coupling signal power between the differential amplifiers 920A and 920B. In some cases, the splitter 921 can provide an uneven power split. In some cases weighting the proportion of the coupling signal power provided to each of the differential amplifiers 920A, 920B by the splitter 921 can be reflected in the weighting coefficients ω₁, ω₂ of each respective differential amplifier 920A, 920B. In some cases, the non-inverting signal path and the inverting signal path can have variable gains that can be controlled separately. In some cases, the variable gains can be reflected in the weighting coefficients ω₁, ω₂ of each respective differential amplifier 920A, 920B.

Applying Equation (2) for the inputs of differential amplifier 920A (assuming a gain of α) produces an output A_{B1} as shown in Equation (3a):

$${A}_{B 1} = α * ( {ω}_{1 , B 1} ( B 1 + {C}_{B 1} + {C}_{B 2} ) - {ω}_{2 , B 1} * ( {C}_{B 1} + {C}_{B 2} ) ) \qquad ( 3 a )$$

$$= α * ( {ω}_{1 , B 1} B 1 + ( {ω}_{1 , B 1} - {ω}_{2 , B 1} ) * ( {C}_{B 1} + {C}_{B 2} ) )$$

Where ω_{1,B1}, ω_{2,B1} are weighting coefficients associated with the differential amplifier 920A. Applying Equation (2) for the inputs of differential amplifier 920B (assuming a gain of α) produces an output A_{B2} as shown in Equation (3b):

$${A}_{B 2} = α * ( {ω}_{1 , B 2} ( B 2 + {C}_{B 1} + {C}_{B 2} ) - {ω}_{2 , B 2} * ( {C}_{B 1} + {C}_{B 2} ) ) = α * ( {ω}_{1 , B 2} B 2 + ( {ω}_{1 , B 2} - {ω}_{2 , B 2} ) * ( {C}_{B 1} + {C}_{B 2} ) ) \qquad ( 3 b )$$

Where ω_{1,B2}, ω_{2,B2} are weighting coefficients associated with the differential amplifier 920B. As can be seen from the values A_{B1}, A_{B2}, the inclusion of a shared coupling port 906 can be used to partially cancel coupling between the antenna elements 914A and/or antenna ports 976 and the first RF port 902 and the second RF port 904. In some implementations, the coupling cancellation provided by coupling port 906 can partially reduce the effect of the coupling signals, 991, 992 without completely cancelling the coupling. In some cases, the weights ω_{1,B1}, ω_{2,B1}, ω_{1,B2}, and/or ω_{2,B2} can be tuned to minimize the impact of coupling from one or more coupling paths (e.g., antenna element(s) 914A and/or antenna port(s) 976 with the strongest coupling to the RF ports 902, 904, 906) relative to one or more other coupling paths.

Compared to the BF module 835 of FIG. 8F, the BF module 934 of FIG. 9B can reduce the number of external connections by one, thereby potentially reducing the size and/or cost of the BF module 934. Some advantages of reducing the size of the BF module 934 can include, without limitation, easier RF signal routing due to more available empty routing space, increased antenna element density, reduced production cost, or the like.

Although FIGS. 9B and 9C illustrate the inverting inputs of the differential amplifiers 920A, 920B split from a single port of the BF module 934 by the splitter 921 to distribute the coupling cancellation signal to the inverting inputs of both differential amplifiers 920A, 920B, a configuration that uses different inputs of the differential amplifiers 920A, 920B can be used without departing from the scope of the present disclosure. For example, in some cases, the coupling cancellation signal can be provided to non-inverting inputs of both differential amplifiers 920A, 920B. In some examples, the coupling cancellation signal from the splitter 921 can be provided to an inverting input of one of the differential amplifiers 920A, 920B and a non-inverting input of the other of the differential amplifiers 920A, 920B. In some cases, the first RF port 902 and coupling port 906 can operate as a first differential RF port pair. In some examples, second RF port 904 and coupling port 906 can operate as a second differential RF port pair.

FIG. 9D illustrates an example coupling cancellation configuration for a receiving (Rx) antenna incorporating a coupling port 906 as described with respect to FIG. 9A. In the BF module 936 of FIG. 9D, the signal conditioning components 949 include two single-ended to amplifiers 930A, 930B. Each of the amplifiers 930A, 930B can include an inverting (−) output and a non-inverting (+) output. The input of amplifier 930A can be coupled to the distribution/combination network port 908. The input of amplifier 930B can be coupled to the distribution/combination network port 910. As illustrated, the non-inverting output of the amplifier 930A can be coupled to the first RF port 902. In some aspects, the first RF port 902 can correspond to a BEAM1+ signal. The non-inverting output of the amplifier 930B can be coupled to the second RF port 904. In some aspects, the second RF port 904 can correspond to a BEAM2+ signal. In the illustrated example of FIG. 9D, the inverting outputs of the amplifiers 930A, 930B can be combined by a combiner 931. The combined signals from the output of combiner 931 can be coupled to the coupling port 906. In some cases, incident electromagnetic signals can stimulate the antenna elements 914A to generate one or more received RF signals. In some cases, the antenna element 914A can be stimulated by two data beams (e.g., BEAM1, BEAM2) simultaneously. In some cases, the two data beams can originate from different directions (e.g., during simultaneous communication between two satellites and one UE, or the like). In some cases, the two data beams can originate from the same direction (e.g., a single satellite communicating with a single UE over multiple data beams simultaneously to improve bandwidth, reliability, or the like).

FIG. 9D illustrates two example configurations for providing phase shift (e.g., by phase shifters 983) and amplification (e.g., by LNAs 982) for each data beam (e.g., BEAM1, BEAM2) to achieve the desired beamforming characteristics. In one example configuration 986, a signal received at the antenna elements 914A can be divided at a divider 962 and distributed to different LNAs 982 corresponding to separate receive (Rx) signal paths. In another example configuration 985, a signal received at the antenna elements 914A can be divided at divider 965 after amplification by a single LNA 982 and distributed to different phase shifters 983 corresponding to separate receive (Rx) signal paths. In the example configurations of FIG. 9D, each antenna element 914A is associated with two phase shifters 983 in the receive signal path. In some cases, different phase shifts can be applied by the phase shifters 983 for each data beam and provided to separate distribution/combination network ports 959A/959B of the distribution/combination network 948. For example, a beamformed first data beam (e.g., BEAM1) can couple to the distribution/combination network port 959A of the distribution/combination network 948 and a beamformed second data beam (e.g., BEAM2) can couple to the distribution/combination network port 959B of the distribution/combination network 948. In some cases, the distribution/combination network ports 959A can be coupled to distribution/combination network port 908 and the distribution/combination network ports 959B can be coupled to distribution/combination network port 910. The illustration of FIG. 9D provides some example configurations of components that can be included in example coupling cancellation configurations. In some cases, more, fewer, and/or different components can be used without departing from the scope of the present disclosure.

In the example of FIG. 9D, the amplifier 930A can have a gain of α1. The resulting differential outputs of the amplifier 930A can have amplitudes A_{S+}, A_{S-}, as shown in equations (4a), (4b), respectively:

$${A}_{S +} = {α}_{1} * ( S * {ω}_{3 , S} ) \qquad ( 4 a )$$

$${A}_{S -} = - {α}_{1} * ( S * {ω}_{4 , S} ) \qquad ( 4 b )$$

Where ω₃, ω₄ are weighting coefficients. In some cases, the weighting coefficients can be used to adjust the relative gain and/or phase of the two differential output signals of the amplifier 930A.

Similarly, in the example of FIG. 9D, the amplifier 930B can have a gain of α₂ The resulting differential outputs of the amplifier 930B can have amplitudes A_{S+}, A_{S-}, as shown in equations (5a), (5b), respectively:

$${A}_{S +} = {α}_{2} * ( S * {ω}_{5 , S} ) \qquad ( 5 a )$$

$${A}_{S -} = - {α}_{2} * ( S * {ω}_{6 , S} ) \qquad ( 5 b )$$

Where ω₅, ω₆ are weighting coefficients. In some cases, the weighting coefficients can be used to adjust the relative gain and/or phase of the two differential output signals of the amplifier 930B.

As Illustrated in FIG. 9D, the BEAM1 signal B1 from distribution/combination network port 908 can be amplified and converted to a differential output signal between the non-inverting and inverting output ports of the amplifier 930A as illustrated by Equations (6a) and (6b) below:

$${A}_{B 1 +} = {α}_{1} * ( B 1 * {ω}_{3} ) \qquad ( 6 a )$$

$${A}_{B 1 -} = - {α}_{1} * ( B 1 * {ω}_{4} ) \qquad ( 6 b )$$

Similarly, the BEAM2 signal B2 from distribution/combination network port 910 can be amplified and converted to a differential output signal between the non-inverting and inverting output ports of the amplifier 930B as illustrated by Equations (7a) and (7b) below:

$${A}_{B 2 +} = {α}_{2} * ( B 2 * {ω}_{5} ) \qquad ( 7 a )$$

$${A}_{B 2 -} = - {α}_{2} * ( B 2 * {ω}_{6} ) \qquad ( 7 b )$$

In the illustrated example of FIG. 9D, the inverting output ports of the amplifiers 930A, 930B are connected to a combiner 931 and the output port of the combiner 931 is coupled to the coupling port 906. In some cases, the inverting output port of the amplifier 930A may have an output impedance Z₁ that will see the inverting output port of the amplifier 930B as a load impedance Z₂ via the combiner 931. Similarly, the inverting output port of the amplifier 930B will see the inverting output port of the amplifier 930A as a load via the combiner 931. In some cases, the weighting coefficients ω₄, ω₆ can be configured to compensate for the loading of each respective inverting output port of the amplifiers 930A, 930B. The combined coupling signal output from the combiner 931 can have an amplitude C_{B1,B2} as illustrated in Equation (8) below.

$${C}_{B 1 , B 2} = - {α}_{1} * B 1 * {ω}_{4} - {α}_{2} * B 2 * {ω}_{6} \qquad ( 8 )$$

In some cases, the non-inverting output and the inverting output port of each amplifier 930A, 930B can have variable gains that can be controlled separately. In some cases, the variable gains of amplifier 930A can be reflected in the weighting coefficients W3, ω₄. In some examples, the variable gains of amplifier 930B can be reflected in the weighting coefficients W5, ω₆.

In some cases, a portion of the signals output on each of the first RF port 902, second RF port 904, and coupling port 906 can radiate and couple to the antenna element 914A (as represented by the coupling signals 992). In some cases, a portion of the signals output on each of the first RF port 902, second RF port 904, and coupling port 906 can radiate and couple to the antenna ports 974 (as represented by coupling signals 993).

The coupling signals (e.g., coupling signals 992 and/or 993 can include a positive BEAM1+ component C_{B1+} from the first RF port 902, a positive BEAM2+ component C_{B2+} from the second RF port 904. The coupling signals 992 can also include a BEAM1− component C_{B1-} and BEAM2− component C_{B2-} from the coupling port 906. If the coupling parameters between each of the ports 902, 904, 906 and the antenna elements 914A and/or antenna ports 974 are equal, the coupling signal can be completely canceled. However, in some cases, the coupling signals 992, 993 can include coupling between the RF ports 902, 904, 906 and multiple antenna elements 914A, and/or antenna ports 974. In some implementations, the coupling cancellation provided by coupling port 906 can partially reduce the effect of the coupling signals, 992, 993 without completely cancelling the coupling. In some cases, the weights ω₃, ω₄, ω₅, and/or ω₆ can be tuned to minimize the impact of coupling from one or more coupling paths (e.g., antenna element(s) 914A and/or antenna port(s) 974 with the strongest coupling to the RF ports 902, 904, 906) relative to one or more other coupling paths.

Although FIG. 9D illustrates the inverting outputs of the amplifiers 930A, 930B combined together by the combiner 931 to generate the coupling cancellation signal, a configuration that uses different outputs of the amplifiers 930A, 930B can be used without departing from the scope of the present disclosure. For example, in another implementation (not shown), both non-inverting outputs of the amplifiers 930A, 930B can be combined together to generate the coupling cancellation signal. In another implementation (not shown), a non-inverting output from one of the amplifiers 930A, 930B can be combined with an inverting output of the other of the amplifiers 930A, 930B to generate the coupling cancellation signal.

Returning to FIG. 9B and FIG. 9C, although the signal conditioning components 949 of BF module 935 are illustrated for a transmitting (Tx) configuration, the signal conditioning components 949 of FIG. 9C can additionally or alternatively include the amplifiers 930A, 930B and other components for operating the BF module 934 in a receiving (Rx) configuration as illustrated in FIG. 9D.

FIG. 9E illustrates an example coupling cancellation configuration for a transmitting (Tx) antenna incorporating coupling cancellation ports in a serially fed FE network configuration. In the example of FIG. 9E, the BF module 937 includes signal conditioning components 949 similar to the signal conditioning components 949 of the configurations of FIG. 9B and FIG. 9C. In some implementations, the BF module 937 can correspond to an individual FE of the serially fed FE networks 432, 434 of FIG. 4C. In the configuration of FIG. 9E, in addition to the distribution/combination network ports 908, 910 of the distribution/combination network 989 coupled to the signal conditioning components 949 and the distribution/combination network ports 959 of the distribution/combination network 989 coupled to the signal paths for antenna elements 914A shown in FIGS. 9B and 9C, the distribution/combination network 990 can includes additional ports 911, 913 coupled to signal conditioning components 947. As illustrated, the signal conditioning components 949 can include a pair of amplifiers 922A, 922B. The amplifiers 922A, 922B can correspond to signal through paths for BEAM1 and BEAM2, respectively, in a serially fed FE network. As shown, the amplifiers 922A, 922B have single ended connections to the distribution/combination network 946 at the distribution/combination network ports 908, 910. The outputs of the amplifiers 922A and 922B can be coupled to a first serial RF port 903 and second serial RF port 905 of the BF module 937. As illustrated, the BF module 937 can also include a third serial RF port 907. In the illustrated example, the third serial RF port 907 can be coupled to a termination 923. As illustrated, the transmitted signal from the antenna elements 914A can couple to the serial RF ports 903, 905, 907 (as indicated by the coupling signals 996). In some cases, signal leakage from the antenna ports 976 can couple to the the serial RF ports 903, 905, 907 (as represented by coupling signals 997). In some cases, the coupling signals 996, 997 can be at least partially cancelled in a subsequent individual FE of a serially fed FE network (e.g., serially fed FE networks 432, 434) that includes BF module 937 as illustrated in FIG. 10A below. For example, RF ports 902, 904, 906 can be driven by the serial RF ports 903, 905, and 907 of a preceding individual FE of a serially fed FE network.

FIG. 9F illustrates an example coupling cancellation configuration for a receiving (Rx) antenna incorporating coupling cancellation ports in a serially fed FE network configuration. In the example of FIG. 9F, the BF module 938 includes signal conditioning components 949 similar to the signal conditioning components 949 of the configuration of FIG. 9D. In some implementations, the BF module 938 can correspond to an individual FE of the serially fed FE networks 432, 434 of FIG. 4C. In the configuration of FIG. 9F, in addition to the distribution/combination network ports 908, 910 coupled to the signal paths for the signal conditioning components 949 and the distribution/combination network ports 959 of the distribution/combination network 990 coupled to the signals chains of the antenna elements 914A, the distribution/combination network 990 can include additional ports 911, 913 coupled to the signal conditioning components 947. As illustrated, the signal conditioning components can include a pair of amplifiers 932A, 932B. The amplifiers 932A, 932B can correspond to signal through paths for BEAM1 and BEAM2, respectively, in a serially fed FE network. As shown, the amplifiers 932A, 932B include single ended connections to the distribution/combination network 990 at the distribution/combination network ports 908, 910. The input of the amplifier 932A can be coupled to a first serial RF port 903. The input of the amplifier 932B can be coupled to a second serial RF port 905. The serial coupling port can be terminated by a termination 942. As illustrated, the serial RF ports 903, 905, 907 can radiate coupling signals that can be received by the antenna elements 914A (as indicated by coupling signals 998) and/or dual antenna ports 974 (as indicated by coupling signals 999). The serial RF ports 903, 905, 907 can be driven by the first RF port 902, second RF port 904, and coupling port 906 of a preceding individual FE of a serially fed FE network as illustrated in FIG. 10B below. Accordingly, the coupling signals can at least partially cancel at the antenna elements 914A and/or at the antenna ports 974, 976 as described with respect to FIG. 9D. In some cases, differing amounts of attenuation and/or phase shift between the signals at each of the serial RF ports 903, 905, 907 can reduce the effectiveness of cancellation (e.g., by causing the positive and negative components to no longer be 180 degrees out of phase). In some cases, phase and attenuation differences can be small by design as such differences between signal paths can affect phased array antenna performance such as signal-to-noise ratio (SNR), side lobe level, beam steering accuracy, or the like.

The examples of FIGS. 9A through 9F are provided only for the purposes of illustration. Other configurations containing more, fewer, and/or different components can be used without departing from the scope of the present disclosure. For example, in some configurations, a BF module can include coupling cancellation components (e.g., as shown in FIGS. 9B through 9F) for both transmitting (Tx) and receiving (Rx) modes. In some cases, a BF module can include only transmitting (Tx) components. In some cases, a BF module can include only receiving (Rx) components. The examples also illustrate beamformer configurations including two data beams. It should be understood that configurations incorporating three or more data beams can be used with the coupling cancellation systems and techniques described herein without departing from the scope of the present disclosure.

In the illustrative examples of FIG. 9A, 9B, 9E and FIG. 9F, simplified configurations of the LNAs 982, phase shifters 983, and PAs 984 illustrating a single signal path are shown. However, the example configurations of LNAs 982, phase shifters 983, and PAs 984 illustrated in BF module 936 of FIG. 9C can similarly be used in the BF modules 937, 938 of FIG. 9E and FIG. 9F.

In the examples of FIG. 9A through FIG. 9F, the connections between signal conditioning components 949 and distribution/combination networks 945, 946, 948, 989, 990 are shown as single ended signal paths which remain single ended throughout the signal chains to the antenna ports 974, 976. However, in some cases, example configurations 885, 886 as illustrated in FIG. 8J, and/or any other configurations including different single ended and/or differential signaling along portions of the transmit (Tx) and/or receive (Rx) signal paths for the antenna elements 914A can be used without departing from the scope of the present disclosure.

FIG. 10A illustrates an example coupling cancellation configuration 1000 for a serially fed FE network of a phased array antenna in a transmitting (Tx) mode. In the illustrated example, each of the BF modules 1037A, 1037B can correspond to BF module 937 of FIG. 9E. In the illustrated example of FIG. 10A, a signal propagation direction 1005 is illustrated as an arrow pointing from left to right. As illustrated, a first data beam BEAM1 can be input to a first RF port 1002A of the serially fed FE, a second data beam BEAM2 can be input to a second RF port 1004A of the BF module 1037A, and a coupling cancellation signal can be input to the coupling port 1006A. In the illustrated example, the BF module 1037A can perform beamforming for BEAM1 and BEAM2 data beams for transmission by the antenna elements 1014A. In addition to beamforming the data beams BEAM1 and BEAM2, the BF module 1037A can output data beam BEAM1 from first RF serial port 1003A and data beam BEAM2 from the second RF serial port 1005A.

As illustrated, the first RF serial port 1003A of the BF module 1037A can be coupled to the first RF port 1002B of BF module 1037B and the second RF serial port 1005A of the BF module 1037A can be coupled to the second RF port 1004B of the BF module 1037B. In addition, the third RF serial port 1007A of the BF module 1037A can be coupled to the coupling port 1006B of the BF module 1037B. In the illustrated example, the BF module 1037B can perform beamforming for BEAM1 and BEAM2 data beams for transmission by the antenna elements 1014B. In some cases, one or more additional BF modules can be included in the serial fed FE network after (e.g., relative to the signal propagation direction 1005) the BF module 1037B and/or before the BF module 1037A.

For the purposes of simplicity, the antenna elements 1014A, 1014B are illustrated as single port antenna elements. Accordingly, the BF module 1037A is coupled to the antenna elements 1014A by single antenna ports 1074A. In some cases, dual port antenna elements (e.g., antenna elements 914A of FIG. 9E) and dual antenna ports (e.g., antenna ports 974, 976 of FIG. 9E) can be used without departing from the scope of the present disclosure.

FIG. 10A illustrates coupling signals 1092 between the antenna elements 1014A and/or antenna ports 1074A to the input side of the BF module 1037A (e.g., first RF port 1002A, the second RF port 1004A, and coupling port 1006A). In some cases, coupling cancellation circuitry (e.g., signal conditioning components 949 of FIG. 9E) can be used to provide coupling cancellation of the coupling signals 1092 as described above with respect to FIG. 9A through FIG. 9C and FIG. 9E above.

Similarly, FIG. 10A illustrates coupling signals 1093 between the antenna elements 1014A and/or antenna ports 1074A to the output side of the BF module 1037A (e.g., first RF serial port 1003A, second RF serial port 1005A, and third RF serial port 1007A). The coupling signals 1093 can appear at the first RF port 1002B, second RF port 1004B, and coupling port 1006B of BF module 1037B. FIG. 10A also illustrates coupling signals 1094 between the antenna elements 1014B and/or antenna ports 1074B to the input side of the BF module 1037B (e.g., first RF port 1002B, the second RF port 1004B, and coupling port 1006B). In some cases, coupling cancellation circuitry (e.g., signal conditioning components 949 of FIG. 9E) can be used to provide coupling cancellation of the coupling signals 1093 and 1094 at the BF module 1037B as described above with respect to FIG. 9A through FIG. 9C and FIG. 9E above.

FIG. 10A also illustrates coupling signals 1095 between the antenna elements 1014B and/or antenna ports 1074B to the output side of the BF module 1037B (e.g., first RF serial port 1003B, second RF serial port 1005B, and third RF serial port 1007B). In some cases, the coupling signals 1095 can be cancelled at a BF module (not shown) following the BF module 1037B in a serially fed FE network as described above with respect to FIG. 9A through FIG. 9C and FIG. 9E above. In some cases, if the BF module 1037B can be the final BF module in the serially fed FE network, the coupling signals 1095 may not be used by another BF module to perform coupling cancellation.

FIG. 10B illustrates an example coupling cancellation configuration 1050 for a serially fed FE network of a phased array antenna in a receiving (Rx) mode. In the illustrated example, each of the BF modules 1038A, 1038B can correspond to BF module 938 of FIG. 9F. In the illustrated example of FIG. 10A, a signal propagation direction 1015 is illustrated as an arrow pointing from right to left. As illustrated, a first data beam BEAM1 can be input to a first RF serial port 1003B of the BF module 1038B, a second data beam BEAM2 can be input to a second RF serial port 1005B of the BF module 1038B, and a coupling cancellation signal can be input to the third RF serial port 1007B of the BF module 1038B. In the illustrated example, the BF module 1038B can perform beamforming for BEAM1 and BEAM2 data beams received by the antenna elements 1014B. In some cases, the BF module 1038B can combine the beamformed BEAM1 signals received by the antenna elements 1014B and the BEAM1 signal received at the first RF serial port 1003B of the BF module 1038B and output the combined BEAM1 signal to first RF port 1002B of the BF module 1038B. Similarly, the BF module 1038B can combine the beamformed BEAM2 signals received by the antenna elements 1014B and the BEAM2 signal received at the second RF serial port 1005B of the BF module 1038B and output the combined BEAM2 signal to second RF port 1004B of the BF module 1038B. In some cases, one or more additional BF modules can be included in the serial fed FE network before (e.g., relative to the signal propagation direction 1015) the BF module 1037B and/or after the BF module 1038B.

As illustrated, the first RF serial port 1003A of the BF module 1038A can be coupled to the first RF port 1002B of BF module 1038B and the second RF serial port 1005A of the BF module 1038A can be coupled to the second RF port 1004B of the BF module 1038B. In addition, the third RF serial port 1007A of the BF module 1038A can be coupled to the coupling port 1006B of the BF module 1038B.

For the purposes of simplicity, the antenna elements 1014A, 1014B of FIG. 10B are illustrated as single port antenna elements. As illustrated, the BF module 1038A is coupled to the antenna elements 1014A by single antenna ports 1074A and the BF module 1038B is coupled to the antenna elements 1014B by single antenna ports 1074B. In some cases, dual port antenna elements (e.g., antenna elements 914A of FIG. 9F) and dual antenna ports (e.g., antenna ports 974, 976 of FIG. 9F) can be used without departing from the scope of the present disclosure.

FIG. 10B illustrates coupling signals 1099 between the input side of the BF module 1038B (e.g., first RF serial port 1003B, second RF serial port 1005B, and third RF serial port 1007B) and antenna elements 1014B and/or antenna ports 1074B. In some cases, the BF module 1038B can be the first BF module in the serially fed FE network and the data beams BEAM1 and BEAM2 may not be present at the input side of the BF module 1038B. Accordingly, coupling between the input side of the BF module 1038B and the antenna elements 1014B and/or antenna ports 1074B may not interfere with the BEAM1 and BEAM2 signals received by the antenna elements 1014B and beamformed by the BF module 1038B. In some cases, the coupling signals 1099 can represent BEAM1 and BEAM2 signals received from a BF module (not shown) before (e.g., relative to the signal propagation direction 1015) the BF module 1038B. The coupling signals 1099 can include a coupling cancelation signal provided by coupling cancellation circuitry (e.g., signal conditioning components 949 of FIG. 9F) of the BF module (not shown) before the BF module 1038B that can provide coupling cancellation as described above with respect to FIG. 9A, FIG. 9D and FIG. 9F above.

Similarly, FIG. 10B illustrates coupling signals 1097 between the input side of the BF module 1038A (e.g., first RF serial port 1003A, second RF serial port 1005A, and third RF serial port 1007A) and the antenna elements 1014A and/or antenna ports 1074A. The coupling signals 1097 can be generated at the first RF port 1002B, second RF port 1004B, and coupling port 1006B of BF module 1038B. FIG. 10B also illustrates coupling signals 1098 between the output side of the BF module 1038B (e.g., first RF port 1002B, the second RF port 1004B, and coupling port 1006B) and the antenna elements 1014B and/or antenna ports 1074B. In some cases, coupling cancellation circuitry (e.g., signal conditioning components 949 of FIG. 9F) of the BF module 1038B can be used to provide coupling cancellation of the coupling signals 1097 and 1098 as described above with respect to FIG. 9A, FIG. 9D and FIG. 9F above.

FIG. 10B illustrates coupling signals 1096 between the output side of the BF module 1038A (e.g., first RF port 1002A, the second RF port 1004A, and coupling port 1006A) and the antenna elements 1014A and/or antenna ports 1074A. In some cases, coupling cancellation circuitry (e.g., signal conditioning components 949 of FIG. 9F) of BF module 1038A can be used to provide coupling cancellation of the coupling signals 1096 as described above with respect to FIG. 9A, FIG. 9D and FIG. 9F above. In some cases, the coupling cancellation circuitry (e.g., signal conditioning components 949 of FIG. 9F) of BF module 1038A can provide coupling cancellation at the input side of a BF module (not shown) after the BF module 1038A of FIG. 10B.

In some examples, one or more processes, such as digital signaling and/or data processing operations, may be performed by one or more computing devices or apparatuses. In some examples, the phased array antenna systems, FEs, BF modules, RFIO circuits, and/or other components described herein can be implemented by a user terminal or SAT shown in FIG. 1A and/or one or more computing devices with the computing device architecture 1100 shown in FIG. 11. In some cases, such a computing device or apparatus may include a processor, microprocessor, microcomputer, or other component of a device that is configured to carry out one or more operations described herein. In some examples, such computing device or apparatus may include one or more antennas for sending and receiving RF signals. In some examples, such computing device or apparatus may include an antenna and a modem for sending, receiving, modulating, and demodulating RF signals.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

In some cases, one or more operations described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which any operations are described is not intended to be construed as a limitation, and any number of the described operations can be combined in any order and/or in parallel to implement the processes.

FIG. 11 illustrates an example computing device architecture 1100 of an example computing device which can implement various techniques and/or operations described herein. For example, the computing device architecture 1100 can be used to implement at least some portions of the SATs 102, the SAGs 104, the user terminals 112 and/or the user network devices 114 shown in FIG. 1A, and perform at least some of the operations described herein. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general purpose processor and a hardware or software service stored in storage device 1130 and configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art, such as a display, projector, television, speaker device. In some instances, multimodal computing devices can enable a user to provide multiple types of input to communicate with the computing device architecture 1100. The communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include software, code, firmware, etc., for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using signals and/or computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication devices, or integrated circuit devices having multiple uses including application in wireless communications and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

While illustrative embodiments have been illustrated and described, it will be appreciated that various changes can be made therein without departing from the spirit and scope of the disclosure.

Illustrative Aspects of the disclosure include:

Aspect 1: An amplifier module comprising first, second, and third radio frequency (RF) ports, wherein the first and third RF ports are configured as a first differential RF signal port pair and the second and third RF ports are configured as a second differential RF signal port pair, wherein the first RF port corresponds to a first RF signal and the second RF port corresponds to a second RF signal, different from the first RF signal.

Aspect 2: The amplifier module of Aspect 1, wherein, in a receiving (Rx) mode of the amplifier module: the third RF port comprises a coupling cancellation port configured to transmit a coupling cancellation signal; and the coupling cancellation signal comprises a first coupling cancellation signal component and a second coupling cancellation signal component.

Aspect 3: The amplifier module of Aspect 2, further comprising an antenna port coupled to an antenna element, wherein the coupling cancellation signal is configured to at least partially destructively interfere, at the antenna port, with coupling between the first and second RF ports and the antenna port.

Aspect 4: The amplifier module of Aspect 3, wherein: the first coupling cancellation signal component has an inverted phase relative to a coupling between the antenna port and a first RF signal differential component output from the first RF port; and the second coupling cancellation signal component has an inverted phase relative to a coupling between the antenna port and a second RF signal differential component output from the second RF port.

Aspect 5: The amplifier module of Aspect 3 or 4, wherein the amplifier module further comprises: a first amplifier comprising: a first input port; and a first differential output port pair of the first amplifier coupled to the first differential RF signal port pair, wherein the first amplifier is configured to generate a first differential output signal at the first differential output port pair of the first amplifier based on a first RF input signal received at the first input port; and a second amplifier comprising: a second input port; and a second differential output port pair of the second amplifier coupled to the second differential RF signal port pair, wherein the second amplifier is configured to generate a second differential output signal at the second differential output port pair of the second amplifier based on a second RF input signal received at the second input port.

Aspect 6: The amplifier module of Aspect 5 further comprising a combiner configured to combine the first coupling cancellation signal component and the second coupling cancellation signal component, wherein: the combiner is configure to receive the first coupling cancellation signal component from one port of the first differential output port pair of the first amplifier; and the combiner is configure to receive the second coupling cancellation signal component from one port of the second differential output port pair of the second amplifier.

Aspect 7: The amplifier module of Aspect 5, further comprising: a first phase shifter configured to apply a first phase shift to a received signal received at the antenna port, wherein the first phase shifter is included in a signal chain of the first input port of the first amplifier; and a second phase shifter configured to apply a second phase shift to the received signal received at the antenna port, wherein the second phase shifter is included in a signal chain of the second input port of the first amplifier, and wherein the first phase shifter and the second phase shifter can be configured to apply different phase shifts.

Aspect 8: The amplifier module of Aspect 7, further comprising: a low noise amplifier (LNA) coupled to the antenna port and configured to amplify the received signal received at the antenna port, wherein an output of the LNA is phase shifted by the first phase shifter and the output of the LNA is phase shifted by the second phase shifter.

Aspect 9: The amplifier module of Aspect 7, further comprising: a first LNA, wherein an output of the first LNA is phased shifted by the first phase shifter; and a second LNA, wherein the output of the second LNA is phased shifted by the second phase shifter.

Aspect 10: The amplifier module of any one of Aspects 5 to 9, wherein: the first input port of the first amplifier comprises a first differential input port pair; and the second input port of the second amplifier comprises a second differential input port pair.

Aspect 11: The amplifier module of any one of Aspects 5 to 9, wherein the first input port and the second input port are single ended input ports.

Aspect 12: The amplifier module of any one of Aspects 5 to 11, further comprising a combination network configured to: combine received signals associated with a signal chain of the antenna port with additional received signals associated with at least one or more of an additional signal chain of an additional antenna port of the amplifier module or one or more additional RF ports of the amplifier module; and output the combined received signals to the first amplifier and the second amplifier.

Aspect 13: The amplifier module of Aspect 1, further comprising an antenna port, wherein, in a transmitting (Tx) mode of the amplifier module, the antenna port is configured to output a combined signal based on the first RF signal and the second RF signal, wherein the combined signal couples with the first RF port, the second RF port, and the third RF port.

Aspect 14: The amplifier module of Aspect 13, wherein: the third RF port comprises a coupling cancellation port; and generating the combined signal comprises: at least partially cancelling the coupling between the combined signal and the first RF port based on a coupling cancellation signal received at the third RF port based on the coupling between the combined signal and the third RF port; and at least partially cancelling the coupling between the combined signal and the second RF port based on the coupling cancellation signal.

Aspect 15: The amplifier module of Aspect 14, wherein: the coupling cancellation signal has a non-inverted phase relative to a coupling between the first RF port and the antenna port; and the coupling cancellation signal has a non-inverted phase relative to a coupling between the second RF port and the antenna port.

Aspect 16: The amplifier module of Aspect 14 or 15, wherein the amplifier module further comprises: a first amplifier having first differential input port pair coupled to the first differential RF signal port pair and a first output port configured to generate a first compensated signal based on the coupling cancellation signal and the first RF signal; and a second amplifier having a second input port coupled to the second differential RF signal port pair, and a second output port configured to generate a second compensated signal based on the coupling cancellation signal and the second RF signal.

Aspect 17: The amplifier module of Aspect 16, further comprising a distributor configured to distribute the coupling cancellation signal to the first amplifier and the second amplifier.

Aspect 18: The amplifier module of Aspect 16 or 17, further comprising: a first phase shifter configured to apply a first phase shift to the first compensated signal to generate a phase shifted first compensated signal; and a second phase shifter configured to apply a first phase shift to the second compensated signal to generate a phase shifted second compensated signal.

Aspect 19: The amplifier module of Aspect 18, further comprising: a combiner configured to combine the phase shifted first compensated signal and the phase shifted second compensated signal into the combined signal; and a power amplifier (PA) configured to amplify the combined signal and output the combined signal to the antenna port.

Aspect 20: The amplifier module of Aspect 18, further comprising: a first PA configured to amplify the phase shifted first compensated signal; a second PA configured to amplify the phase shifted second compensated signal; and a combiner configured to combine the phase shifted first compensated signal and the phase shifted second compensated signal into the combined signal and output the combined signal to the antenna port.

Aspect 21: The amplifier module of any one of Aspects 16 to 20, wherein: the first output port of the first amplifier comprises a first differential output port pair; and the second output port of the second amplifier comprises a second differential output port pair.

Aspect 22: The amplifier module of any one of Aspects 16 to 20, wherein the first output port of the first amplifier and the second output port of the second amplifier are single ended.

Aspect 23: The amplifier module of any one of Aspects 16 to 22, further comprising a distribution network configured to: distribute the first compensated signal to a signal chain of the antenna port and at least one or more of an additional signal chain of an additional antenna port of the amplifier module or one or more additional RF ports of the amplifier module; and distribute the second compensated signal to the signal chain of the antenna port and at least one or more of the additional signal chain of the additional antenna port of the amplifier module or the one or more additional RF ports of the amplifier module.

Aspect 24: The amplifier module of Aspect 1, further comprising first, second, and third RF serial ports; wherein: the first RF serial port corresponds to the first RF signal; the second RF serial port corresponds to the second RF signal; and the third RF serial port corresponds to an additional coupling cancellation signal.

Aspect 25: The amplifier module of Aspect 24, wherein the first RF serial port, the second RF serial port, and the third RF serial port are coupled to a corresponding first additional RF port, second additional RF port, and third additional RF port, respectively, of an additional amplifier module serially connected with the amplifier module.

Aspect 26: The amplifier module of Aspect 25, wherein, in a receive (Rx) mode, the additional coupling cancellation signal is configured to destructively interfere, at an antenna port of the amplifier module, with coupling between the first and second RF serial ports and the antenna port.

Aspect 27: The amplifier module of Aspect 26, wherein the first and third RF serial ports are configured as a third differential RF signal port pair and the second and third RF serial ports are configured as a fourth differential RF signal port pair.

Aspect 28: The amplifier module of Aspect 27, wherein the additional coupling cancellation signal comprises a first coupling cancellation signal component corresponding to the first RF signal and a second coupling cancellation signal component corresponding to the second RF signal.

Aspect 29: The amplifier module of Aspect 28, wherein: the first coupling cancellation signal component has an inverted phase relative to a coupling between the antenna port and a first RF signal differential component output from the first RF serial port; and the second coupling cancellation signal component has an inverted phase relative to a coupling between the antenna port and a second RF signal output differential component from the second RF serial port.

Aspect 30: The amplifier module of Aspect 25, wherein, in a transmit (Tx) mode: a combined signal generated based on the first RF signal and the second RF signal is output from an antenna port of the amplifier module, wherein the combined signal couples with the first RF serial port, the second RF serial port, and the third RF serial port; the additional amplifier module is configured to at least partially cancel the coupling between the combined signal and the first RF serial port based on the additional coupling cancellation signal received at the third RF serial port, wherein the additional coupling cancellation signal is based on a coupling between the combined signal and the third RF serial port; and the additional amplifier module is configured to at least partially cancel the coupling between the combined signal and the second RF serial port based on the additional coupling cancellation signal.

Aspect 31: The amplifier module of Aspect 30, wherein the first and third RF serial ports are configured as a third differential RF signal port pair and the second and third RF serial ports are configured as a fourth differential RF signal port pair.

Aspect 32: The amplifier module of Aspect 31, wherein: the additional coupling cancellation signal has a non-inverted phase relative to a coupling between the first RF serial port and the antenna port; and the additional coupling cancellation signal has a non-inverted phase relative to a coupling between the second RF serial port and the antenna port.

Aspect 33: The amplifier module of any one of Aspects 1 to 32, further comprising fourth, fifth, and sixth RF ports, wherein: the fourth and sixth RF ports are configured as a third differential RF signal port pair; and the fifth and sixth RF ports are configured as a fourth differential RF signal port pair; the fourth RF port corresponds to a third RF signal, wherein the third RF signal is different from the first RF signal and the second RF signal; and the fifth RF port corresponds to a fourth RF signal, different from the, first, second, and third RF signals.

Aspect 34: The amplifier module of any one of Aspects 1 to 33, wherein the amplifier module comprises first, second, and third conductors configured to electrically couple the first, second, and third RF ports to a carrier.

Aspect 35: A method of coupling cancellation at an amplifier in a transmit (Tx) mode, the method comprising: obtaining a first RF signal at a first differential RF port pair, wherein the first differential RF port pair comprises a first RF port and a third RF port; obtaining a second RF signal at a second differential RF port, wherein the second differential RF port comprises a second RF port and the third RF port; outputting a combined signal from an antenna port, wherein the combined signal is based on the first RF signal and the second RF signal, and wherein the combined signal couples with the first RF port, the second RF port, and the third RF port; and obtaining a coupling cancellation signal at the third RF port, wherein the coupling cancellation signal comprises a coupling between the combined signal and the third RF port, wherein generating the combined signal comprises at least partially cancelling the coupling cancellation signal.

Aspect 36: The method of Aspect 35, wherein: the coupling cancellation signal has a non-inverted phase relative to a coupling between the first RF port and the antenna port; and the coupling cancellation signal has a non-inverted phase relative to a coupling between the second RF port and the antenna port.

Aspect 37: A method of coupling cancellation at an amplifier in a receive (Rx) mode, the method comprising: obtaining a received RF signal at an antenna port; generating a first RF signal based on the received RF signal, wherein the first RF signal is output at a first differential RF port pair comprising a first RF port and a third RF port; and generating a second RF signal based on the received RF signal, wherein the second RF signal is output at a second differential RF port pair comprising a second RF port and the third RF port, wherein the third RF port comprises a coupling cancellation port configured to transmit a coupling cancellation signal, wherein the coupling cancellation signal comprises a first coupling cancellation signal component and a second coupling cancellation signal component.

Aspect 38: The method of Aspect 37, wherein: the first coupling cancellation signal component has an inverted phase relative to a coupling between a first RF signal output from the first RF port and the antenna port; and the second coupling cancellation signal component has an inverted phase relative to a coupling between a second RF signal output from the second RF port.

Aspect 39: A method of coupling cancellation in accordance with any of Aspects 1 to 38.

1. An amplifier module comprising first, second, and third radio frequency (RF) ports, wherein the first and third RF ports are configured as a first differential RF signal port pair and the second and third RF ports are configured as a second differential RF signal port pair, wherein the first RF port corresponds to a first RF signal and the second RF port corresponds to a second RF signal, different from the first RF signal.

2. The amplifier module of claim 1, wherein, in a receiving (Rx) mode of the amplifier module:
the third RF port comprises a coupling cancellation port configured to transmit a coupling cancellation signal; and
the coupling cancellation signal comprises a first coupling cancellation signal component and a second coupling cancellation signal component.

3. The amplifier module of claim 2, further comprising an antenna port coupled to an antenna element, wherein the coupling cancellation signal is configured to at least partially destructively interfere, at the antenna port, with coupling between the first and second RF ports and the antenna port.

4. The amplifier module of claim 3, wherein:
the first coupling cancellation signal component has an inverted phase relative to a coupling between the antenna port and a first RF signal differential component output from the first RF port; and
the second coupling cancellation signal component has an inverted phase relative to a coupling between the antenna port and a second RF signal differential component output from the second RF port.

5. The amplifier module of claim 3, wherein the amplifier module further comprises:
a first amplifier comprising:
a first input port; and
a first differential output port pair of the first amplifier coupled to the first differential RF signal port pair, wherein the first amplifier is configured to generate a first differential output signal at the first differential output port pair of the first amplifier based on a first RF input signal received at the first input port; and
a second amplifier comprising:
a second input port; and
a second differential output port pair of the second amplifier coupled to the second differential RF signal port pair, wherein the second amplifier is configured to generate a second differential output signal at the second differential output port pair of the second amplifier based on a second RF input signal received at the second input port.

6. The amplifier module of claim 5 further comprising a combiner configured to combine the first coupling cancellation signal component and the second coupling cancellation signal component, wherein:
the combiner is configure to receive the first coupling cancellation signal component from one port of the first differential output port pair of the first amplifier; and
the combiner is configure to receive the second coupling cancellation signal component from one port of the second differential output port pair of the second amplifier.

7. The amplifier module of claim 5, further comprising:
a first phase shifter configured to apply a first phase shift to a received signal received at the antenna port, wherein the first phase shifter is included in a signal chain of the first input port of the first amplifier; and
a second phase shifter configured to apply a second phase shift to the received signal received at the antenna port, wherein the second phase shifter is included in a signal chain of the second input port of the first amplifier, and wherein the first phase shifter and the second phase shifter can be configured to apply different phase shifts.

8. The amplifier module of claim 7, further comprising: a low noise amplifier (LNA) coupled to the antenna port and configured to amplify the received signal received at the antenna port, wherein an output of the LNA is phase shifted by the first phase shifter and the output of the LNA is phase shifted by the second phase shifter.

9. The amplifier module of claim 7, further comprising:
a first LNA, wherein an output of the first LNA is phased shifted by the first phase shifter; and
a second LNA, wherein the output of the second LNA is phased shifted by the second phase shifter.

10.-11. (canceled)

12. The amplifier module of claim 5, further comprising a combination network configured to:
combine received signals associated with a signal chain of the antenna port with additional received signals associated with at least one or more of an additional signal chain of an additional antenna port of the amplifier module or one or more additional RF ports of the amplifier module; and
output the combined received signals to the first amplifier and the second amplifier.

13. The amplifier module of claim 1, further comprising an antenna port, wherein, in a transmitting (Tx) mode of the amplifier module, the antenna port is configured to output a combined signal based on the first RF signal and the second RF signal, wherein the combined signal couples with the first RF port, the second RF port, and the third RF port.

14. The amplifier module of claim 13, wherein:
the third RF port comprises a coupling cancellation port; and
generating the combined signal comprises:
at least partially cancelling the coupling between the combined signal and the first RF port based on a coupling cancellation signal received at the third RF port based on the coupling between the combined signal and the third RF port; and
at least partially cancelling the coupling between the combined signal and the second RF port based on the coupling cancellation signal.

15. The amplifier module of claim 14, wherein:
the coupling cancellation signal has a non-inverted phase relative to a coupling between the first RF port and the antenna port; and
the coupling cancellation signal has a non-inverted phase relative to a coupling between the second RF port and the antenna port.

16. The amplifier module of claim 14, wherein the amplifier module further comprises:
a first amplifier having first differential input port pair coupled to the first differential RF signal port pair and a first output port configured to generate a first compensated signal based on the coupling cancellation signal and the first RF signal; and
a second amplifier having a second input port coupled to the second differential RF signal port pair, and a second output port configured to generate a second compensated signal based on the coupling cancellation signal and the second RF signal.

17. The amplifier module of claim 16, further comprising a distributor configured to distribute the coupling cancellation signal to the first amplifier and the second amplifier.

18. The amplifier module of claim 16, further comprising:
a first phase shifter configured to apply a first phase shift to the first compensated signal to generate a phase shifted first compensated signal; and
a second phase shifter configured to apply a first phase shift to the second compensated signal to generate a phase shifted second compensated signal.

19. The amplifier module of claim 18, further comprising:
a combiner configured to combine the phase shifted first compensated signal and the phase shifted second compensated signal into the combined signal; and
a power amplifier (PA) configured to amplify the combined signal and output the combined signal to the antenna port.

20. The amplifier module of claim 18, further comprising:
a first PA configured to amplify the phase shifted first compensated signal;
a second PA configured to amplify the phase shifted second compensated signal; and
a combiner configured to combine the phase shifted first compensated signal and the phase shifted second compensated signal into the combined signal and output the combined signal to the antenna port.

21.-22. (canceled)

23. The amplifier module of claim 16, further comprising a distribution network configured to:
distribute the first compensated signal to a signal chain of the antenna port and at least one or more of an additional signal chain of an additional antenna port of the amplifier module or one or more additional RF ports of the amplifier module; and
distribute the second compensated signal to the signal chain of the antenna port and at least one or more of the additional signal chain of the additional antenna port of the amplifier module or the one or more additional RF ports of the amplifier module.

24. The amplifier module of claim 1, further comprising first, second, and third RF serial ports; wherein:
the first RF serial port corresponds to the first RF signal;
the second RF serial port corresponds to the second RF signal; and
the third RF serial port corresponds to an additional coupling cancellation signal.

25. The amplifier module of claim 24, wherein the first RF serial port, the second RF serial port, and the third RF serial port are coupled to a corresponding first additional RF port, second additional RF port, and third additional RF port, respectively, of an additional amplifier module serially connected with the amplifier module.

26. The amplifier module of claim 25, wherein, in a receive (Rx) mode,
the additional coupling cancellation signal is configured to destructively interfere, at an antenna port of the amplifier module, with coupling between the first and second RF serial ports and the antenna port.

27. The amplifier module of claim 26, wherein the first and third RF serial ports are configured as a third differential RF signal port pair and the second and third RF serial ports are configured as a fourth differential RF signal port pair.

28. The amplifier module of claim 27, wherein the additional coupling cancellation signal comprises a first coupling cancellation signal component corresponding to the first RF signal and a second coupling cancellation signal component corresponding to the second RF signal.

29. The amplifier module of claim 28, wherein:
the first coupling cancellation signal component has an inverted phase relative to a coupling between the antenna port and a first RF signal differential component output from the first RF serial port; and
the second coupling cancellation signal component has an inverted phase relative to a coupling between the antenna port and a second RF signal output differential component from the second RF serial port.

30. The amplifier module of claim 25, wherein, in a transmit (Tx) mode:
a combined signal generated based on the first RF signal and the second RF signal is output from an antenna port of the amplifier module, wherein the combined signal couples with the first RF serial port, the second RF serial port, and the third RF serial port;
the additional amplifier module is configured to at least partially cancel the coupling between the combined signal and the first RF serial port based on the additional coupling cancellation signal received at the third RF serial port, wherein the additional coupling cancellation signal is based on a coupling between the combined signal and the third RF serial port; and
the additional amplifier module is configured to at least partially cancel the coupling between the combined signal and the second RF serial port based on the additional coupling cancellation signal.

31. The amplifier module of claim 30, wherein the first and third RF serial ports are configured as a third differential RF signal port pair and the second and third RF serial ports are configured as a fourth differential RF signal port pair.

32. The amplifier module of claim 31, wherein:
the additional coupling cancellation signal has a non-inverted phase relative to a coupling between the first RF serial port and the antenna port; and
the additional coupling cancellation signal has a non-inverted phase relative to a coupling between the second RF serial port and the antenna port.

33.-34. (canceled)

35. A method of coupling cancellation at an amplifier in a transmit (Tx) mode, the method comprising:
obtaining a first RF signal at a first differential RF port pair, wherein the first differential RF port pair comprises a first RF port and a third RF port;
obtaining a second RF signal at a second differential RF port, wherein the second differential RF port comprises a second RF port and the third RF port;
outputting a combined signal from an antenna port, wherein the combined signal is based on the first RF signal and the second RF signal, and wherein the combined signal couples with the first RF port, the second RF port, and the third RF port; and
obtaining a coupling cancellation signal at the third RF port, wherein the coupling cancellation signal comprises a coupling between the combined signal and the third RF port, wherein generating the combined signal comprises at least partially cancelling the coupling cancellation signal.

36. (canceled)

37. A method of coupling cancellation at an amplifier in a receive (Rx) mode, the method comprising:
obtaining a received RF signal at an antenna port;
generating a first RF signal based on the received RF signal, wherein the first RF signal is output at a first differential RF port pair comprising a first RF port and a third RF port; and
generating a second RF signal based on the received RF signal, wherein the second RF signal is output at a second differential RF port pair comprising a second RF port and the third RF port, wherein the third RF port comprises a coupling cancellation port configured to transmit a coupling cancellation signal, wherein the coupling cancellation signal comprises a first coupling cancellation signal component and a second coupling cancellation signal component.

38.-39. (canceled)
